(19) United States
(12) Patent Application Publication
(10) Pub. No.: US 2010/0196655 A1
(43) Pub. Date: Aug. 5, 2010

(54) DISPLAY-USE FILTER

(75) Inventors: Nobuyasu Kai, Shiga (JP); Tatsuro Tsuchimoto, Shiga (JP); Kiyoshige Maeda, Shiga (JP)

Correspondence Address: IP GROUP OF DLA PIPER LLP (US), ONE LIBERTY PLACE, 1650 MARKET ST, SUITE 4900, PHILADELPHIA, PA, 19103, US

(73) Assignee: TORAY ADVANCED FILM CO., LTD., Tokyo (JP)

(21) Appl. No.: 12/666,034

(22) PCT Filed: Jun. 25, 2008
(86) PCT No.: PCT/JP2008/061511

§ 371 Date: Dec. 22, 2009

(30) Foreign Application Priority Data
Jun. 29, 2007 (JP) 2007-171609
Mar. 5, 2008 (JP) 2008-054473
Mar. 5, 2008 (JP) 2008-054474

(51) Int. Cl. G02B 5/20; B32B 3/26; B32B 27/00

(52) U.S. Cl. 428/110; 428/161; 428/162

(57) ABSTRACT

A display-use filter, which comprises a laminated body comprising a transparent substrate, light-shielding convex portions formed on the transparent substrate, a resin layer stacked on the light-shielding convex portions and a non-convex area existing between the light-shielding convex portions, wherein a concave section of the resin layer is formed in the non-convex area, and the resin layer has a center-line average roughness Ra in a range from 50 to 500 nm.

### RELATED APPLICATIONS

This is a §371 of International Application No. PCT/JP2008/061511, with an international filing date of Jun. 25, 2008 (WO 2009/004957 A1, published Jan. 8, 2009), which is based on Japanese Patent Application Nos. 2007-171609, filed Jun. 29, 2007, 2008-054473, filed Mar. 5, 2008, and 2008-054474, filed Mar. 5, 2008, the subject matter of which is incorporated by reference.

### TECHNICAL FIELD

The present invention relates to a display-use filter that is attached to a screen of a display device, such as a CRT, an organic EL display, a liquid crystal display and a plasma display. More specifically, the present invention concerns such a display-use filter that is superior in image antireflective property, and desirably applicable to the plasma display.

### BACKGROUND

An optical filter is attached to the front face of a display panel so as to improve functions of the display panel.

For example, a plasma display-use filter to be attached to the front face of a plasma display panel requires the following functions: (1) to provide a mechanical strength to a plasma display main body (panel) made of a glass thin film; (2) to shield electromagnetic waves released from the plasma display panel; (3) to shield infrared rays released from the plasma display panel; (4) to prevent external light reflection; and (5) color-tone correction.

The plasma display-use filter mounted on plasma displays that have been currently introduced to the market is formed by stacking a plurality of layers having the above-mentioned respective functions of (1) to (5). More specifically, the plasma display-use filter is composed of a transparent substrate such as glass used for applying a mechanical strength to the plasma display panel, a conductive layer used for shielding electromagnetic waves, a near infrared-ray shielding layer used for shielding infrared rays, an ultraviolet-ray shielding layer used for shielding ultraviolet rays, an antireflection layer for preventing external light reflection and a color-tone correcting layer containing a coloring matter capable of absorbing light rays within a visible light range so as to correct color tones.

The performances that the display is required to exert have become severer year after year, and requirements for the display-use filter have also become higher and higher. Among these, in order to improve the image-quality characteristics, there have been strong demands for high contrast, reduction of interference fringes, reduction of image reflection from a fluorescent lamp or the like on the display surface, and the like.

As the method for reducing image reflection, in general, a method is proposed in which an antireflection layer having a concave/convex pattern is formed on the substrate. Moreover, the formation of the concave/convex pattern is achieved by forming fine concave/convex portions on the surface by applying a transparent paint containing fine particles JP A Nos. 2005-316450 and 2006-195305).

In contrast, together with low prices of the plasma displays, the prices of the filters have become lower year by year, with the result that the demand for cutting costs has become severer. In general, a commonly-used filter is formed by laminating an optical functional film including an antireflection layer, a color-tone correcting layer, a near infrared-ray shielding layer and the like, and a plastic film on which a conductive layer has been formed, with an adhesive layer interposed therebetween, and in comparison with a filter made of these two films, by forming a filter by using only one plastic sheet, it becomes possible to achieve low prices. For example, a filter has been proposed in which an antireflection layer is formed on one of the faces of a plastic film, with a conductive layer formed on the other face, or another filter has been proposed in which a conductive layer is formed on a plastic film, with an antireflection layer being further stacked thereon (JP A Nos. 2007-96049 and 2006-54377).

In the techniques disclosed in JP A Nos. 2005-316450 and 2006-195305, however, although a superior image antireflective property is provided, the light diffusing property becomes high to cause insufficient transmitted image clearness, and from the viewpoint of costs, these methods require a plurality of films to form a display-use filter, failing to provide a sufficient device.

Moreover, since the techniques of JP A Nos. 2007-96049 and 2006-54377 form a display-use filter by using one sheet of film, it is possible to reduce costs; however, since no concave/convex portions for diffusing light are formed on the outermost surface on the visible side, the techniques fail to provide a sufficient structure in the antireflective property.

In view of the above identified prior art problems, it could be helpful to provide a display-use filter that has a sufficient image antireflective function, and is superior in transmitted image clearness, at low costs.

### SUMMARY

We thus provide a display-use filter with the following structures:
1) display-use filter, which comprises a laminated body comprising:
   a transparent substrate;
   light-shielding convex portions formed on the transparent substrate;
   a resin layer stacked on the light-shielding convex portions and a non-convex area existing between the light-shielding conbex portions,
wherein a concave section of the resin layer is formed in the non-convex area, and the resin layer has a center-line average roughness Ra in a range from 50 to 500 nm.
2) The display-use filter described in 1) in which the concave section in the resin layer has a depth (D) in a range from 0.5 to 5 μm.
3) The display-use filter described in 1) or 2) in which the light-shielding convex portions have a height of 0.5 to 8 μm, and are mesh-shaped convex portions or a plurality of dot-shaped convex portions.
4) The display-use filter described in 3) in which a resin layer occupancy ratio (R), defined in the following manner, is set to 20 to 100%:
(Definition of the resin layer occupancy ratio (R))

R=(β/α)×100)
α: area of triangle ABC
β: area of resin layer located within triangle ABC
where, in the case when the cross section of a resin layer is viewed,the cross section being in a direction orthogonal to a transparent substrate and passing through two adjacent centers of gravity (G1, G2) of adjacent non-convex areas, each surrounded by the mesh-shaped convex portions in the surface direction of the transparent substrate, it is supposed that an apex of the resin layer on the mesh-shaped convex portions is C, that an intersection point of a perpendicular line (perpendicular relative to the transparent substrate) passing through one of the centers of gravity G1 of the two centers of gravity and the surface of the resin layer is A, and that an intersection point of a perpendicular line (perpendicular relative to the transparent substrate) passing through the other center of gravity G2 of the two centers of gravity and the surface of the resin layer is B.
5) The display-use filter described in any one of 1) to 4) in which the light-shielding convex portions is a conductive mesh.
6) The display-use filter described in 5) in which the conductive mesh has a pitch in a range from 50 to 500 μm.
7) The display-use filter described in 5) or 6) in which a resin layer occupancy ratio (R), defined in the following manner, is set to 20 to 100%:
(Definition of the resin layer occupancy ratio (R))

R=(β/α)×100)
α: area of triangle ABC
β: area of resin layer located within triangle ABC
where, in the case when the cross section of a resin layer is viewed, the cross section being in a direction orthogonal to a transparent substrate and passing through two adjacent centers of gravity (G1, G2) of adjacent non-convex areas (openings of the conductive mesh), each surrounded by the conductive mesh, in the surface direction of the transparent substrate, it is supposed that an apex of the resin layer on the conductive mesh is C, that an intersection point of a perpendicular line (perpendicular relative to the transparent substrate) passing through one of the centers of gravity (G1) of the two centers of gravity and the surface of the resin layer is A, and that an intersection point of a perpendicular line (perpendicular relative to the transparent substrate) passing through the other center of gravity (G2) of the two centers of gravity and the surface of the resin layer is B.
8) The display-use filter described in any one of 1) to 4) in which the light-shielding convex portions contain a resin component and a light-shielding substance.
9) The display-use filter described in any one of 1) to 8) in which the resin layer (one layer on the light-shielding convex portion side in the case when the resin layer has a laminated structure) has a weight coated amount in a range from 1 to 16 g/m².
10) The display-use filter described in any one of 1) to 9) in which the resin layer is a transparent resin layer.
11) The display-use filter described in any one of 1) to 10) in which the resin layer is a hard coat layer.
12) The display-use filter described in any one of 1) to 10) in which the resin layer has a laminated structure with an antireflection layer being stacked on a hard coat layer.
13) The display-use filter described in any one of 1) to 12) that is further provided with: a functional layer having at least one function selected from the group consisting of a near infrared-ray shielding function, a color-tone correcting function, an ultraviolet-ray shielding function and a Ne-cutting function.
14) The display-use filter described in any one of 1) to 13) that is used for a plasma display.

It is thus possible to provide a display-use filter that has a sufficient image antireflective function, and is superior in transmitted image clearness, at low costs.

### BRIEF DESCRIPTION OF THE DRAWINGS

FIG. 1 is a schematic cross-sectional view that shows one example of a concave structure of a resin layer of the present invention.

FIG. 2 is a schematic cross-sectional view that shows another example of the concave structure of a resin layer of the present invention.

FIG. 3 is a schematic cross-sectional view that shows the other example of the concave structure of a resin layer of the present invention.

FIG. 4 is a plan view that shows a conductive mesh to be used in the present invention.

FIG. 5a is a schematic cross-sectional view that explains a resin layer occupancy rate \textcircled{R}.

FIG. 5b is a schematic cross-sectional view that explains the resin layer occupancy rate \textcircled{R}.

FIG. 6 is a schematic plan view that shows one example of a mesh-shaped convex portion of the present invention.

FIG. 7 is a schematic plan view that shows another example of the mesh-shaped convex portion of the present invention.

FIG. 8 is a schematic plan view that shows the other example of the mesh-shaped convex portion of the present invention.

FIG. 9 is a schematic plan view that shows one example of a dot-shaped convex portion of the present invention.

FIG. 10 is an A-A line schematic cross-sectional view of FIG. 6.

FIG. 11 is a B-B line schematic cross-sectional view of FIG. 9.

FIG. 12 is a schematic cross-sectional view that shows one example of a mode in which a resin layer is stacked on mesh-shaped convex portions of the present invention.

FIG. 13 is a schematic cross-sectional view that shows one example of a mode in which a resin layer is stacked on dot-shaped convex portions of the present invention.

FIG. 14 is a schematic cross-sectional view that shows one example of mesh-shaped convex portions that overlap with a conductive mesh of the present invention in a projected manner.

### EXPLANATION OF REFERENCE NUMERALS

1 Transparent substrate
2 Conductive mesh
3 Resin layer
4 Peak
5 Bottom
6 Center of gravity of opening of conductive mesh on plan view
7a, 7b Perpendicular line passing through the center of gravity 6 of the opening of conductive mesh
8 Opening of conductive mesh
11 Light-shielding convex portion
12 Non-convex area
13 Transparent substrate
14 Resin layer
15 Peak
16 Bottom
17 Conductive mesh
D Depth of concave of resin layer

### DETAILED DESCRIPTION

In a conventional image antireflective method, by applying a transparent paint containing particles onto a flat substrate such as a plastic film so as to form a concave/convex structure thereon, concave/convex portions are formed on the resin layer by the particles; however, in this method, it is not possible to sufficiently prevent the image reflection without causing a reduction in transmitted image clearness.

In contrast, the display-use filter of the present invention, which is constituted by a laminated body in which light-shielding convex portions are formed on a transparent substrate, with a resin layer being stacked on the light-shielding convex portions as well as on each non-convex area between the adjacent light-shielding convex portions, is characterized in that concave sections of the resin layer are formed in the non-convex areas, with a center-line average roughness Ra of the resin layer being set in a range from 50 to 500 nm. With respect to the laminated body formed by stacking a resin layer on the light-shielding convex portions as well as on each non-convex area, a mode is preferably used in which a transparent resin is stacked in a manner so as to cover the light-shielding convex portions and each non-convex area. It has been found that the application of the display-use filter having the structure of the present invention makes it possible to sufficiently prevent the image reflection without causing a reduction in transmitted image clearness.

In the case when the concave/convex structure is simply formed on the resin layer without utilizing the light-shielding convex portions, a transmitted image is disturbed by the convex portions of the resin layer to cause a reduction in transmitted image clearness; however, when the concave/convex structure is formed by utilizing the light-shielding convex portions as in the case of the present invention, the reduction in transmitted image clearness due to the convex portions of the resin layer can be suppressed. This is presumably because, since light rays (light emission from a display), caused by particularly steep portions of the convex structure of the resin layer and greatly influential to degradation of the transmitted image clearness, are shielded by the light-shielding convex portions, the degradation of the transmitted image clearness due to the convex portions of the resin layer is suppressed.

Therefore, the resin layer in accordance with the present invention makes it possible to sufficiently prevent image reflection without the necessity of containing particles having comparatively large sizes so as to form the concave/convex structure on the resin layer, while simultaneously ensuring high transmitted image clearness.

Although the present invention makes it possible to sufficiently prevent the image reflection without allowing the resin layer to contain particles, as described above, the resin layer may contain particles in an attempt to further improve the image antireflective effect. However, depending on the kinds of particles to be contained therein, the transmitted image clearness tends to be lowered when the particles are contained in the resin layer. Therefore, in the attempt to improve the image antireflective effect by allowing the resin layer to contain particles, it is important to carefully select the average particle size and the content of the particles so as not to cause a reduction in the transmitted image clearness. With respect to the mode for allowing the resin layer to contain particles, an explanation will be given later in detail.

The plane shape (shape viewed from above) of each light-shielding convex portion in accordance with the present invention is preferably prepared as a mesh shape or a plurality of dot shapes (that is, the light-shielding convex portion is preferably formed into a mesh shape or a plurality of dot-shaped portions). Moreover, the light-shielding convex portions are preferably formed as a conductive layer, and the light-shielding convex portions are more preferably formed as a mesh-shaped conductive layer, that is, as a conductive mesh.

The following description will discuss a filter for a plasma display in which a conductive mesh is used for the light-shielding convex portions, with a resin layer being stacked on the conductive mesh, in detail as a preferable mode of the present invention. In this case, the conductive mesh to be desirably used for the filter for a plasma display is made of a metal and consequently has a light-shielding property.

As described above, the display-use filter of the present invention is constituted by a laminated body in which light-shielding convex portions are formed on a transparent substrate, with a resin layer being stacked on the light-shielding convex portions as well as on each non-convex area between the adjacent light-shielding convex portions, and concave sections of the resin layer are formed in the non-convex areas, with a center-line average roughness Ra of the resin layer being set in a range from 50 to 500 nm. Moreover, the filter for a plasma display of the present invention preferably has a mode in which a conductive mesh is used as the light-shielding convex portions (for this reason, the non-convex area between the adjacent light-shielding convex portions forms a portion without the conductive mesh, that is, an opening in the conductive mesh); more specifically, a conductive layer made of the conductive mesh is placed on a transparent substrate, and a resin layer is stacked on the conductive layer to form a laminated body, with concave sections of the resin layer being coincident with portions without the conductive mesh located thereon (that is, the opening of the conductive mesh corresponding to the non-convex area), and this mode is characterized in that a center-line average roughness Ra of the resin layer is set in a range from 50 to 500 nm.

It is found that, by forming the surface structure of the resin layer stacked on the conductive layer constituted by a conductive mesh as described above, the image reflection can be prevented without causing a reduction in the transmitted image clearness. Moreover, by forming the resin layer to be stacked on the conductive layer as a functional film having a hard-coating function and an antireflective function, it becomes possible to reduce the costs of the plasma display-use filter.

### (Concave Structure of Resin Layer)

The resin layer to be used for the filter for a plasma display of the present invention is preferably disposed as light-shielding convex portions by using a conductive mesh in openings between the conductive mesh lines. The kinds of the resin and characteristics of the resin layer of the plasma display-use filter of the present invention are not particularly limited, as long as concave sections of the resin layer are located on portions (non-convex area) without the conductive mesh, as will be described later, with a center-line average roughness Ra of the resin layer being set in a range from 50 to 500 nm. Moreover, the resin layer may be formed as a single layer or as a laminated structure having two or more layers. Additionally, in the case when the resin layer has a laminated structure, concave sections of the resin layer may be located on portions (non-convex area between the adjacent light-shielding convex portions) without the conductive mesh, with a center-line average roughness Ra of the outermost surface layer of the resin layer (surface on the side opposite to the light-shielding convex portions and the non-convex area) being set in a range from 50 to 500 nm.

The center-line average roughness Ra of the resin layer of the present invention is preferably set in a range from 75 to 400 nm, more preferably, from 100 to 300 nm, most preferably, from 150 to 250 nm. In the case when the center-line average roughness Ra of the resin layer is less than 50 nm, the outline of a reflected image becomes conspicuous so that the reflected image is easily viewed, and in the case when it exceeds 500 nm, the transmitted image deteriorates. For this reason, in the filter for a plasma display of the present invention, it becomes important to set the center-line average roughness Ra of the resin layer in a range from 50 to 500 nm. As described above, in the case of the laminated structure of two or more layers of the resin layer, it becomes important to set the center-line average roughness Ra of the outermost surface layer of the resin layer in a range from 50 to 500 nm.

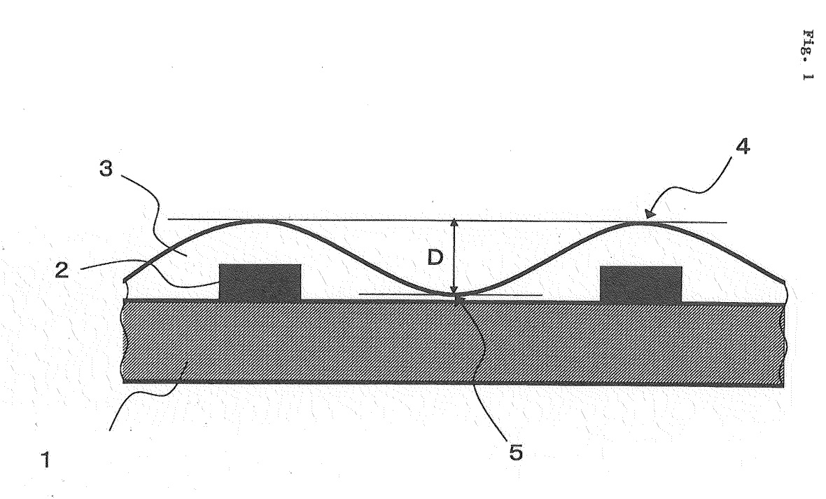

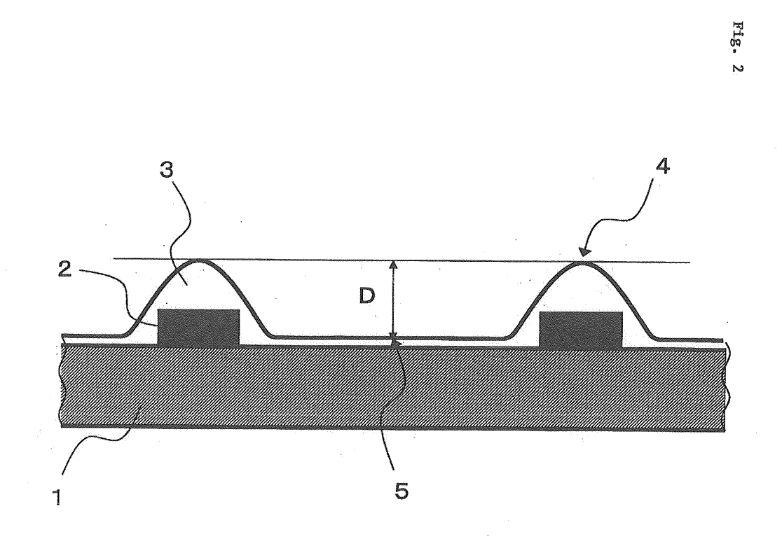

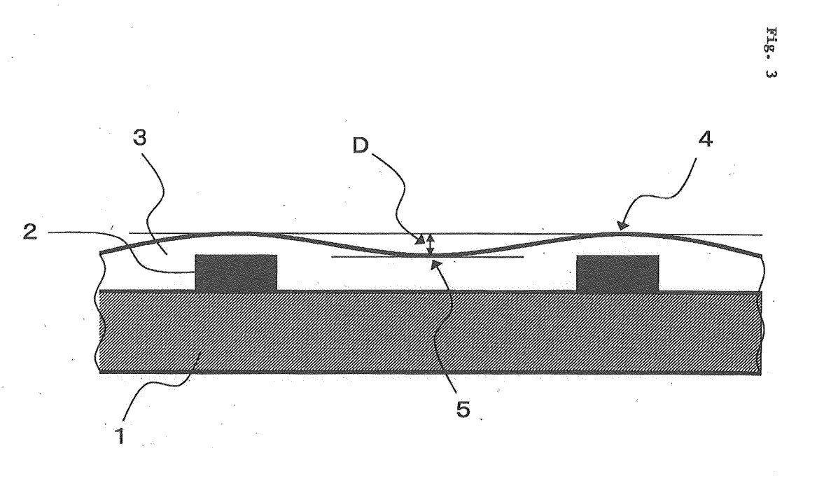

In the filter for a plasma display of the present invention, it is important to place concave sections of the resin layer on portions (non-convex area) without the conductive mesh. For example, FIGS. 1, 2 and 3 show the structure of recesses of the resin layer. In FIGS. 1 to 3, a conductive mesh 2 is formed on a transparent substrate 1, with a resin layer 3 being further stacked on the conductive mesh 2.

As described earlier, it is important to place the concave sections of the resin layer on portions without the conductive mesh (non-convex areas), and from the viewpoint of effectively preventing image reflection, the depth (D) of the concave sections of the resin layer is preferably set in a range from 0.5 to 5 μm, more preferably, from 0.5 to 4 μm, most preferably, from 1 to 3 μm.

The depth (D) of the concave section of the resin layer corresponds to a vertical distance from the peak 4 to the bottom 5 of the concave section. The peak 4 is positioned on the resin layer (convex portion of the resin layer) on the conductive mesh, and corresponds to the highest position of the resin layer. Moreover, the bottom 5 is positioned on the resin layer (concave section of the resin layer) without the conductive mesh, that is, between the conductive mesh lines (opening of the conductive mesh), and corresponds to the lowest position in the concave section of the resin layer.

By setting the depth (D) of the concave section of the resin layer to 0.5 to 5 μm, the outline of a reflected image becomes ambiguous, and the reflected image can be made hardly visible so that it is possible to desirably suppress degradation of the transmitted image.

In the present invention, the concave section of the resin layer is placed on the portion without the conductive mesh (non-convex area between the light-shielding convex portions), and the formation of the concave section is achieved by a method for controlling the thickness and pitches of the conductive mesh or a method for controlling the viscosity of an applied solution to be used for forming the resin layer. The method will be described later in detail.

In a conventional image antireflective method, a transparent paint containing particles having an average particle size of 0.5 to 10 μm is applied to a flat substrate such as a plastic film so that fine concave/convex portions are formed on the surface; however, in this method, it is not possible to sufficiently prevent image reflection without causing degradation of transmitted image clearness.

In contrast, in the preferable mode of the present invention, a conductive layer made of a conductive mesh is prepared to form light-shielding convex portions, and a resin layer is stacked on the conductive layer so that concave sections (a concave/convex structure in the resin layer) are formed on the resin layer by utilizing the concave/convex portions of the conductive mesh (opening portions and mesh portions of the conductive mesh), with a center-line average roughness Ra of the resin layer being set in a range from 50 to 500 nm; thus, it becomes possible to sufficiently prevent image reflection without the necessity of allowing the resin layer to contain particles, and also to simultaneously ensure high transmitted image clearness.

In the case when the concave/convex structure is simply formed on the resin layer without utilizing the light-shielding convex portions (conductive mesh), a transmitted image is disturbed by the convex portions of the resin layer to cause a reduction in transmitted image clearness; however, it is found that, when the concave/convex structure is formed by utilizing the light-shielding convex portions (conductive mesh) as in the case of the present invention, the reduction in transmitted image clearness due to the convex portions of the resin layer can be suppressed. This is presumably because, since light rays (light emission from a plasma display), caused by particularly steep portions of the convex structure of the resin layer and greatly influential to degradation of the transmitted image clearness, are shielded by the conductive mesh, the degradation of the transmitted image clearness due to the convex portions of the resin layer is suppressed. Additionally, since the conductive mesh to be used as the plasma display-use filter is normally made of metal, it is possible to provide a sufficient light-shielding property.

The following description will discuss a preferable mode of the concave/convex structure of the resin layer possessed by the display-use filter of the present invention.

In the display-use filter of the present invention, the resin layer is preferably provided with a concave/convex structure of a resin layer derived from a concave/convex structure formed by light-shielding convex portions and non-convex areas. That is, in the case when mesh-shaped convex portions are used as the light-shielding convex portions, convex portions of the resin layer are formed on the mesh-shaped convex portions so that the concave sections of the resin layer are desirably formed on the non-convex areas each of which is surrounded by the mesh-shaped convex portions. With respect to such a concave/convex structure of the resin layer, a desired concave/convex structure is proposed from the viewpoint of the image antireflection.

That is, in the concave/convex structure of the resin layer, as the rate of flat portions in the concave sections of the resin layer becomes smaller, the image reflection from a fluorescent lamp or the like is more effectively prevented.

The contents of the above-mentioned structure will be explained in more detail based upon a mode in which a conductive mesh is used as light-shielding mesh-shaped convex portions.

In the case when the conductive mesh is used as the light-shielding convex portions, convex portions of the resin layer are preferably formed on thin lines forming the conductive mesh, with non-convex areas being formed between the adjacent light-shielding convex portions (portions without the conductive mesh; hereinafter, referred to as opening portions), each surrounded by the thin lines of the conductive mesh, and it is more preferable to set the rate of the flat portions in the concave sections of the resin layer as small as possible.

The rate of the flat portions in the concave sections of the resin layer can be represented as described below in a substituted manner. That is, when the cross section of the resin layer is viewed which is in a direction orthogonal to the transparent substrate and pass through two adjacent centers of gravity (G1, G2) of the adjacent non-convex areas (in the case of the light-shielding portions formed by a conductive mesh, the non-convex areas correspond to opening portions), each of which is surrounded by the mesh-shaped convex portions (conductive mesh lines) in the surface direction of the transparent substrate, suppose that the apex of the resin layer on the mesh-shaped convex portion (conductive mesh) is represented by C, that an intersection point of a perpendicular line passing through one of the centers of gravity (G1) of the two centers of gravity (perpendicular line relative to the transparent substrate) and the surface of the resin layer is represented by A, and that an intersection point of a perpendicular line passing through the other center of gravity (G2) of the two centers of gravity (perpendicular line relative to the transparent substrate) and the surface of the resin layer is represented by B. Moreover, suppose that the area of a triangle ABC is represented by α, and that the area of the resin layer located within the triangle ABC is represented by β. In this case, the rate of the area β of the resin layer located within the triangle ABC to the area a of the triangle ABC is referred to as a resin layer occupancy rate R (R=(β/α)×100). Referring to drawings, the following description will discuss the resin layer occupancy rate R.

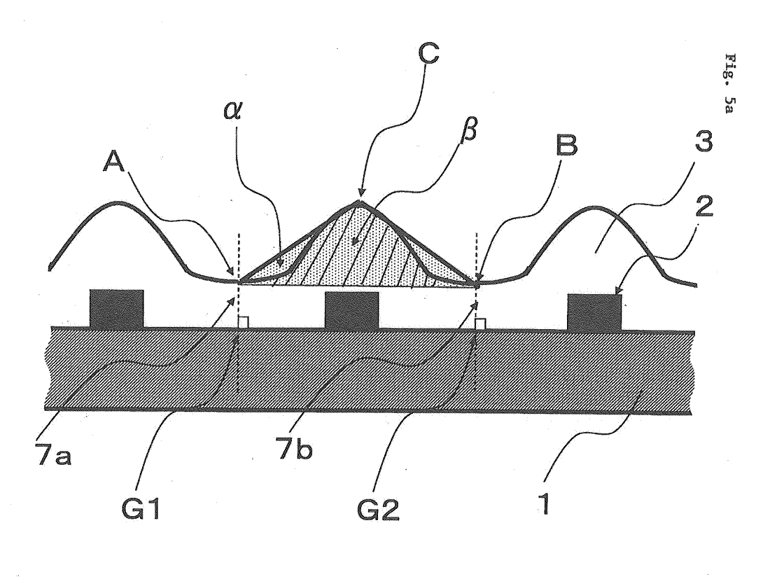

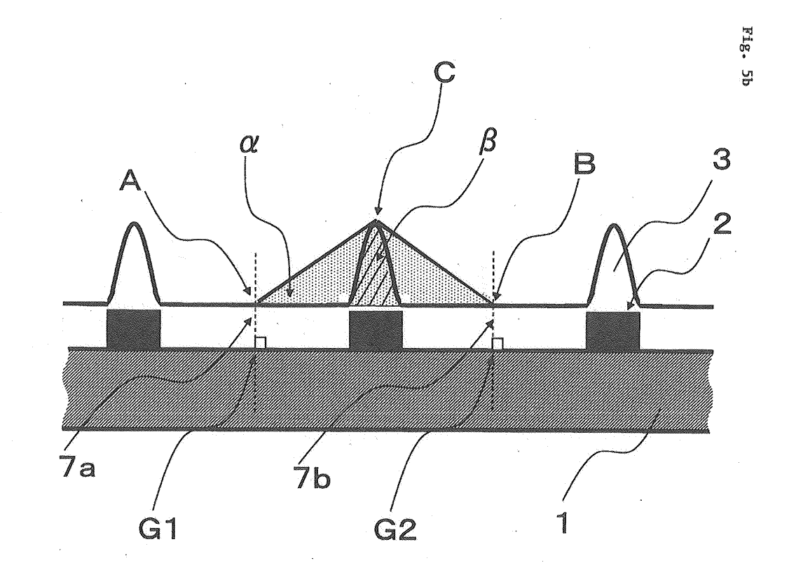

FIG. 5 is a cross-sectional view that shows a display-use filter of the present invention in which a conductive mesh is used to form light-shielding convex portions, and in this drawing, the cross section of a resin layer is viewed which is in a direction orthogonal to a transparent substrate and pass through two adjacent centers of gravity (G1, G2) of adjacent opening portions. In FIG. 5, with respect to the area ABC (α: indicated by dots) of the triangle formed by connecting the apex C of the convex portion of the resin layer, the intersection point A of a perpendicular line 7a passing through one of the centers of gravity G1 of a certain one of opening portions of the conductive mesh and the surface of the resin layer, and the intersection point B of a perpendicular line 7b passing through the other center of gravity G2 of an opening portion adjacent to the opening portion and the surface of the resin layer, the resin layer occupancy rate (R) represents a rate of an area (β: indicated by slanting lines) of the concave/convex structure of the resin layer located within the triangle ABC.

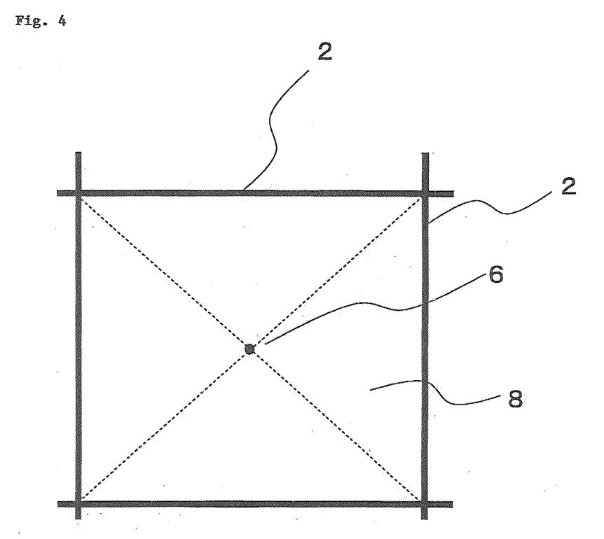

In this case, the center of gravity of the opening portion of the conductive mesh refers to a center of gravity 6 of each opening portion 8 of the conductive mesh, obtained when, as shown in FIG. 4, the conductive mesh is viewed in a surface direction of the transparent substrate on its plan view. Moreover, as shown in FIG. 5, the intersection points A and B refer to intersection points obtained, as intersection points between perpendicular lines 7a, 7b passing through the center of gravity 6 of the opening portion and the surface of the resin layer 3, when the cross section of the resin layer is viewed in a direction that passes through the two centers of gravity and is orthogonal to the transparent substrate.

Based upon the area (α) of the triangle ABC and the area (β) of the resin layer located within the triangle ABC, the resin layer occupancy rate (R) is represented by the following equation:

(R)=(α/β)×100.

In order to calculate the resin layer occupancy rate (R), the area (β) of the resin layer located within the triangle ABC that corresponds to the area of the resin layer concave/convex structure and the area (α) of the triangle ABC can be measured and calculated by using a laser microscope (for example, VK-9700, made by Keyence Corporation). Three-dimensional image data of a resin layer, obtained by observing and measuring a sample by the laser microscope, is further two-dimensionally analyzed in a vertical direction so that a two-dimensional profile is found, and based upon this two-dimensional profile, the area (β) of the resin layer located within the triangle ABC and the area (α) of the triangle ABC can be calculated. At this time, by preliminarily forming an extremely thin film (uniform film having a thickness in a range from 50 to 100 nm) of platinum, palladium or the like on the surface of the sample resin layer by using a sputtering method or the like, image data that is less susceptible to the influences of the conductive mesh and the substrate that are located beneath the resin layer can be obtained. A specific measuring method will be shown in embodiments.

In the present invention, the resin layer occupancy rate (R) is preferably set in a range from 20 to 100%, more preferably, from 20 to 80%, most preferably, from 30 to 70%. By setting the resin layer occupancy rate (R) in the range from 20 to 100%, it becomes possible to effectively prevent image reflection from a fluorescent lamp or the like, without causing a reduction in transmitted image clearness.

In the case when a comparatively large amount of particles (for example, 6% by weight or more relative to the total component of the resin layer) are contained in the resin layer, the resin layer occupancy rate (R) sometimes exceeds 100% due to the concave/convex structure of the resin layer caused by the particles, and such a rate exceeding 100% causes degradation of transmitted image clearness.

As described earlier, the resin layer occupancy rate (R) represents a rate of the flat portions within the concave section of the concave/convex structure of the resin layer, and as this numeric value becomes greater, the rate of the flat portions within the concave section of the concave/convex structure becomes smaller; in contrast, as this numeric value becomes smaller, the rate of the flat portions within the concave/convex structure of the resin layer becomes greater.

When FIGS. 5a and 5b are compared with each other, it is found that the rate of flat portions in the concave section of the resin layer 3 is smaller in FIG. 5a in comparison with that in FIG. 5b. As clearly indicated by the drawings, with respect to the resin layer occupancy rates (R) in FIG. 5a and FIG. 5b, the rate in FIG. 5a is greater than that in FIG. 5b. Actually, it is confirmed that the structure of FIG. 5a more effectively prevents the image reflection.

In the case when the rate of flat portions in the concave section is great in the concave/convex structure of the resin layer, since the specular reflection factor increases, the image antireflective property deteriorates; in contrast, in the case when the rate of flat portions is small, since the specular reflection factor decreases, the image antireflective property is improved.

Although the present invention makes it possible to sufficiently prevent image reflection without allowing the resin layer to contain particles, as described earlier, the resin layer may contain particles in an attempt to further improve the image antireflective effect. However, the transmitted image clearness is sometimes lowered when the particles are contained in the resin layer. Therefore, in the attempt to improve the image antireflective effect by allowing the resin layer to contain particles, it is important to carefully select the average particle size and the content of the particles so as not to cause a reduction in the transmitted image clearness.

In the case when particles are contained in the resin layer, it is necessary to adjust the average particle size and content of the particles so that the range of the center-line average roughness Ra of the resin layer obtained by stacking resin layers on the light-shielding convex portions of the conductive mesh or the like and the non-convex area of the opening portions or the like, that is, the Ra range, is set from 50 to 500 nm.

Upon allowing the resin layer to contain particles, particles having an average particle size in a range from 0.5 to 5 μm, in particular, an average particle size in a range from 1 to 3 μm, are preferably used.

In this case, the average particle size of the particles is defined as an average value of particle diameters indicated by the sphere corresponding value measured by, for example, an electrical resistance testing method (Coulter counter method).

Moreover, upon allowing the resin layer to contain particles, particles, which have an average particle size in a range from 0.5 to 5 μm, with the average particle size being also set to the same level as the thickness of the light-shielding convex portion such as the conductive mesh or less, more preferably, those particles, which have an average particle size of 90% or less relative to the thickness of the light-shielding convex portion such as the conductive mesh, are used, and most preferably those particles, which have an average particles size of 80% or less relative to the thickness of the light-shielding convex portion such as the conductive mesh, are used. Additionally, with respect to the average particle size of the particles to be used in this case, no lower limitation of the rate of the particle size relative to the thickness of the light-shielding convex portion such as the conductive mesh is particularly given as long as it is 0.5 μm or more.

The content of the particles to be contained in the resin layer is preferably set to 6% or less by weight to 100% by weight of the total components of the resin layer, more preferably, to 4% by weight or less, most preferably to 3% by weight or less, by far the most preferably, to 2.5% by weight or less. The lower limit content of the particles to be contained in the resin layer is set to about 0.1% by weight relative to 100% by weight of the total components of the resin layer.

With respect to the particles to be contained in the resin layer, those inorganic-based or organic-based particles are proposed, and those formed by using an organic-based material are preferably used. Moreover, those particles having a superior transparent property are preferably used. Specific examples of the particles include silica beads as the inorganic-based particles, and plastic beads as the organic-based particles. Among plastic beads, those having a transparent property are preferably used, and specific examples thereof include acryl-based, styrene-based and melamine-based plastic beads. In the present invention, acryl-based plastic beads having a superior trasparent property are preferably used.

Moreover, those particles having a spherical shape (a complete spherical shape, an elliptical shape or the like) are preferably used, and more preferably, those having the complete spherical shape are used.

In the case when the resin layer relating to the present invention contains a hard coat layer as its component, the hard coat layer may contain the above-mentioned particles having an average particle size (0.5 to 5 μm) at the above-mentioned content (6% by weight or less relative to 100% by weight of the total components of the resin layer).

A reflected image on the plasma display panel is formed by reflected light from the plasma display-use filter and reflected light from the plasma display panel. Since the reflected light from the plasma display panel is absorbed by the plasma display-use filter, the image antireflective function can be improved by lowering the transmittance of the plasma display-use filter. However, in the case when the transmittance of the plasma display-use filter is made too low, the luminance of the transmitted image is also lowered to cause a dark image, and in order to maintain the luminance in such a case, the image to be projected to the plasma display panel needs to be made brighter; however, this mode is not preferable because the power consumption is consequently increased. For this reason, the total light-ray transmittance of the plasma display-use filter of the present invention is preferably set in a range from 20 to 60%, more preferably, from 25 to 50%, most preferably, from 30 to 45%, and by preparing this transmittance, it becomes possible to provide a well-balanced state between the reduction of image reflection and the transmitted image luminance.

### (Conductive Layer)

In the plasma display panel, strong leakage electromagnetic waves are generated from the panel because of its structure and operation principle. In recent years, influences of the leakage electromagnetic waves from electronic apparatuses, given to the human body and other apparatuses, have been mentioned widely, and for example, in Japan, it has been demanded that the leakage electromagnetic waves should be limited within a reference value determined by VCCI (voluntary control council for interference by processing equipment electronic office machine). More specifically, VCCI regulates the leakage electromagnetic wave to less than 50 dBμV/m in class A indicating a regulated value for business applications, and also regulates it to less than 40 dBμV/m in class B indicating a regulated value for consumer applications; however, since the discharge electric field strength of the plasma display panel exceeds 50 dBμV/m in the band of 20 to 90 MHz (in the case of 40 inches in diagonal length), the display panel, as it is, cannot be used for consumer applications. For this reason, it is inevitably required to use a plasma display-use filter provided with an electromagnetic wave shielding layer (conductive layer) in a plasma display panel.

In order to allow the electromagnetic shielding layer to exert an electromagnetic shield performance, the shielding layer requires a conductive property, and the conductive property required for the electromagnetic wave shielding for a plasma display panel corresponds to 3 Ω/square or less in surface resistance, preferably to 1 Ω/square or less, more preferably, to 0.5 Ω/square or less. Therefore, in the display-use filter of the present invention having a conductive layer, the conductive property is preferably set to 3 Ω/square or less in surface resistance, more preferably to 1 Ω/square or less, most preferably, to 0.5 Ω/square or less. In this case, the lower the surface resistance, the better because of an improved electromagnetic wave shielding property; however, practically, the lower limit is considered to be about 0.01 Ω/square.

In the plasma display-use filter of the present invention, a conductive mesh is preferably used as its conductive layer. By using the conductive mesh, convex portions on which the conductive mesh is disposed and concave sections with no conductive mesh located thereon (corresponding to the opening portions of the conductive mesh, that is, non-convex areas between the light-shielding convex portions) can be utilized so that concave sections of the resin layer can be formed on the portions with no conductive mesh located thereon.

In addition to a function for shielding electromagnetic waves, the conductive layer made of the conductive mesh of the present invention has a function for forming concave sections (concave/convex structure of the resin layer) in the resin layer.

In order to form concave sections that are effective for preventing image reflection, the thickness of the conductive mesh needs to be made larger to a certain extent; however, in contrast, when the thickness becomes too large, the transmitted image clearness tends to cause degradation of a coating property of the resin layer, and subsequent occurrences of coating stripes and irregularities.

From the above-mentioned viewpoints, the thickness of the conductive mesh is preferably set in a range from 0.5 to 8 μm, more preferably, from 1 to 7 μm, most preferably, from 1 to 5 μm. In the case of the thickness of the conductive mesh of less than 0.5 μm, it is not possible to obtain a sufficient depth in the concave sections of the resin layer, with the result that the outline of a reflected image becomes conspicuous, making the reflected image further visible, and failing to obtain a required electromagnetic wave shielding property. In the case of the thickness of the conductive mesh exceeding 8 μm, the depth of the concave sections of the resin layer becomes too large to tend to cause degradation in the transmitted image, and subsequent high costs disadvantageously.

From the viewpoint of a coating property for the resin layer, the thickness of the conductive mesh is preferably made smaller. Therefore, by setting the thickness of the conductive mesh to 8 μm or less, it becomes possible to provide a superior coated face without occurrences of coating stripes, coating irregularities and the like. In the case of the thickness of the conductive mesh exceeding 8 μm, since the coating property of the resin layer deteriorates, it becomes difficult to stably form concave sections that are effective for preventing image reflection in the resin layer.

In the case when the conductive mesh is used as the light-shielding convex portions, there is a range with preferable pitches from the viewpoint of forming the concave sections that are effective for preventing image reflection in the resin layer in a stable manner, with respect to the pitches of the conductive mesh. In this case, the pitch of the conductive mesh refers to intervals between portions (opening portions surrounded by thin lines of the conductive mesh) with no mesh located thereon, and more specifically, corresponds to a distance between the center of gravity of one opening portion and the center of gravity of an adjacent opening portion with one side being commonly possessed therewith.

In the present invention, the pitch of the concave sections formed on the resin layer is greatly dependent on the pitch of the conductive mesh. Therefore, by controlling the pitch of the conductive mesh, it is possible to form concave sections effective for preventing image reflection in the resin layer. The pitch of the concave sections refers to a distance between the bottoms in the adjacent concave sections, and as shown in FIGS. 1 to 3, more specifically corresponds to a distance between the bottom 5 of a certain concave section and the bottom 5 of another concave section adjacent to the concave section.

From the above-mentioned viewpoints, the pitch of the conductive mesh is preferably set in a range from 50 to 500 μm, more preferably, from 75 to 450 nm, most preferably, from 100 to 350 μm.

Moreover, in an attempt to form concave sections in the resin layer so as to set the center-line average roughness Ra of the resin layer to a range from 50 to 500 nm, there is a preferable relationship between the thickness of the conductive mesh and the pitch thereof. That is, in the case when the thickness of the conductive mesh is from 0.5 μm or more to less than 4 μm, the pitch is preferably set in a range from 50 to 300 μm, and in the case when the thickness of the conductive mesh is from 4 μm or more to less than 6 μm, the pitch is preferably set in a range from 100 to 400 μm, and in the case when the thickness of the conductive mesh is from 6 μm to less than or equal to 8 μm, the pitch is preferably set in a range from 150 to 500 μm.

Moreover, from the viewpoint of preventing image reflection, there is a preferable relationship between the pitch of the conductive mesh and the depth D of the concave section of the resin layer. In the case when the pitch of the conductive mesh is from 50 μm or more to 200 μm or less, the depth D of the concave section is preferably set in a range from 0.5 to 4 μm, more preferably, from 0.5 to 3 μm. Furthermore, in the case when the pitch of the conductive mesh is from 200 μm or more to 500 μm or less, the depth D of the concave section is preferably set in a range from 0.7 to 5 μm, more preferably, from 1 to 4 μm.

The line width of the conductive mesh of the present invention is preferably set in a range from 3 to 30 μm, more preferably, from 5 to 20 μm. In the case of the line width of the conductive mesh of less than 3 μm, the electromagnetic wave shielding property tends to be lowered; in contrast, in the case of the line width of greater than 30 μm, the transmittance of the plasma display-use filter tends to be lowered. Since the above-mentioned electromagnetic shielding property and transmittance are also influenced by the pitch of the conductive mesh, the line width and the pitch are preferably set in the above-mentioned ranges.

The transmittance of the plasma display-use filter is greatly influenced by the aperture ratio of the conductive mesh. The aperture ratio of the conductive mesh refers to a ratio of the total area of the opening portions relative to the sum of the total area of the mesh portions (thin line portions) on the plan view and the total area of the opening portions on the plan view, and the aperture ratio of the conductive mesh is determined by the line width and the pitch. In the present invention, the aperture ratio of the conductive mesh is preferably set to 60% or more, more preferably, to 70% or more, most preferably, to 80% or more. The upper limit of the aperture ratio is preferably set to 95% or less, more preferably, to 93% or less.

The aperture ratio of the conductive mesh is, for example, measured by the following method.

By using a digital microscope (VHX-200) made by Keyence Corporation, a surface observation is carried out by a power of 200 times, and by using its luminance extracting function (histogram extraction, luminance range setting 0-170), portions (opening portions) with no conductive mesh located thereon and portions with the conductive mesh located thereon are binarized, and its area measuring function is then utilized so that the total area and the area of the opening portions are calculated; thus, the area of the opening portions is divided by the total area so that the aperture ratio is found.

More specifically, from a sheet of sample having a size of 20 cm×20 cm, the aperture ratios are calculated at 20 arbitrary points, and the average value is preferably found.

With respect to the mesh pattern shapes (shapes of the opening portions) of the conductive mesh, examples thereof include a lattice shaped mesh pattern having a quadrilateral shape, such as a square, a rectangular shape and a diamond shape, a polygonal-shaped mesh pattern, such as a triangular shape, a pentagonal shape, a hexagonal shape, an octagonal shape and a dodecagonal shape, a mesh pattern having a round shape or an elliptical shape, a composite-shaped pattern of the above-mentioned shapes, and a random mesh pattern. Among these, a lattice-shaped mesh pattern composed of a quadrilateral shape and a mesh pattern composed of a hexagonal shape are preferably used, and more preferably, a regular mesh pattern is used.

In the case when, for example, a lattice-shaped mesh pattern is used as the mesh pattern, the lines of the mesh pattern are preferably made to have a certain degree of angle (bias angle) relative to lines along which pixels are aligned so as not to cause moire interference due to interaction with the display pixels that are disposed laterally as well as longitudinally in parallel with one another. Since to design the bias angle so as not to cause the moire interference is dependent on the pitch of pixels and the pitch and line width of the mesh pattern, it is determined on demand in accordance with these conditions.

In the plasma display-use filter of the present invention, the conductive layer made of a conductive mesh is formed on a transparent substrate. As the transparent substrate, various films, obtained from a solution film-forming method and a fusing film-forming method, are preferably used, and the transparent substrate will be described later in detail.

In the plasma display-use filter of the present invention, known methods may be used as a method for forming the conductive mesh layer on the transparent substrate or the like. For example, the following methods are proposed: 1) a method in which a conductive ink is printed on a transparent substrate as a pattern; 2) a method in which, after pattern-printing thereon by using an ink containing a plating catalyst core, a plating process is carried out thereon; 3) a method in which conductive fibers are used; 4) a method in which, after a metal foil has been bonded to a substrate with an adhesive agent, a patterning process is carried out thereon; 5) a method in which, after a metal thin film has been formed on a substrate by using a vapor-phase film-forming method or a plating method, a patterning process is carried out thereon; 6) a method in which photosensitive silver salt is used; and 7) a method in which a metal thin film is formed by laser abrasion; however, the method is not intended to be limited by these.

The following description will discuss the method for manufacturing a conductive mesh in detail.
1) The method in which a conductive ink is printed on a transparent substrate as a pattern corresponds to a method for printing the conductive ink on the transparent substrate as a pattern by using a known printing method such as a screen printing method and a gravure printing method.
2) The method in which, after pattern-printing thereon by using an ink containing a plating catalyst core, a plating process is carried out thereon corresponds to a method in which a pattern is printed by using a catalyst ink composed of a palladium colloid-containing paste, and by immersing this in an electroless copper plating solution so that an electroless copper plating process is carried out, and an electrolytic copper plating process is successively carried out thereon, and this is further subjected to an electrolytic plating of an Ni—Sn alloy so that a conductive mesh pattern is formed.
3) The method which uses conductive fibers corresponds to a method in which a knitted cloth made from conductive fibers is bonded thereto by using an adhesive agent or a sticker.
4) The method in which, after a metal foil has been bonded to a substrate with an adhesive agent, a patterning process is carried out thereon corresponds to a method in which, after a metal foil (copper, aluminum, nickel or the like) has been bonded to the transparent substrate by using an adhesive agent or a sticker, a resist pattern is formed on the metal foil by using a photolithography method or a screen printing method, and the metal foil is then etched. The photolithography method is preferably used as the resist pattern-forming method, and the photolithography method is a method in which a photosensitive resist is applied to a metal foil or a photosensitive resist film is laminated thereon, and after having been subjected to an exposing process, with a pattern mask being tightly made in contact therewith, this is developed by a developing solution to form an etching resist pattern, and metal, located portions other than the patterned portions, is eluted by using an appropriate etching solution so that a desired conductive mesh is formed.
5) The method in which, after a metal thin film has been formed on a substrate by using a vapor-phase film-forming method or a plating method, a patterning process is carried out thereon corresponds to a method in which, after a metal thin film (metal such as copper, aluminum, silver, gold, palladium, indium, tin or silver and an alloy between metals other than these) is formed on a transparent substrate by using a vapor-phase film-forming method, such as vapor deposition, sputtering and ion plating, or a plating method, and after a resist pattern has been formed on the metal thin-film by using a photolithography method or a screen printing method, and the metal thin-film is then etched. The photolithography method is preferably used as the resist pattern-forming method, and the photolithography method is a method in which a photosensitive resist is applied to a metal foil or a photosensitive resist film is laminated thereon, and after having been subjected to an exposing process, with a pattern mask being tightly made in contact therewith, this is developed by a developing solution to form an etching resist pattern, and metal located portions other than the patterned portions are eluted by using an appropriate etching solution so that a desired conductive mesh is formed. In this method, the metal thin-film is desirably formed on the transparent substrate, without an adhesive agent or a sticker being interposed therebetween.
6) The method which uses photosensitive silver salt corresponds to a method in which a transparent substrate is coated with a silver salt emulsion layer of silver halogenide or the like, and after having been subjected to a photomask exposure or a laser exposure, the resulting layer is then developed so that a silver mesh is formed thereon. Preferably, the silver mesh thus formed is further plated by metal such as nickel. This method has been disclosed in WO No. 2004/7810, JP-A No. 2004-221564, JP-A No. 2006-12935 and the like, and reference can be made thereto.
7) The method in which a metal thin film is formed by laser abrasion corresponds to a method in which the metal thin-film, formed on the transparent substrate by using the same method as that of the method 5), is subjected to a laser abrasion method so as to form a mesh pattern of the metal thin-film.

The laser abrasion refers to a phenomenon in which, upon irradiation of a solid-material surface that absorbs a laser light beam with laser light with a high energy density, the bond between molecules at an irradiated portion is cut off to be evaporated, with the result that the solid-material surface at the irradiated portion is subjected to an abrasion. By utilizing this phenomenon, the solid-material surface can be processed. Since the laser light is superior in its linearly advancing property and light-condensing property, it is possible to selectively machine a fine area corresponding to about three times the wavelength of the laser light to be used for the abrasion, and consequently to achieve high machining precision by using the laser abrasion method.

As the laser to be used for the abrasion method, any laser can be used as long as it has wavelengths that are absorbed by metal. For example, a gas laser, a semiconductor laser, an excimer laser or a solid-state laser using a semiconductor laser as its exciting light source may be used. Moreover, a second harmonic light source (SHG), a third harmonic light source (THG) and a fourth harmonic light source (FHG), obtained by combining the solid-state laser with a non-linear optical crystal, may also be used.

Among these solid-state lasers, from the viewpoint that no plastic films are machined, an ultraviolet-ray laser having a wavelength of 254 nm to 533 nm is desirably used. In particular, an SHG (wavelength: 533 nm) of a solid-state laser such as Nd:YAG (neodium:yttrium-aluminum-garnet) is preferably used, and more preferably, an ultraviolet-ray laser of THG (wavelength: 355 nm) of a solid-state laser such as Nd:YAG is used.

With respect to the oscillation system of the laser, a laser of any system may be used; however, from the viewpoint of the machining precision, a pulse laser is preferably used, and a pulse laser of a Q-switch system having a pulse width of ns or less is more preferably used.

After further forming a metal oxide layer of 0.01 to 0.1 μm on the metal thin-film (visual recognition side), the metal thin-film and the metal oxide layer are desirably subjected to the laser abrasion process. Examples of the metal oxide include metal oxides of copper, aluminum, nickel, iron, gold, silver, stainless steel, chromium, titanium and tin, and from the viewpoints of the price and film stability, copper oxide is desirably used. Examples of the forming method of the metal oxide include a vacuum vapor deposition method, a sputtering method, an ion plating method, a chemical vapor deposition method, electroless and electrolytic plating methods.

Among the above-mentioned manufacturing methods for the conductive mesh, from the viewpoints of easily manufacturing a conductive mesh having a comparatively small thickness (for example, conductive mesh having a thickness of 8 μm or less) and of ensuring a high electromagnetic wave shielding property, the above-mentioned manufacturing methods 2), 5), 6) and 7) are desirably used.

Moreover, from the viewpoints of the coating characteristic of the resin layer and the adhesion between the resin layer and the conductive layer, conductive meshes manufactured by using the above-mentioned manufacturing methods 2), 5) and 7) are desirably used. In particular, the manufacturing method 5), which has a superior applying characteristic and provides a low manufacturing cost of the conductive mesh, is more desirably used.

The following description will discuss the manufacturing method 5) in more detail.

The vapor phase film-forming method is preferably used as the method for forming the metal thin-film on the transparent substrate. As the vapor phase film-forming method, the following methods are proposed: sputtering, ion-plating, electron-beam vapor deposition, vacuum vapor deposition and chemical vapor deposition methods and the like, and among these, sputtering and vacuum vapor deposition methods are preferably used. As the metal used for forming the metal thin-film includes, one kind of following metals or an alloy film or a multi-layered alloy film, formed by combining two or more kinds of metals selected from the group consisting of copper, aluminum, nickel, iron, gold, silver, stainless steel, chromium and titanium, may be used. Among these, copper is preferably used because of its desirable electromagnetic-wave shielding property, easiness in forming a mesh pattern and low costs.

Moreover, in the case of using copper as metal for the metal thin-film, a nickel thin-film having a thickness of 5 to 100 nm is preferably formed between the substrate and the copper thin-film. With this structure, the adhesion between the substrate and the copper thin-film is further improved. In this mode, the thickness of the conductive mesh is defined as the sum of thicknesses of the nickel thin-film and the copper thin-film.

As the method for forming a resist pattern on the metal thin-film, a photolithography method is preferably used. The photolithography method corresponds to a method in which, after a photosensitive resist layer has been laminated on a metal thin film, the resist layer is exposed into a mesh pattern, and developed to form a resist pattern is formed, and the metal thin-film is then etched into a mesh pattern so that the resist layer on the mesh is separated and removed.

As the photosensitive resist layer, a negative-working resist whose exposed portion is cured, or in contrast, a positive-working resist whose exposed portion is dissolved by development, may be used. The photosensitive resist layer may be directly applied onto the metal thin-film and laminated thereon, or a film made from photoresist may be bonded thereto. As the method for exposing the photoresist layer, a method for carrying out the exposing process through a photomask by using ultraviolet rays or the like, or a method for directly carrying out scanning and exposing processes by using laser, may be used.

A chemical etching method or the like may be used as the etching method. The chemical etching method refers to a method in which metal at portions other than metal portions protected by the resist pattern is dissolved by an etching solution and removed. Examples of the etching solution include a ferric chloride aqueous solution, a cupric chloride aqueous solution and an alkali etching solution.

The conductive mesh of the present invention is preferably subjected to a blackening treatment. By carrying out the blackening treatment, reflection from the viewer's side and reflection from the display side due to metallic gloss of the conductive mesh can be reduced and the lowering of image visibility can be avoided so that it becomes possible to obtain a plasma display-use filter that is superior in contrast and visibility.

In a portion other than the portion forming a light-transmitting portion of the conductive mesh when placed on the display, that is, in a portion other than the display portion and a portion concealed by a printed framework, the mesh pattern is not necessarily required to be formed, and this portion may be prepared, for example, as a solid metal foil portion without a patterned portion. In addition, when the solid portion that is not patterned is formed as a black-colored portion, this portion, as it is, is desirably used as the printed framework of the display-use filter.

### (Lamination of Resin Layer)

The display-use filter of the present invention is configured by a laminated body in which a resin layer is laminated on light-shielding convex portions and a non-convex area, and in particular, in the present invention, the resin layer is preferably laminated on the conductive layer made of a conductive mesh, and the resin layer is more preferably laminated on the conductive layer directly. The laminating method for the resin layer is preferably carried out by applying a coating solution to form a resin layer (hereinafter, referred to simply as “coating solution) thereto.

Upon carrying out the coating process, the viscosity of the coating solution (23° C.) is preferably set in a range from 1 to 50 mPa·s. By controlling the viscosity of the coating solution in the above-mentioned range, it is possible to form concave sections that are effective for preventing image reflection in the resin layer. In an attempt to form the concave sections in the resin layer, it is effective to set the viscosity of the coating solution to 50 mPa·s or less. In the case of the viscosity of the coating solution exceeding 50 mPa·s, the coating property is lowered to sometimes cause coating stripes and coating irregularities.

In the case of the viscosity of the coating solution lower than 1 mPa·s, the coated surface tends to be easily smoothed in contrast, sometimes failing to form the concave sections that are effective for preventing image reflection.

The viscosity of the coating solution is preferably set in a range from 1 to 40 mPa·s, more preferably, from 1 to 30 mPa·s, most preferably, from 1 to 20 mPa·s.

Moreover, the solid-component concentration of the coating solution and the wet coating amount of the coating solution are also preferably adjusted in the following ranges.

The solid-component concentration in the coating solution is preferably set in a range from 1 to 80% by weight, more preferably, from 20 to 70% by weight, most preferably, from 30 to 70% by weight. In this case, the solid-state component of the coating solution includes a resin component and other solid components (for example, a polymerization initiator, a coating-property improving agent and the like) on demand. The resin component, which includes a polymer, a monomer or an oligomer, preferably contains 50% by weight or more of the resin components relative to the total solid-state components in the coating solution, and more preferably contains 60% by weight or more thereof. The upper limit is set to 100% by weight.

The wet coating amount of the coating solution is preferably set in a range from 1 to 50 g/m², most preferably, from 5 to 30 g/m².

As the coating method for the coating solution for a resin layer, for example, the following various coating methods may be used: a reverse coating method, a gravure coating method, a rod coating method, a bar coating method, a die coating method and a spray coating method. Among these, the gravure coating method and the die coating method are preferably used.

In the display-use filter of the present invention, the volume coated amount in the dried state of the resin layer is desirably controlled in accordance with the heights of the light-shielding convex portions, such as a mesh-shaped convex portion and a plurality of dot-shaped convex portions, and in particular, in the present invention, the volume coated amount in the dried state of the resin layer is more desirably controlled in accordance with the thickness of the conductive mesh. With this arrangement, it is possible to form a concave section that is effective for preventing image reflection in a portion with no conductive mesh located thereon (opening portions of the conductive mesh).

Supposing that the thickness of the conductive mesh is (A) μm, a theoretical volume coated amount (B) cm³/m² of the resin layer in a dried state in the case when only the concave sections of the conductive mesh are evenly filled with the resin layer up to the same level as the thickness of the conductive mesh is indicated by the following equation. In the following equation, C represents an aperture ratio of the conductive mesh. Additionally, m²=10¹² μm², and μm³=10⁻¹² cm³.

B=(A×10¹²)×C×10⁻¹²=A×C

A desirable range of the volume coated amount of the resin layer in accordance with the thickness of the conductive mesh can be found based upon the above-mentioned theoretical volume coated amount (B).

That is, in the case when the thickness of the conductive mesh is less than 4 μm, the volume coated amount of the resin layer is preferably set in a range from 30 to 220%, more preferably, from 40 to 200%, most preferably, from 50 to 180%, relative to 100% of the theoretical volume coated amount (B). In the case of the thickness of the conductive mesh of less than 4 μm, when the volume coated amount of the resin layer becomes less than 30% relative to 100% of the theoretical volume coated amount (B), the coating property is lowered, while, in the case when it becomes more than 220%, it becomes difficult to form concave sections effective for preventing image reflection in the resin layer.

In the case when the thickness of the conductive mesh is from 4 μm or more to 8 μm or less, the volume coated amount of the resin layer is preferably set in a range from 40 to 250%, more preferably, from 50 to 220%, most preferably, from 55 to 200%, relative to 100% of the theoretical volume coated amount (B). In the case of the thickness of the conductive mesh from 4 μm or more to 8 μm or less, when the volume coated amount of the resin layer becomes less than 40% relative to 100% of the theoretical volume coated amount (B), the coating property is lowered, while, in the case when it becomes more than 250%, it becomes difficult to form concave sections effective for preventing image reflection in the resin layer.

The above-mentioned volume coated amount of the resin layer corresponds to the volume coated amount after having been dried; however, in the case when the resin layer is a hard coat layer, the volume coated amount of the resin layer corresponds to the volume coated amount after having been cured.

In the present invention, the resin layer preferably includes a hard coat layer. The hard coat layer has a function for preventing occurrence of scratches or the like in the plasma display-use filter, and for this reason, its hardness is preferably set to a sufficiently high level.

In order to obtain a high hardness, a multifunctional polymerizable monomer is preferably used as a resin component of the hard coat layer, and the specific gravity of the resulting hard coat layer after having been cured is preferably set to 1.2 or more, more preferably to 1.3 or more, most preferably, to 1.4 or more. As the specific gravity of the hard coat layer having been cured becomes higher, the hardness tends to become higher; therefore, the specific gravity of the hard coat layer after having been cured is preferably set to a higher level. The upper limit of the specific gravity of the hard coat layer is about 1.7.

When the above-mentioned volume coated amount is multiplied by the specific gravity, the resulting value corresponds to a weight coated amount. The weight coated amount of the resin layer is easily found by measuring the weights of a sample per unit area before and after the coating process; therefore, this factor is preferably used upon controlling and managing the manufacturing processes.

For example, supposing that the thickness (A) of a conductive mesh is 5 μm, that the aperture ratio (C) of the conductive mesh is 85% and that the specific weight of the hard coat layer is 1.4, the theoretical volume coated amount (B) of the resin layer is represented by: B=A×C=5×0.85=4.25 cm³/m².

As described above, in the case of the thickness of the conductive mesh from 4 μm or more to 8 μm or less, the volume coated amount of the resin layer is preferably set in a range from 40% to 250% relative to the theoretical volume coated amount (B); therefore, in the case of the thickness of the conductive mesh of 5 μm, the volume coated amount of the resin layer is preferably set in a range from 1.7 to 10.6 cm³/m².

When the above-mentioned volume coated amount is multiplied by the specific gravity 1.4 of the hard coat layer, the preferable range of the weight coated amount of the resin layer in the case of the conductive mesh having a thickness of 5 μm becomes 2.4 to 14.9 g/cm². More preferably, the range of the weight coated amount (within the range from 50 to 220% relative to the theoretical volume coated amount) is set in a range from 3.0 to 13.1 g/cm², and most preferably, the range of the weight coated amount (within the range from 55 to 200% relative to the theoretical volume coated amount) is set in a range from 3.3 to 11.9 g/cm².

As described earlier, the thickness of the conductive mesh is preferably set to 8 μm or less in the present invention. In the case of the thickness of the conductive mesh exceeding 8 μm, the coating property is seriously lowered upon applying the resin layer onto the conductive mesh in an actual manufacturing process, causing occurrences of stripes and irregularities on the coated surface of the resin layer. In particular, in the case when the dried coated amount of the resin layer is made comparatively small so as to form concave sections in the resin layer, the above-mentioned lowering of the coating property becomes conspicuous. When stripes, irregularities and the like occur on the resin layer, the plasma display-use filter is subjected to serious damages.

In the case of the thickness of the conductive mesh of 8 μm or more, in order to ensure a desirable coating property of the resin layer, the weight coated amount (after dried) of the resin layer needs to be set to 17 g/m² or more, more preferably, to 20 g/m² or more, and because of increased drying time and curing time after the coating process, the productivity deteriorates greatly. Moreover, in the case when the resin layer includes the hard coat layer, as the weight coated amount (weight coated amount after the curing process in the case of the hard coat layer) becomes greater, a problem arises in that a curl occurs in the plasma display-use filter due to condensation polymerization at the time of a curing process and a crack occurs in the hard coat layer.

Therefore, in the present invention, the weight coated amount of the resin layer is preferably set to 16 g/m² or less, more preferably, to 14 g/m² or less, most preferably, to 10 g/m² or less, by far the most preferably, to 9 g/m² or less. From the viewpoint of ensuring the hardness of the resin layer, the lower limit of the weight coated amount of the resin layer is preferably set to 1 g/m² or more, more preferably, to 1.5 g/m² or more. Additionally, in the case when the resin layer has a laminated structure, the weight coated amount of one layer on the side closest to the light-shielding convex portions of the resin layer is preferably set in the above-mentioned range (1 to 16 g/m²).

Therefore, in the present invention, the weight coated amount of the hard coat layer is preferably set to 16 g/m² or less, more preferably, to 14 g/m² or less, most preferably, to 10 g/m² or less, by far the most preferably, to 9 g/m² or less. From the viewpoint of ensuring the hardness of the resin layer, the lower limit of the weight coated amount of the hard coat layer is preferably set to 1 g/m² or more, more preferably, to 1.5 g/m².

Moreover, in the case when the hard coat layer is used as the resin layer, if the center-line average roughness Ra of the resin layer becomes greater than 500 nm, the scratch resistant property of the hard coat layer tends to deteriorate.

### (Structure of Resin Layer)

The resin layer of the present invention is preferably is disposed so that, when the plasma display-use filter is attached to a plasma display, the resin layer forms the outermost surface on the viewer's side (viewing side).

Moreover, the resin layer of the present invention is preferably prepared as a transparent resin layer. In this case, it is sufficient for the transparent resin layer to have a transparent property as high as that required for a hard coat layer, an antireflection layer and another functional layer (layer having at least one function selected from the group consisting of a near infrared-ray shielding function, a color-tone correcting function, an ultraviolet-ray shielding function and a Ne-cutting function) to be used for a normal display-use filter. More specifically, the resin layer is defined as a transparent resin layer as long as the display-use filter having the resin layer exerts a visual transmittance in the visible light wavelength range of 20% or more to 100% or less.

The resin layer of the present invention may have a single-layer structure or a laminated layer structure of two layers or more. In the case when the resin layer is the single layer, the resin layer is preferably prepared as a hard coat layer. In the case when the resin layer has the laminated layer structure of two layers or more, the resin layer is preferably composed of a hard coat layer and an antireflection layer. The antireflection layer may be formed as a low refractive-index layer, or may have a laminated structure of a high refractive-index layer and a low refractive-index layer. In the case of the laminated structure of a hard coat layer and an antireflection layer, the antireflection layer is preferably disposed so as to form the outermost surface on the viewer's side.

In the case of the laminated structure, it is important to form concave sections in the hard coat layer by carrying out a coating process on the hard coat layer and also to control the center-line average roughness Ra of the hard coat layer to a range from 50 to 500 nm. Since the antireflection layer to be laminated on the hard coat layer is an extremely thin film, it is formed in a manner so as to follow the surface shape of the hard coat layer.

The following description will discuss the hard coat layer and the antireflection layer in detail.

### (Hard Coat Layer)

The hard coat layer is a layer to be formed so as to prevent scratches. The hard coat layer is preferably designed to have a high hardness, and its pencil hardness defined in JIS K5600-5-4 (1999) is preferably set to 1H or more, more preferably, to 2H or more. The upper limit thereof is about 9H.

Moreover, in order to easily evaluate the scratch resistant property, a scratch resistant property test by the use of steel wool can be used. In this testing method, after the surface of the hard coat layer has been rubbed by #0000 steel wool, with a load of 250 g being imposed thereon, reciprocatingly 10 times, with a stroke width of 10 cm at a speed of 30 mm/sec, the surface is visually observed, and the state of scratches is evaluated by the following five ranks
5^{th} grade: No scratches were found.
4^{th} grade: Scratches of 1 or more to 5 or less were found.
3^{rd} grade: Scratches of 6 or more to 10 or less were found.
2^{nd} grade: Scratches of 11 or more were found.
1^{st} grade: Innumerable scratches were found on the entire surface.

In the above-mentioned testing method, the hard coat layer of the present invention is preferably set to the 3^{rd} grade or more, more preferably, to 4^{th} grade or more.

As the component of the hard coat layer in the present invention, a thermosetting type resin, a photocurable type resin or the like, such as an acryl-based resin, a silicon-based resin, a melamine-based resin, an urethane-based resin, an alkyd-based resin or a fluorine-based resin, is proposed, and from the viewpoint of well-balanced state of performances, costs, productivity and the like, the acrylate-based resin is preferably used.

The acrylate-based hard coat layer is made of a cured composition mainly composed of a polyfunctional acrylate. The polyfunctional acrylate is a monomer, an olygomer or a prepolymer in which 3 (preferably, 4, more preferably, 5) or more (meth)acyloyloxy groups are contained in one molecule, and examples of the monomer includes a monomer in which 3 or more (meth)acryloyloxy groups (in the present specification “ . . . (meth)acry . . . ” represents an abbreviated form of “ . . . acry . . . or . . . methacry . . . ”) are contained in one molecule, and examples of the olygomer or copolymer include a compound in which polyhydric alcohol having three alcoholic hydroxyl groups or more are contained in one molecule, with the hydroxyl groups being formed into three or more esterificated (meth)acrylic acid copolymers.

Specific examples thereof include: pentaerythritol tri(metha)acrylate, pentaerythritol tetra(metha)acrylate, dipentaerythritol tri(metha)acrylate, dipentaerythritol tetra(metha)acrylate, dipentaerythritol penta(metha)acrylate, dipentaerythritol hexa(metha)acrylate, trimethylol propane tri(metha)acrylate, trimethylol propane EO-modified tri(metha)acrylate, pentaerythritol triacrylate hexamethylenediisocyanate urethane prepolymer, pentaerythritol triacrylate toluene diisocyanate urethane prepolymer, and pentaerythritol triacrylate isophrone diisocyanate urethane prepolymer. One of these may be used, or two or more kinds of these may be mixed and used.

The rate of use of each of these monomer, olygoner and prepolymer in which 3 or more (meth)acyloyloxy groups are contained in one molecule is preferably set to 50 to 90% by weight, more preferably, to 50 to 80% by weight, relative to 100% by weight of 100% by weight of the total amounts of the components of the hard coat layer.

In order to alleviate the rigidity of the hard coat layer and also to alleviate shrinkage thereof upon curing, mono- or di-functional acrylate is preferably used in combination. With respect to the monomer having 1 to 2 ethylenic unsaturated double bonds in one molecule, not particularly limited, a normal monomer may be used as long as it is a radical-polymerizable monomer.

With respect to the compound having two ethylenically unsaturated double bonds in a molecule, the following (a) to (f) (meth)acrylates or the like may be used.

That is, (a) (meth)acrylic acid diesters of alkylene glycol having 2 to 12 carbon atoms: ethylene glycol di(meth)acrylate, propylene glycol di(meth)acrylate, 1,4-butane diol (meth)acrylate, neopentyl glycol di(meth)acrylate, 1,6-hexane diol di(meth)acrylate and the like;
(b) (meth)acrylic acid diesters of polyoxyalkylene glycol: diethylene glycol di(meth)acrylate, triethylene glycol di(meth)acrylate, tetraethylene glycol di(meth)acrylate, dipropylene glycol di(meth)acrylate, polyethylene glycol di(meth)acrylate, polypropylene glycol di(meth)acrylate and the like;
(c) (meth)acrylic acid diesters of polyhydric alcohol: pentaerythritol di(meth)acrylate and the like;
(d) (meth)acrylic acid diesters of ethylene oxide and propylene oxide adducts of bisphenol A or bisphenol A hydride: 2,2-bis(4-acryloyloxyethoxy phenyl)propane, 2,2′-bis(4-acryloxypropoxyphenyl)propane and the like;
(e) urethane(meth)acrylates having two or more (meth)acryloyloxy groups in a molecule, obtained by further allowing a terminal isocyanate group containing compound, prepared by preliminarily allowing a compound containing a diisocyanate compound and two or more compounds containing an alcoholic hydroxyl group to react with each other, to react with alcoholic hydroxyl group-containing (meth)acrylate, and the like; and
(f) epoxy(meth)acrylates having two or more (meth)acryloyloxy groups in a molecule obtained by allowing acrylic acid or methacrylic acid to a compound having two or more epoxy groups in a molecule, and the like. With respect to the compound having one ethylenic unsaturated double bonds in a molecule, examples thereof include: methyl (meth)acrylate, ethyl(meth)acrylate, n- and i-propyl(meth)acrylate, n-, sec- and t-butyl(meth)acrylate, 2-ethylhexyl(meth)acrylate, lauryl(meth)acrylate, stearyl (meth)acrylate, methoxyethyl(meth)acrylate, ethoxyethyl(meth)acrylate, hydroxyethyl (meth)acrylate, polyethylene glycol mono(meth)acrylate, polypropylene glycol mono(meth)acrylate, glycidyl(meth)acrylate, tetrahydrofurfuryl(meth)acrylate, N-hydroxyethyl (meth)acrylamide, N-vinylpyrrolidone, N-vinyl-3-methylpyrrolidone and N-vinyl-5-methylpyrrolidone. One kind of these monomers may be used alone, or two or more kinds of these may be mixed and used in combination.

The rate of use of each of these monomers containing one or two ethylenic unsaturated double bonds in a molecule is preferably set to 10 to 40% by weight, more preferably, to 20 to 40% by weight, relative to 100% by weight of the total amount of the constituent components of the hard coat layer.

Moreover, in the present invention, as modifiers for the hard coat layer, a coating-property improving agent, an antifoamer, a thickener, an antistatic agent, an organic lubricant, an organic polymer compound, an ultraviolet-ray absorbing agent, a photo-stabilizer, dyes, pigments or stabilizers may be used, and these may be used as composition components of the coating layer forming the hard coat layer within a range that would not impair a reaction by an active ray or heat, so that the characteristics of the hard coat layer can be improved depending on the applications.

In the present invention, as the method for curing the hard coat layer, for example, a method for applying ultraviolet rays or the like as active rays, a high-temperature heating method and the like may be used, and when these methods are used, a photopolymerization initiator, a thermal polymerization initiator or the like is preferably added to the hard coating composition.

Specific examples of the photopolymerization initiator include carbonyl compounds, such as acetophenone, 2,2-diethoxyacetophenone, p-dimethylacetophenone, p-dimethylaminopropiophenone, benzophenone, 2-chlorobenzophenone, 4,4′-dichlorobenzophenone, 4,4′-bisdiethylaminobenzophenone, Michler's ketone, benzyl, benzoin, benzoin methylether, benzoin ethylether, benzoin isopropylether, methyl benzoyl formate, p-isopropyl-α-hydroxyisobutyl phenone, α-hydroxyisobutylphenone, 2,2-dimethoxy-2-phenylacetophenone and 1-hydroxycyclohexylphenyl ketone, and sulfur compounds, such as tetramethylthiuram monosulfide, tetramethylthiuram disulfide, thioxanthone, 2-chlorothioxanthone and 2-methylthioxanthone. One of these photopolymerization initiators may be used alone, or two or more kinds of these may be used in combination. Moreover, as the thermal polymerization initiator, peroxide compounds, such as benzoyl peroxide or di-t-butyl peroxide may be used.

The amount of use of the photopolymerization initiator or the thermal polymerization initiator is appropriately set in a range of 0.01 to 10 parts by weight relative to 100 parts by weight of the total amount of the constituent components of the hard coat layer. In the case when an electron beam or a gamma beam is used as a curing means, the polymerization initiator is not necessarily required to be added. Moreover, in the case when the thermal curing process is carried out at a high temperature of 200° C. or more, the polymerization initiator is not necessarily required to be added.

In order to prevent thermal polymerization in production and dark reaction in storage, a thermal polymerization inhibitor, such as hydroquinone, hydroquinone monomethyl ether or 2,5-t-butyl hydroquinone, is preferably added to the hard coat-layer forming composition to be used in the present invention. The amount of addition of the thermal polymerization inhibitor is preferably set in a range from 0.005 to 0.05% by weight relative to 100% by weight of the total amount of the hard coat-layer constituent components.

The hard coat-layer forming composition to be used in the present invention is preferably allowed to contain a silicone-based leveling agent. With this arrangement, the concave sections of the hard coat layer can be easily formed in a stable manner. As the silicone-based leveling agent, a material having polydimethyl siloxane as its basic skeleton to which a polyoxyalkylene group is added is preferably used, and, for example, a dimethylpolysiloxane-polyoxyalkylene copolymer (for example, SH190: made by Toray Dow Corning Inc.) is proposed. The content of the silicone-based leveling agent is preferably set in a range from 0.01 to 5% by weight relative to 100% by weight of the total amount of the hard coat-layer constituent components.

Moreover, in the case of using a laminated structure in which a laminated layer is further formed on the hard coat layer as the resin layer of the plasma display-use filter of the present invention, an attempt needs to be made so as not to impair the coating property and adhesive property of the resin layer to be formed on the hard coat layer, and in this case, an acryl-based leveling agent is preferably applied to the hard coat layer. As such a leveling agent, for example, “ARUFON-UP1000 Series, UH2000 Series, UC3000 Series (trade names): made by Toagosei Co., Ltd.” or the like is preferably used. The amount of addition of the leveling agent is preferably set in a range from 0.01 to 5% by weight relative to 100% by weight of the total amount of the hard coat-layer constituent components. By adding the leveling agent to the hard coat layer in this manner, the coating property and adhesive property of an antireflection layer to be formed on the hard coat layer can be improved, in the case when, for example, the laminated film of the hard coat layer and the antireflection layer is used as the resin layer.

As the active ray to be used in the present invention on demand, electromagnetic waves that can polymerize an acryl-based vinyl group, such as ultraviolet rays, electron beam and radioactive rays (α rays, β rays, γ rays and the like) are proposed, and in practical use, ultraviolet rays are simple and preferably used. As the source of ultraviolet rays, an ultraviolet-ray fluorescent lamp, a low-pressure mercury lamp, a high-pressure mercury lamp, an ultrahigh-pressure mercury lamp, a xenon lamp, a carbon arc lamp or the like may be used. Moreover, upon irradiation with the active ray, when the irradiation is carried out under a low oxygen concentration, the curing process can be carried out efficiently. Furthermore, in the electron beam system, it is necessary to carry out the operation under an inert gas atmosphere by using an expensive equipment; however, this method is advantageous in that no photopolymerization initiator, photosensitive agent or the like needs to be contained in the coating layer.

As the heat required for thermo-setting process of the present invention, heat is proposed which is given by blowing air or an inert gas, having a temperature of at least 140° C. or more heated by a steam heater, an electric heater, an infrared-ray heater, a far-infrared ray heater or the like, to the substrate or the coated film by using a slit nozzle, and among heats of this kind, heat derived from air heated to 200° C. or more is preferably used, and heat derived from nitrogen heated to 200° C. or more is more preferably used because of its faster curing speed.

As the curing method for the hard coat layer, from the viewpoints of applying a high hardness to the hard coat layer and of obtaining high productivity, a method for applying an active ray is preferably used, and in particular, a method for applying ultraviolet rays is more preferably used. Therefore, the hard coat layer of the present invention is preferably prepared as a hard coat layer of an ultraviolet-ray curable type.

Moreover, as described earlier, the hard coat layer may contain particles. This structure is obtained in the same manner as described earlier.

### (Antireflection Layer)

As the antireflection layer in the present invention, for example, a layer is proposed in which a thin film made from a fluorine-based transparent polymer resin, a magnesium fluoride-based or silicon-based resin, or silicon oxide, having a low refractive index of 1.5 or less, more preferably, 1.4 or less, in visible range is formed as a single layer with an optical film thickness of, for example, ¼ wavelength, and another layer is proposed in which a multi-layer laminated structure, which has two or more thin layers made from inorganic compounds, such as metal oxide, fluoride, silicate, nitride, sulfide or the like, or organic compounds, such as a silicon-based resin, an acrylic resin, a fluorine-based resin or the like, having different refractive indexes, is formed; however, a layer structure in which a low-refractive-index layer and a high-refractive-index layer are laminated from the outermost surface is preferably used as a well balanced structure of performances and costs, and in the present invention, the antireflection layer may be prepared as a structure having not a laminated structure, but only the low-refractive-index layer, or as a structure in which both the low-refractive-index layer and the high-refractive-index layer are formed. The antireflection layer is normally laminated on the hard coat layer.

Although not particularly limited, the method for forming the antireflection layer is preferably prepared as a method for applying paint by using a wet-coating process, from the viewpoint of a well-balanced state between costs and performances. The applying method for the paint, methods, such as a micro-gravure coating method, a spin-coating method, a dip-coating method, a curtain flow-coating method, a roll-coating method, a spray-coating method and a flow-coating method, are preferably used, and from the viewpoint of uniformity in the thickness of the coat, the micro-gravure coating method is more preferably used. After the applying process, a heating process, a drying process and a curing process by using heat or active rays such as ultraviolet rays are carried out so that the respective coat films are formed.

In the case when, for example, a laminated body made of a hard coat layer and an antireflection layer is used as the resin layer, the antireflection layer of the present invention is formed on the outermost surface of the plasma display-use filter. For this reason, since it is troublesome when scratches are caused upon wiping dusts or the like adhered to the surface of the antireflection layer with a cloth or the like, the surface is preferably designed to have a scratch-resistant property of third grade or more in the aforementioned scratch-resistant property by the use of steel wool. More preferably, the surface is allowed to have a scratch-resistant property of fourth grade or more.

Although the antireflection layer of the present invention is not particularly limited as long as it has an antireflective performance, the following description will discuss a more preferable mode of the antireflection layer, a more preferably mode of the high refractive-index layer and a more preferably mode of the low refractive-index layer.

In the present invention, the more preferable antireflection layer is allowed to satisfy three conditions that (1) the lowest reflectance is 0.6% or less, (2) the highest reflectance is 2.5% or less and (3) the difference between the highest reflectance and the lowest reflectance is less than 2.5%, in the absolute reflection spectrum at 5° in a wavelength range from 400 to 700 nm. When the lowest reflectance exceeds 0.6%, the antireflective function becomes insufficient, failing to provide a preferable structure. Moreover, when the highest reflectance exceeds 2.5%, the reflectance in the vicinity of 450 nm or in the vicinity of 700 nm becomes higher, with the result that a bluish or reddish color tone appears in the reflected light, failing to provide a preferable structure. More preferably, the lowest reflectance is set to 0.5% or less, most preferably, to 0.3% or less, the highest reflectance is set to 2.0% or less, and the difference between the highest reflectance and the lowest reflectance is set to less than 2.0%, most preferably, to less than 1.5%; thus, when all these conditions are satisfied, a flatter reflection spectrum is preferably obtained, with a neutral color tone being preferably achieved.

In the particularly preferable antireflection layer, in order to set the lowest reflectance and the highest reflectance as well as the difference between the reflectances in absolute reflection spectra in a wavelength range from 400 to 700 nm to the above-mentioned ranges, the refractive indexes of the low reflective-index layer and the high reflective-index layer are adjusted in the following manner.

The refractive index (nL) of the low refractive-index layer is preferably set in a range from 1.23 to 1.42, more preferably, from 1.34 to 1.38. Moreover, the refractive index (nH) of the high refractive-index layer is preferably set in a range from 1.55 to 1.80, more preferably, from 1.60 to 1.75. Furthermore, the difference in the refractive indexes between the low refractive-index layer and the high refractive-index layer is preferably set to 0.15 or more.

Moreover, the refractive index of the hard coat layer is desirably adjusted. The refractive index (nG) of the hard coat layer is preferably set to 1.45 to 1.55. In this case, the refractive index (nL) of the low reflective-index layer and the refractive index (nH) of the high reflective-index layer are designed to satisfy the following equations (1) and (2) so that the lowest reflectance is preferably made lower.

(nH)={(nL)×(nG)}^{1/2}±0.02 (1)

(nL)={(nH)/(nG)}^{1/2}±0.02 (2)

In order to allow the antireflection layer to obtain a flatter reflection spectrum, the product (corresponding to an optical thickness) of the refractive index (nH) of the high refractive-index layer and the thickness (dH) of the high refractive-index layer is preferably designed to a thickness (dH) that corresponds to 1.0 to 1.7 times the ¼ wavelength of wavelength (λ) of visible light ray whose reflection is to be prevented, more preferably, to 1.3 to 1.6 times. When the product is lower than 1.0 time, this state is not preferable because the difference between the highest refractive index and the lowest refractive index exceeds 2.5%. In contrast, when the product exceeds 1.7 times, this state is not preferable because the lowest reflectance becomes higher than 0.6% to make the antireflective performance insufficient. In this case, the wavelength (λ) of visible light ray whose reflection is to be prevented is arbitrarily selected as long as it is located within a visible light range; however, normally, it is desirably set within a range from 450 to 650 nm.

When the preferable range of the refractive index (nH) of the high refractive-index layer and the wavelength (λ) whose reflection is to be prevented are taken into consideration, the thickness (dH) of the high refractive-index layer is preferably set to 100 to 300 nm, more preferably, to 100 to 200 nm in order to allow the antireflection layer to obtain a flatter reflection spectrum.

On the other hand, the thickness (dL) of the low refractive-index layer is preferably set to such a thickness (dL) that the product of the refractive index (nL) of the low refractive-index layer located in the above-mentioned range and the thickness (dL) of the low refractive-index layer is made to a thickness (dL) corresponding to 0.7 to 1.0 time the ¼ of the wavelength (λ) of visible light ray whose reflection is to be prevented, more preferably, to 0.7 to 0.95 times thereof. When these points are taken into consideration, the thickness (dL) of the low refractive-index layer is set in a range from 70 to 160 nm in order to allow the antireflection layer to obtain a flatter reflection spectrum. The thickness (dL) of the low refractive-index layer is preferably set to 80 to 140 nm, more preferably, to 85 to 105 nm.

Moreover, in order to obtain a flat reflection spectrum, the ratio (dH/dL) of the thickness (dH) of the high refractive-index layer and the thickness (dL) of the low refractive-index layer is preferably set to 1.0 to 1.9. When the ratio becomes lower than 1.0, the highest reflectance becomes higher than 2.5%, and the difference between the highest reflectance and the lowest reflectance also exceeds 2.5%, with the result that a reflection spectrum forms a V-shape, causing red and blue interference colors to appear. In contrast, in the case when the ratio exceeds 1.9, although a flat reflection spectrum can be obtained, the lowest reflectance becomes higher than 0.6%, making the antireflective function insufficient. The ratio (dH/dL) is preferably set to 1.1 to 1.8, more preferably, to 1.2 to 1.7; thus, it becomes possible to obtain a flat reflection spectrum, with the lowest reflectance being made lower.

In the particularly preferable antireflection layer of the present invention, a material, formed by scattering metal compound particles into a resin composition, is preferably used as a constituent component of the high refractive-index layer, so as to apply an antistatic property to the surface of the antireflection layer. A (meth)acrylate compound is used as the resin component. The (meth)acrylate compound is preferably used because it is radically polymerized upon irradiation with an active light ray to improve the solvent-resistant property and the hardness of a film to be formed, and a polyfunctional (meth)acrylate compound having two or more (meth)acryloyl groups in a molecule is more preferably used in the present invention because it improves the solvent-resistant property and the like. Examples thereof include: trifunctional (meth)acrylates, such as pentaerythritol tri(meth)acrylate, trimethylolpropane tri(meth)acrylate, glycerol tri(meth)acrylate, ethylene-modified trimethylolpropane tri(meth)acrylate, tris-(2-hydroxyethyl)-isocyanuric acid ester tri(meth)acrylate, and tetrafunctional or greater functional (meth)acrylates, such as pentaerythritol tetra(meth)acrylate, dipentaerythritol penta(meth)acrylate and dipentaerythritol hexa(meth)acrylate.

As the resin component, a (meth)acrylate compound having an acidic functional group, such as a carboxyl group, a phosphoric acid group and a sulfonic acid group, may be used so as to improve the scattering property of the metal compound particles. More specifically, examples of the acidic functional-group-containing monomer include: an unsaturated carboxylic acid, such as acrylic acid, methacrylic acid, crotonic acid, 2-methacryloyloxy ethyl succinic acid and 2-methacryloxy ethyl phthalic acid; phosphoric acid (meth)acrylic acid esters, such as mono(2-(meth)acryloyloxyethyl) acid phosphate and diphenyl-2-(meth)acryloyloxyethyl phosphate; and 2-sulfoexter(meth)acrylate. In addition, other (meth)acrylate compounds having a bond with a polarity, such as an amid bond, an urethane bond and an ether bond may be used.

As the metal compound particles to be used in this case, various conductive metal compound particles are preferably used. In particular, tin-containing antimony oxide particles (ATO), zinc-containing antimony oxide particles, tin-containing indium oxide particles (ITO), zinc oxide/aluminum oxide particles, antimony oxide particles and the like are preferably used. More preferably, tin-containing indium oxide particles (ITO) are used.

With respect to the conductive metal compound particles providing a conductive property, those particles having an average primary particle size in a range from 0.005 to 0.05 μm are preferably used. When the average primary particle size exceeds 0.05 μm, the resulting coat film (high refractive-index layer) tends to become poor in transparency. Moreover, in the case of the average primary particle size of less than 0.005 μm, the metal compound particles tend to easily aggregate, with the result that the resulting coat film (high refractive-index layer) has an increased haze value. Any of these cases make it difficult to obtain a desired haze value. Moreover, in the case when a laminated structure of a hard coat layer and an antireflection layer is used as the resin layer (with the hard coat layer being formed on the conductive layer side) and when an attempt is made to control the Ra of the resin layer by controlling the Ra of the hard coat layer, the addition of particles having a large particle size exceeding 0.05 μm to the high refractive-index layer of the antireflection layer sometimes causes the Ra of the resin layer uppermost surface to fail to follow the Ra of the hard coat layer, with the result that the particles of the antireflection layer tend to give adverse effects to the Ra of the resin layer uppermost surface. The primary particle size refers to a particle size that is obtained by measuring particles that are left standing therein by using an electronic microscope, an adsorption method by the use of a gas or a solute, an air flowing method, an X-ray small-angle scattering method or the like.

In order to further improve the conductivity effect, a conductive polymer, such as polypyrrole, polythiophene and polyaniline, and an organic metal compound, such as metal alcoholate and a chelate compound, may be further added to the constituent component of the high refractive-index layer.

Upon forming the high refractive-index layer, an initiator may be used so as to accelerate the curing process of the applied resin component. As the initiator, various photopolymerization initiators, which are used for initiating or accelerating the polymerizing and/or cross-linking reaction of the coated binder component by a radical reaction, an anionic reaction, a cationic reaction or the like, and include conventionally known compounds, such as thioxanthone derivatives, azo compounds, diazo compounds, aromatic carbonyl compounds, dialkyl amino benzoic acid esters, peroxides, acridine derivatives, phenazine derivatives, quinoxaline derivatives, and the like, may be used. The amount of the photopolymerization initiator to be added is normally set to 0.1 to 20 parts by weight, more preferably, to 1 to 15 parts by weight, relative to 100 parts by weight of the total amount of the constituent components of the high refractive-index layer. When set to this preferable range, the photopolymerization proceeds sufficiently faster to provide satisfactory hardness and scratch-resistant property so that only the light irradiation in a short period of time is required, while functions of the coated film, such as conductivity, abrasion-resistant property and weather-resistant property, are property maintained, without being lowered.

Moreover, upon forming the high refractive-index layer, an amine compound may be allowed to coexist with the photopolymerization initiator so as to prevent the initiator from being lowered in its sensitivity due to oxygen inhibition. If necessary, various additives, such as a polymerization inhibitor, a curing catalyst, an antioxidant, a scattering agent, a leveling agent, a silane coupling agent and the like, may be added thereto. Moreover, in an attempt to improve the surface hardness, alkyl silicates and their hydrolyzed materials, inorganic particles, such as colloidal silica, dry silica, wet silica and titanium oxide, silica fine particles scattered into a colloidal state and the like, may be further contained therein.

With respect to the compounding ratio of the constituent components of the high refractive-index layer, the resin component and the metal compound particles are preferably set to a weight ratio [(A)/(B)] in a range from 10/90 to 30/70, more preferably, to 15/85 to 25/75. When the metal compound fine particles are set within this preferable range, the resulting films have sufficient transparency and superior conductivity, without causing degradation of physical and chemical strengths in the resulting films.

The plasma display panel-use filter is easily subjected to adhesion of dusts due to static electricity charge, and since the human body tends to receive an electric shock due to a discharge released when the human body is made in contact therewith, it is preferably subjected to an anti-static treatment. In order to allow the high refractive-index layer to exert an anti-static property in a preferable level, the amount of addition is preferably controlled so that the surface resistance value of the layer is set to 1×10¹¹ Ω/sheet or less, more preferably, to 1×10¹⁰ Ω/square or less.

From the viewpoints of clearness and transparency, the high refractive-index layer is preferably set to 40% or more, more preferably, to 50% or more, in its total light-ray transmittance.

The high refractive-index layer is formed through processes in which a coating solution is dispersed with a solvent to be adjusted, and after the resulting coating solution has been applied onto a hard coat layer, the layer is dried and cured.

A solvent to be used upon forming the high refractive-index layer is blended so as to improve the coating or printing workability and also to improve the scattering property of the metal compound particles, and any one of conventionally known organic solvents may be used as long as it dissolves the resin component. In particular, in the present invention, from the viewpoints of stability in viscosity and drying property of the composition, an organic solvent having a boiling point in a range from 60 to 180° C. is preferably used, and those organic solvents having oxygen atoms are more preferably used because of their affinity with the metal compound particles. More specifically, preferable examples of the organic solvent include: methanol, ethanol, isopropyl alcohol, n-butanol, tert-butanol, ethylene glycol monomethyl ether, 1-methoxy-2-propanol, propylene glycol monomethyl ether, cyclohexanone, butyl acetate, isopropyl acetone, methylethyl ketone, methylisobutyl ketone, diacetyl acetone, acetyl acetone and the like. One of these may be used alone, or two or more kinds of these may be mixed and used.

Moreover, the amount of the organic solvent is set to a desired amount so as to allow the composition to have a viscosity having superior workability in accordance with the coating means and the printing means, and the amount is preferably set to a level in which the solid-component concentration of the normal composition is set to 60% by weight or less, more preferably, to 50% by weight or less. As the preparation method for the photo-curable conductive film-forming composition, although any desired methods may be used, a method is preferably used in which metal compound particles are added to a solution prepared by dissolving a normal resin component therein by using an organic solvent, and then scattered by using a dispersing machine, such as a paint shaker, a ball mill, a sand mill, a triple roll, an attritor and a homomixer, and to this is then added a photopolymerizaton initiator and dissolved therein uniformly.

In a particularly preferable mode of the antireflection layer of the present invention, the low refractive-index layer is desirably formed by coating the layer with a paint composition made from silica fine particles having voids included therein, a siloxane compound, a curing agent and a solvent so that it is possible to reduce the refractive index and consequently to preferably lower the surface reflectance.

In order to improve the surface hardness and also to provide a superior scratch-resistant property, the low refractive-index layer desirably has a structure in which a siloxane compound serving as a matrix material and silica fine particles are firmly bonded to each other, and for this purpose, in the coating composition in a stage prior to the coating process, the siloxane compound is preliminarily made to react with the surface of each silica fine particle so as to be bonded thereto.

A coating composition for use therein can be obtained by hydrolyzing a silane compound in a solvent in the presence of silica fine particles by using an acidic catalyst so that a silanol compound is produced, and the silanol compound is then subjected to a condensation reaction. To provide the silanol compound, one or more kinds of silane compounds selected from the group consisting of silane compounds represented by the following formulas (1) to (5) are preferably used.

The resulting paint contains a siloxane compound that is a condensed product of these silane compounds. Moreover, the paint may also contain a non-condensed silanol compound derived from silane compounds that have been hydrolyzed.

R¹Si(OR⁶)₃ (1)

In this formula, R¹ represents a fluoroalkyl group having 3 to 17 fluorine atoms. The number of fluorine atoms of R¹ is preferably set to 6 to 8. When there are many fluorine atoms per each molecule, the resulting coated film tends to have a poor hardness. The number of carbon atoms of R¹ is preferably set to 3 to 10 because this makes it possible to enhance the scratch-resistant property of the resulting coated film. In particular, the number of carbon atoms is more preferably set to 3. R⁶ represents a methyl group, an ethyl group, a propyl group, an isopropyl group or an acetyl group, and these may be the same or different from one another. Preferably, R⁶ is prepared as a methyl group or an ethyl group. In the case when a tri-functional silane compound, represented by formula (1), is used, the resulting coated film is desirably made to have a low refractive index.

R²Si(OR⁷)₃ (2)

In this formula, R² represents a group selected from the group consisting of a vinyl group, an aryl group, an alkenyl group, an acrylic group, a methacrylic group, a methacryloxy group, a cyano group, an epoxy group, a glycidoxy group and an amino group as well as a substituent of these. The number of carbon atoms of R² is preferably set to 2 to 10 because this makes it possible to enhance the scratch-resistant property of the resulting coated film. R⁷ represents a methyl group, an ethyl group, a propyl group, an isopropyl group, a methoxyethyl group, or an acetyl group, and these may be the same or different from one another. Preferably, R⁷ is prepared as a methyl group or an ethyl group. In the case when a tri-functional silane compound, represented by formula (2), is used, the resulting coated film is desirably allowed to have an increased hardness.

R³Si(OR⁸)₃ (3)

In this formula, R³ represents a hydrogen atom, or a group selected from the group consisting of an alkyl group, an aryl group and a substituent thereof. The number of carbon atoms of R³ is preferably set to 1 to 6 because this makes it possible to preferably enhance the scratch-resistant property of the resulting coated film. R⁸ represents a methyl group, an ethyl group, a propyl group, or a butyl group, and these may be the same or different from one another. Preferably, R⁸ is prepared as a methyl group or an ethyl group. In the case when a tri-functional silane compound, represented by formula (3), is used, the resulting coated film is desirably allowed to have an increased hardness.

R⁴R⁵Si(OR⁹)₂ (4)

In this formula, each of R⁴ and R⁵ represents a hydrogen atom, or a group selected from the group consisting of an alkyl group, a fluoroalkyl group, an aryl group, an alkenyl group, a methacryloxy group, an epoxy group, a glycidoxy group, an amino group and a substituent thereof, and these may be the same or different from one another. The number of carbon atoms of each of R⁴ and R⁵ is preferably set to 1 to 6 because this makes it possible to preferably enhance the scratch-resistant property of the resulting coated film. R⁹ represents a methyl group, an ethyl group, a propyl group, an isopropyl group, or an acetyl group, and these may be the same or different from one another. Preferably, R⁹ is prepared as a methyl group or an ethyl group. In the case when a di-functional silane compound, represented by formula (4), is used, the resulting coated film is desirably allowed to have improved flexibility.)

Si(OR¹⁰)₄ (5)

In this formula, R¹⁰ represents a methyl group or an ethyl group, and these may be the same or different from each another. Preferably, R⁹ is prepared as a methyl group or an ethyl group. In the case when a tetra-functional silane compound, represented by formula (5), is used, the resulting coated film is desirably allowed to have an improved hardness.

Each of the silane compounds represented by formulas (1) to (5) may be used alone, or two or more kinds of these may be combined with one another and used.

Upon forming a coated film, the content of the siloxane compound is preferably set to 20% by weight to 70% by weight, more preferably, to 30% by weight to 60% by weight, relative to the total amount of the coated film. By setting the content of the siloxane compound in this range, it is possible to preferably reduce the refractive index of the coated film and also to preferably increase the hardness of the coated film. Therefore, the content of the siloxane compound in the paint is desirably set in the above-mentioned range, relative to the total components except for the solvent.

Among these, in order to achieve a low refractive index, the fluorine-containing silane compound represented by formula (1) is used as an essential component, and one or more kinds of silane compounds selected from the group consisting of the silane compounds represented by formulas (2) to (5) may be preferably combined therewith and used. The amount of the silane compound represented by formula (1) is preferably set to 20% by weight to 80% by weight, more preferably, to 30% by weight to 60% by weight, relative to the total amount of all the silane compounds. When the amount of the silane compound becomes less than 20% by weight, the lowered refractive index tends to be insufficient. In contrast, when the amount of the silane compound exceeds 80% by weight, the hardness of the coated film tends to be lowered.

Specific examples of the silane compounds represented by formulas (1) to (5) are shown below.

As the tri-functional silane compound represented by formula (1), examples thereof include: trifluoromethyl trimethoxy silane, trifluoromethyl triethoxy silane, trifluoromethyl triacetoxy silane, trifluoropropyl trimethoxy silane, trifluoropropyl triethoxy silane, trifluoropropyl triacetoxy silane, trifluoroacetoxyethyl trimethoxy silane, trifluoroacetoxyethyl triethoxy silane, trifluoroacetoxyethyl triacetoxy silane, perfluoropropylethyl trimethoxy silane, perfluoropropylethyl triethoxy silane, perfluoropropylethyl triacetoxy silane, perfluoropentylethyl trimethoxy silane, perfluoropentylethyl triethoxy silane, perfluoropentylethyl triacetoxy silane, tridecafluorooctyl trimethoxy silane, tridecafluorooctyl triethoxy silane, tridecafluorooctyl tripropoxy silane, tridecafluorooctyl triisopropoxy silane, heptadecafluorodecyl trimethoxy silane and heptadecafluorodecyl triethoxy silane. Among these, from the viewpoint of the hardness of the resulting coated film, trifluoromethyl trimethoxy silane, trifluoromethyl triethoxy silane, trifluoropropyl trimethoxy silane and trifluoropropyl triethoxy silane are preferably used.

As the trifunctional silane compound represented by formula (2), examples thereof include: vinyl trimethoxy silane, vinyl triethoxy silane, vinyl triacetoxy silane, γ-methacryloxypropyl trimethoxy silane, γ-methacryloxypropyl triethoxy silane, γ-aminopropyl trimethoxy silane, γ-aminopropyl triethoxy silane, N-β-(aminoethyl)-γ-aminopropyl trimethoxy silane, β-cyanoethyl triethoxy silane, glycidoxymethyl trimethoxy silane, glycidoxymethyl triethoxy silane, α-glycidoxyethyl trimethoxy silane, α-glycidoxyethyl triethoxy silane, β-glycidoxyethyl trimethoxy silane, β-glycidoxyethyl triethoxy silane, α-glycidoxypropyl trimethoxy silane, α-glycidoxypropyl triethoxy silane, β-glycidoxypropyl trimethoxy silane, β-glycidoxypropyl triethoxy silane, γ-glycidoxypropyl trimethoxy silane, γ-glycidoxypropyl triethoxy silane, γ-glycidoxypropyl tripropoxy silane, γ-glycidoxypropyl tributhoxy silane, γ-glycidoxypropyl trimethoxy silane, α-glycidoxybutyl trimethoxy silane, α-glycidoxybutyl triethoxy silane, β-glycidoxybutyl trimethoxy silane, β-glycidoxybutyl triethoxy silane, γ-glycidoxybutyl trimethoxy silane, γ-glycidoxybutyl triethoxy silane, δ-glycidoxybutyl trimethoxy silane, δ-glycidoxybutyl triethoxy silane, (3,4-epoxycyclohexyl)methyl trimethoxy silane, (3,4-epoxycyclohexyl)methyl triethoxy silane, β-(3,4-epoxycyclohexyl)methyl trimethoxy silane, β-(3,4-epoxycyclohexyl)methyl triethoxy silane, β-(3,4-epoxycyclohexyl)ethyl tripropoxy silane, β-(3,4-epoxycyclohexyl)ethyl tributhoxy silane, β-(3,4-epoxycyclohexyl)ethyl trimethoxyethoxy silane, β-(3,4-epoxycyclohexyl)ethyl triphenoxy silane, β-(3,4-epoxycyclohexyl)propyl trimethoxyethoxy silane, β-(3,4-epoxycyclohexyl)propyl triethoxy silane, δ-(3,4-epoxycyclohexyl)butyl trimethoxyethoxy silane and δ-(3,4-epoxycyclohexyl)butyl triethoxy silane. Among these, from the viewpoint of the hardness of the resulting coated film, vinyl trialkoxy silane and 3-methacryloxypropyl trialkoxy silane are preferably used.

As the trifunctional silane compound represented by formula (3), examples thereof include: methyl trimethoxy silane, methyl triethoxy silane, methyl trimethoxyethoxy silane, methyl triacetoxy silane, methyl tripropoxy silane, methyl tributoxy silane, ethyl trimethoxy silane, ethyl triethoxy silane, hexyl trimethoxy silane, octadecyl trimethoxy silane, octadecyl triethoxy silane, phenyl trimethoxy silane, phenyl triethoxy silane, 3-aminopropyl triethoxy silane, N-2-(aminoethyl)-3-aminopropyl trimethoxy silane, 3-chloropropyl trimethoxy silane, 3-(N,N-diglycidyl)aminopropyl trimethoxy silane and 3-glycidoxypropyl trimethoxy silane. Among these, from the viewpoint of the hardness of the resulting coated film, methyl trimethoxy silane, ethyl triethoxy silane, phenyl trimethoxy silane and phenyl triethoxy silane are preferably used.

As the difunctional silane compound represented by formula (4), examples thereof include: dimethyl dimethoxy silane, dimethyl diethoxy silane, dimethyl diacetoxy silane, diphenyl dimethoxy silane, diphenyl diethoxy silane, methylphenyl dimethoxy silane, methylvinyl dimethoxy silane, methylvinyl diethoxy silane, γ-glycidoxypropylmethyl dimethoxy silane, γ-aminopropylmethyl dimethoxy silane, γ-aminopropylmethyl diethoxy silane, N-2-(aminoethyl)-3-aminopropylmethyl dimethoxy silane, γ-methacryloxypropylmethyl dimethoxy silane, γ-methacryloxypropylmethyl diethoxy silane, glycidoxymethyl dimethoxy silane, glycidoxymethylmethyl diethoxy silane, α-glycidoxyethylmethyl dimethoxy silane, α-glycidoxyethylmethyl diethoxy silane, β-glycidoxyethylmethyl dimethoxy silane, β-glycidoxyethylmethyl diethoy-glycidoxypropylmethyl diphenoxy silane,xy silane, α-glycidoxypropylmethyl dimethoxy silane, α-glycidoxypropylmethyl diethoxy silane, β-glycidoxypropylmethyl dimethoxy silane, β-glycidoxypropylmethyl diethoxy silane, γ-glycidoxypropylmethyl dimethoxy silane, γ-glycidoxypropylmethyl diethoxy silane, γ-glycidoxypropylmethyl dipropoxy silane, β-glycidoxypropylmethyl dibutoxy silane, γ-glycidoxypropylmethyl dimethoxyethoxy silane, γ-glycidoxypropylmethyl diphenoxy silane, γ-glycidoxypropylmethyl diacetoxy silane, γ-glycidoxypropylethyl diethoxy silane, γ-glycidoxypropylvinyl dimethoxy silane, γ-glycidoxypropylvinyl diethoxy silane, trifluoropropylmethyl dimethoxy silane, trifluoropropylmethyl diethoxy silane, trifluoropropylmethyl diacetoxy silane, trifluoropropylethyl dimethoxy silane, trifluoropropylethyl diethoxy silane, trifluoropropylethyl diacetoxy silane, trifluoropropylvinyl dimethoxy silane, trifluoropropylvinyl diethoxy silane, trifluoropropylvinyl diacetoxy silane, heptadecafluorodecylmethyl dimethoxy silane, 3-chloropropylmethyl dimethoxy silane, 3-chloropropylmethyl diethoxy silane, cyclohexylmethyl dimethoxy silane, 3-methacryloxypropyl dimethoxy silane and octadecylmethyl dimethoxy silane. Among these, in an attempt to apply flexibility to the resulting coated film, dimethyldialkoxy silane is preferably used.

As the tetrafunctional silane compound represented by formula (5), examples thereof include tetramethoxy silane, tetraethoxy silane and the like.

As the silica fine particles to be used for the low refractive-index layer, particles having a number-average particle size in a range from 1 nm to 50 nm are preferably used. In the case of the number average particle size of less than 1 nm, the bonded state to the matrix material becomes insufficient to cause a reduction in the hardness of the coated film. In contrast, in the case of the number average particle size exceeding 50 nm, the generation of voids among particles formed by introducing many particles becomes lower to sometimes fail to sufficiently exert the effect of a low refractive index. In this case, with respect to the average particle size of silica fine particles, the number average particle size thereof can be measured by using various particle-size counters. The particle size of the silica fine particles is preferably measured prior to the addition to a paint. Moreover, after the coated film formation, a method for measuring the particle size of the silica fine particles in the coated film by using an electron scanning-type microscope or a transmission-type electron microscope is preferably used. The following description will exemplify a number-average particle-size measuring method in which a transmission-type electron microscope is used: a sample obtained by using an ultra-thin cutting method is observed by a transmission-type electron microscope (model H-7100FA made by Hitachi, Ltd.) at an acceleration voltage of 100 kV (about 100,000 times in magnification), and the average particle size can be obtained from the resulting image.

Moreover, in the case when a laminated structure of a hard coat layer and an antireflection layer is used as the resin layer (with the hard coat layer being formed on the conductive layer side) and when an attempt is made to control Ra of the resin layer by controlling Ra of the hard coat layer, the addition of particles having a large particle size exceeding 50 nm in the number-average particle size to the low refractive-index layer of the antireflection layer sometimes cause the Ra of the resin layer uppermost surface to fail to follow the Ra of the hard coat layer, with the result that the particles of the antireflection layer tend to give adverse effects to the Ra of the resin layer uppermost surface.

The number-average particle size of the silica fine particles to be used for the low refractive-index layer is preferably set to be smaller than the film thickness of the coated film to be formed. When this exceeds the film thickness of the coated film, the silica fine particles are exposed to the surface of the coated film, impairing the antireflective property, as well as causing degradation of the surface hardness and contamination preventive property of the coated film.

As the silica fine particles to be used for the low refractive-index layer, silica fine particles having a silanol group on the surface thereof are preferably used so as to easily react with the siloxane compound of the matrix. Moreover, silica fine particles having voids inside thereof are preferably used so as to lower the refractive index of the coated film. Since silica particles without voids inside thereof generally have a refractive index of their own particles in a range from 1.45 to 1.50, the reducing effect of the refractive index is small. In contrast, since the silica fine particles having voids inside thereof have a refractive index of their own particles in a range from 1.20 to 1.40, the reducing effect of the refractive index becomes greater when introduced into the layer. As the silica fine particles having voids inside thereof, for example, silica fine particles having voids, each enclosed by an outer shell, and porous silica fine particles having a large number of void portions are proposed. Of these, from the viewpoint of the hardness of the coated film, the porous silica fine particles having high strength in their own particles are preferably used. The refractive index of the fine particles is set to 1.20 to 1.40, more preferably, to 1.20 to 1.35. Moreover, the number-average particle size of the silica fine particles having voids inside thereof is preferably set to 1 nm to 50 nm. The refractive index of the silica fine particles can be measure by using a method disclosed in paragraph [0034] of JP-A No. 2001-233611. The silica fine particles having voids inside thereof can be manufactured by using, for example, a method disclosed in paragraphs from [0033] to [0046] of JP-A No. 2001-233611, or a method disclosed in paragraph [0043] of JP No. 3272111. Those commercially available particles in general can also be used.

Upon forming a coated film, the content of the silica fine particles to be used in the low refractive-index layer is preferably set to 30% by weight to 80% by weight, more preferably, to 40% by weight to 70% by weight, relative to the total amount of the coated film. Therefore, the content of the silica fine particles in the paint is desirably set in the above-mentioned range, relative to the total components except for the solvent. When the silica fine particles are contained in the coated film in this range, it becomes possible not only to lower the refractive index, but also to increase the hardness of the coated film. When the content of the silica fine particles becomes less than 30% by weight, the reducing effect of the refractive index caused by the voids among the particles becomes small. In contrast, when the content of the silica fine particles exceeds 80% by weight, a large number of island phenomena occur in the coating film, with the result that the hardness of the coated film is lowered, and the refractive index becomes irregular undesirably depending on places.

Moreover, the paint composition to be used for forming the low refractive-index layer as described earlier can be obtained through processes in which, by hydrolyzing a silane compound in a solvent in the presence of silica fine particles by using an acidic catalyst, a silanol compound is produced, and the silanol compound is then subjected to a condensation reaction, and in this hydrolytic reaction, after the acidic catalyst and water have been added to the solvent in 1 to 180 minutes, the reaction is preferably carried out at room temperature to 80° C. for 1 to 180 minutes. By carrying out the hydrolyzing reaction under these conditions, it becomes possible to suppress an abrupt reaction from occurring. The reaction temperature is preferably set to 40 to 70° C. Moreover, after a silanol compound has been obtained by the hydrolyzing reaction, the compound, as it is, may be preferably heated at a temperature higher than 50° C. below the boiling point of the solvent for 1 to 100 hours so as to be subjected to a condensing reaction. Moreover, in order to raise the polymerization degree of the siloxane compound, a reheating process or an adding process of a basic catalyst may be carried out.

As the acid catalyst to be used for the hydrolyzing reaction, for example, acid catalysts, such as a hydrochloric acid, an acetic acid, a formic acid, a nitric acid, an oxalic acid, a hydrochloric acid, a sulfuric acid, a phosphoric acid, a polyphosphoric acid, a polyhydric carboxylic acid or its anhydride and ion exchange resin, may be used. In particular, an acidic aqueous solution using the formic acid, acetic acid or phosphoric acid is preferably used. A preferable amount of addition of the acid catalyst is set to 0.05% by weight to 10% by weight, more preferably, to 0.1% by weight to 5% by weight, relative to the total amount of silane compounds. When the amount of the acid catalyst becomes less than 0.05% by weight, the hydrolyzing reaction sometimes fails to proceed sufficiently. When the amount of the acid catalyst exceeds 10% by weight, the hydrolyzing reaction might run away.

Although not particularly limited, the solvent is determined by taking into consideration the stability, wettability, volatility and the like of the paint composition. As the solvent, not only one kind thereof, but also two or more kinds thereof may be used as a mixture. Specific examples of the solvent include: alcohols, such as, methanol, ethanol, propanol, isopropanol, butanol, isobutanol, t-butanol, pentanol, 4-methyl-2-pentanol, 3-methyl-2-butanol, 3-methyl-3-methoxy-1-butanol and diacetone; glycols, such as ethylene glycol and propylene glycol; ethers, such as ethyleneglycol monomethyl ether, ethyleneglycol monoethyl ether, propyleneglycol monomethyl ether, propyleneglycol monoethyl ether, propyleneglycol monopropyl ether, propyleneglycol monobutyl ether, propyleneglycol mono-t-butyl ether, ethyleneglycol dimethyl ether, ethyleneglycol diethyl ether, ethyleneglycol dibutyl ether and diethyl ether; ketones, such as methylethyl ketone, acetyl acetone, methylpropyl ketone, methylbutyl ketone, methylisobutyl ketone, diisobutyl ketone, cyclopentane and 2-heptanone; amides, such as dimethyl formamide and dimethyl acetamide; acetates, such as ethyl acetate, propyl acetate, butyl acetate, isobutyl acetate, ethyleneglycol monoethylether acetate, propyleneglycol monomethylether acetate, 3-methoxybutyl acetate, 3-methyl-3-methoxybutyl acetate, methyl lactate and ethyl acetate; aromatic or aliphatic hydrocarbons, such as toluene, xylene, hexane and cyclohexane; and in addition to these, γ-butyrolactone, N-methyl-2-pyrrolidone and dimethylsulfoxide may be used.

The amount of the solvent to be used at the time of the hydrolyzing reaction is preferably set in a range from 50% by weight to 500% by weight, more preferably, from 80% by weight to 200% by weight, relative to the total amount of all the silane compounds. When the amount of the solvent becomes less than 50% by weight, the reaction tends to run away to sometimes cause gelation. In contrast, when the amount of the solvent exceeds 500% by weight, the hydrolyzing reaction sometimes fails to progress.

Moreover, ion-exchanged water is preferably used as the water to be used for the hydrolyzing reaction. Although desirably selected, the amount of water is preferably set in a range from 1.0 to 4.0 moles per 1 mole of the silane compound.

Furthermore, as the curing agent to be added so as to cure the painting agent to form the low refractive-index layer, various curing agents or three-dimensional cross-linking agents, which accelerate the curing process of the paint composition or allow the curing process to be easily carried out, may be used. Specific examples of the curing agent include a nitrogen-containing organic substance, a silicone resin curing agent, various metal alcolates, various metal chelate compounds, an isocyanate compound and its polymer, melamine resin, polyfunctional acrylic resin, urea resin and the like, and one kind of these or two or more kinds of these may be added. Among these, from the viewpoints of stability of the curing agent and the processability of the resulting coated film, a metal chelate compound is preferably used. Examples of the metal chelate compound to be used include a titanium chelate compound, a zirconium chelate compound, an aluminum chelate compound and a magnesium chelate compound. Among these, for the purpose of lowering the refractive index, an aluminum chelate compound and/or a magnesium chelate compound having a low refractive index are preferably used. Each of these metal chelate compounds can be easily obtained by allowing a chelating agent to react with metal alkoxide. Preferable examples of the chelating agent include: β-diketones, such as acetyl acetone, benzoyl acetone and dibenzoyl methane, and β-keto acid esters, such as acetoethyl acetate and benzoylethyl acetate. Preferable specific examples of the metal chelate compound include: aluminum chelate compounds, such as ethylacetoacetate aluminum diisopropylate, aluminum tris(ethylacetoacetate), alkylacetoacetate aluminum diisopropylate, aluminum monoacetylacetate bis(ethylacetoacetate) and aluminum tris(acetylacetonate); and magnesium chelate compounds, such as ethylaceto acetate magnesium monoisopropylate, magnesium bis(ethylacetoacetate), alkylacetoacetate magnesium monoisopropylate and magnesium bis(acetylacetonate). Among these, aluminum tris(acetylacetonate), aluminum tris(ethylacetoacetate), magnesium bis(acetylacetonate) and magnesium bis(ethylacetoacetate) are preferably used. From the viewpoints of storage stability and easiness in availability, aluminum tris(acetylacetonate) and aluminum tris(ethylactoacetate) are, in particular, preferably used. The amount of addition of the curing agent is preferably set in a range from 0.1% by weight to 10% by weight, more preferably, from 1% by weight to 6% by weight, relative to the amount of all the silane compounds in the paint composition. In this case, the amount of all the silane compounds refers to an amount including all the silane compounds, hydrolyzed matters thereof and condensed matters thereof. In the case of the content less than 0.1% by weight, the hardness of the resulting coated film is lowered. In contrast, in the case of the content exceeding 10% by weight, the curing process becomes sufficient, with the result that, although the hardness of the coated film is improved, the refractive index is undesirably raised.

Moreover, for the paint composition, a solvent having a boiling point from 100 to 180° C. under atmospheric pressure and a solvent having a boiling point of less than 100° C. are preferably mixed with each other and used. By containing the solvent having a boiling point from 100 to 180° C. under atmospheric pressure, it becomes possible to provide a coating solution having a superior coating property, and consequently to obtain a coated film having a flat surface. Moreover, by containing the solvent having a boiling point of less than 100° C. under atmospheric pressure, the solvent is effectively evaporated upon forming a coated film so that the coated film having a high hardness can be obtained. Thus, it becomes possible to obtain a coated film that has a high hardness with a flat surface.

Specific examples of the solvent having a boiling point from 100 to 180° C. under atmospheric pressure include: ethers, such as ethylene glycol monomethyl ether, ethylene glycol monoethyl ether, propylene glycol monomethyl ether, propylene glycol monoethyl ether, propylene glycol monopropyl ether, propylene glycol monobutyl ether, propylene glycol mono-t-butyl ether, ethylene glycol dimethyl ether, ethylene glycol diethyl ether and ethylene glycol dibutyl ether; acetates, such as ethylene glycol monoethylether acetate, propylene glycol monomethylether acetate, propylene acetate, butyl acetate, isobutyl acetate, 3-methoxybutyl acetate, 3-methyl-3-methoxybutyl acetate, methyl lactate, ethyl lactate and butyl lactate; ketones, such as acetyl acetone, methylpropyl ketone, methylbutyl ketone, methylisobutyl ketone, cyclopentanone and 2-heptanone; alcohols, such as butanol, isobutyl alcohol, pentanol, 4-methyl-2-pentanol, 3-methyl-2-butanol, 3-methyl-3-methoxy-1-butanol and diacetone; and aromatic hydrocarbons, such as toluene and xylene. These may be used alone or as a mixture of two or more thereof. Among these, in particular, preferable examples of the solvent include propylene glycol monomethyl ether, propylene glycol monoethyl ether, propylene glycol monopropyl ether and diacetone alcohol.

Examples of the solvent having a boiling point of less than 100° C. under atmospheric pressure include: methanol, ethanol, isopropanol, t-butanol and methylethyl ketone. These may be used alone or as a mixture of two or more thereof.

The content of all the solvents in the paint composition is preferably set in a range from 1300% by weight to 9900% by weight, more preferably, from 1500% by weight to 6000% by weight, relative to the total content of silane compounds. When the content of all the solvents becomes less than 1300% by weight, or exceeds 9900% by weight, it becomes difficult to form a coated film with a predetermined film thickness. In this case, the total content of silane compounds refers to the amount including all the silane compounds, hydrolyzed matters thereof and condensed matters thereof

Moreover, in the present invention, in the case when the resin layer contains an antireflection layer, by allowing the antireflection layer to contain particles having an appropriate particle size, the Ra of the outermost surface of the resin layer can be controlled. However, as described earlier, since the particles to be contained in the antireflection layer are added so as to improve the surface hardness and scratch-resistant property in the case of a high refractive-index layer, and since they are added so as to improve the anti-static property in the case of a low refractive-index layer, those particles having an extremely small particle size are preferably used as various particles to be added to the antireflection layer. In the case when particles having an extremely small particle size are used for the antireflection layer, even in an attempt to also control the Ra of the outermost surface of the resin layer by controlling the Ra of the hard coat layer as well as by the use of a laminated structure of the hard coat layer and the antireflection layer as the resin layer (with the hard coat layer being formed on the conductive layer side), the particles to be used in the antireflection layer give no adverse effects to the center-line average roughness Ra of the resin layer.

### (Other Functional Layers)

The plasma display-use filter of the present invention is preferably provided with a functional layer having at least one function selected from the group consisting of a near infrared-ray shielding function, a color-tone correcting function, an ultraviolet-ray shielding function and an Ne cutting function. This functional layer may be prepared as one layer having a plurality of functions. Moreover, a laminated layer with a plurality of layers may be used as the functional layer.

The following description will discuss functional layers that configure the plasma display-use filter of the present invention.

### (Color-Tone Correcting Layer)

The color-tone correcting layer having a color-tone correcting function, which is one kind of the functional layer and a layer containing a coloring matter having a color-tone correcting property, carries out a color-tone correcting process on transmitted visible light rays, so as to improve the image characteristics of the plasma display panel, and more specifically to provide images having high contrast and highly clear colors. Moreover, the color-tone correcting layer makes it possible to adjust the transmittance of the entire plasma display-use filter and also to exert a function for adjusting image reflection characteristics.

The color-tone correcting process is carried out by selectively absorb visible light rays having specific wavelengths among visible light rays transmitted through the plasma display-use filter. Therefore, the coloring matter to be contained in the color-tone correcting layer is capable of absorbing the visible light rays having predetermined wavelengths selectively, and the coloring matter may be prepared as either a dye or a pigment. The term “to selectively absorb visible light rays with specific wavelengths” refers to the fact that among light rays within a wavelength range (wavelengths from 380 to 780 nm) of visible light rays, those light rays within a specific wavelength range are particularly absorbed. In this case, the wavelength range, particularly absorbed by the coloring matter, may be a single wavelength range or a plurality of wavelength ranges.

Specific examples of the coloring matter absorbing this specific wavelength include known organic pigments and organic dyes, as well as inorganic pigments, such as azo-based, condensed-azo-based, phthalocyanine-based, anthraquinone-based, indigo-based, perinone-based, perylene-based, dioxazine-based, quinacridone-based, methine-based, isoindolinone-based, quinophthalone-based, pyrrole-based, thioindigo-based and metal-complex-based pigments and dyes. Among these, in particular, phthalocyanine-based and anthraquinone-based coloring matters are preferably used because they have a superior weather resistant property. Additionally, any one of the above-mentioned coloring matters may be contained in the color-correcting layer, or two or more kinds of these may be contained therein.

Moreover, the plasma display-used filter sometimes needs to have a neutral gray or a blue gray in its transmission color. This is because, when the light-emitting characteristic and contrast of the plasma display panel need to be maintained or improved, white color having a color temperature slightly higher than that of standard white color is sometimes desirably used. Upon achieving such a requirement, the above-mentioned coloring matter can also be applied.

Various modes may be used as the color-tone correcting layer as long as a coloring matter having a color-correcting property is contained therein. The color-tone correcting layer may be formed by using a desired method in accordance with the mode. For example, in the case of a mode in which a coloring matter having a color-tone correcting property is contained in a sticker, the coloring matter having a color-tone correcting property may be added to the sticker as a dye or a pigment so that the resulting sticker is applied thereto to form a color-tone correcting layer having a predetermined thickness. As the sticker to be used for this purpose, commercially available stickers may be used, and preferable specific examples thereof include an acrylic acid ester copolymer, polyvinyl chloride, epoxy resin, polyurethane, a vinyl acetate copolymer, a styrene-acryl copolymer, polyester, polyamide, polyolefin, styrene-butadiene copolymer-based rubber, butyl rubber, silicone resin or the like.

In the case of a mode for carrying out coloring processes on the transparent substrate and the transparent substrate so as to form the color-tone correcting layer, the coloring matter having a color-correcting property, as it is, may be used as the dye or the pigment, or may be dissolved in a solvent, and applied and then dried thereon so that a color-tone correcting layer having a desired thickness can be formed. As the solvent to be used for this purpose, a ketone-based solvent, such as cyclohexane, an ether-based solvent, an ester-based solvent, such as butyl acetate, an ether alcohol-based solvent, such as ethyl cerosolve, a ketone alcohol-based solvent, such as diacetone alcohol, an aromatic-based solvent, such as toluene, and the like are proposed.

Moreover, in the case when the color-tone correcting layer corresponds to a transparent substrate having a coloring matter with a color-tone correcting property, a thermoplastic resin serving as a material for the transparent substrate is dissolved in a desired solvent, and to this solvent a coloring matter having a color-tone correcting property is added as the dye or pigment, so that the resulting solution is applied and dried thereon to form a color-tone correcting layer with a desired thickness. As the solvent to be used in this case, any solvent may be used as long as it can dissolve the resin serving as a material and can also dissolve or disperse the dye or pigment to be added thereto. Examples of the solvent used for this purpose include a ketone-based solvent, such as cyclohexane, an ether-based solvent, an ester-based solvent, such as butyl acetate, an ether alcohol-based solvent, such as ethyl cerosolve, a ketone alcohol-based solvent, such as diacetone alcohol, an aromatic-based solvent, such as toluene, and the like.

In the method for forming the color-tone correcting layer by applying a solution containing a coloring matter having a color-tone correcting property or a coloring matter having a color-tone correcting property, and a material resin for the transparent substrate, the coating method may be selected, for example, from a dip coating method, a roll coating method, a spray coating method, a gravure coating method, a comma coating method and a die coating method. These coating methods make it possible to carry out continuous processes, and are superior in productivity in comparison with a vapor deposition method and the like using a batch production system. Moreover, a spin coating method capable of forming a very thin uniform coated film may be adopted.

In order to obtain a sufficient color-tone correcting property, the thickness of the color-tone correcting layer is preferably set to 0.5 μm or more. Moreover, in order to obtain a superior light transmission property, more specifically, a superior visible light-ray transmission property, the thickness thereof is preferably set to 40 μm or less, more preferably, to 1 to 25 μm. In the case of the thickness of the color-tone correcting layer exceeding 40 μm, upon forming a color-tone correcting layer by applying a solution containing a desired dye or pigment and a transparent resin thereto, the solvent tends to remain thereon, making it undesirably difficult to provide sufficient operability in forming the color-tone correcting layer.

In the case when the color-tone correcting layer corresponds to a sticker layer containing a coloring matter having a color-tone correcting property or a transparent substrate having a coloring matter with a color-tone correcting property, the coloring matter is preferably contained therein at 0.1% by weight or more, more preferably, at 1% by weight or more, relative to the sticker agent or the thermoplastic resin. Moreover, in order to maintain physical properties of the sticker layer or the transparent substrate, the amount of the coloring matter having a color-tone correcting property is preferably suppressed to 10% by weight or less.

### (Near Infrared-Ray Shielding Layer)

The following description will discuss a near infrared-ray shielding layer having a near infrared-ray shielding function that is one type of the functional layer. Since strong near infrared rays, generated from a plasma display panel, give influences to a peripheral electronic apparatus, such as a remote controller, a cordless telephone and the like, to cause a muloperation, it is necessary to cut light rays within the near infrared area to a level that causes no problems in practical use. The wavelength range to cause problems is from 800 to 1000 nm, and it is necessary to limit the transmittance in the corresponding wavelength range to 20% or less, preferably, to 10% or less. In order to shield near infrared rays, the near infrared-ray shielding layer is normally allowed to contain a coloring matter having a near infrared-ray absorbing property with the maximum absorbing wavelength from 750 to 1100 nm, that is, a compound or the like, such as a polymethine-based, a phthalocyanine-based, a naphthalocyanine-based, a metal-complex-based, an aluminum-based, an immonium-based, a diimmonium-based, an anthraquinone-based, a diol metal-complex-based, a naphthoquinone-based, an indolphenol-based, an azo-based or a triallylmethane-based compound, is preferably used, and in particular, a metal complex-based, an aluminum-based, a phthalocyanine-based, a naphthalocyanine-based or a diimmonium based compound is preferably used. Additionally, in the case when the coloring matter having a near infrared-ray absorbing property is used, any one of these may be contained therein, or two or more kinds of these may be contained therein.

The structure, forming method, thickness and the like of the near infrared-ray absorbing layer are the same as those of the aforementioned color-tone correcting layer. The near infrared-ray absorbing layer may be prepared as the same layer as the color-tone correcting layer, that is, a layer in which a coloring matter having a color-tone correcting property and a coloring matter having a near infrared-ray absorbing property are contained in the color-tone correcting layer, or another near infrared-ray shielding layer different from the color-tone correcting layer may be formed. The content of the near infrared-ray absorbing coloring matter is preferably set to 0.1% by weight or more, more preferably, to 2% by weight or more, relative to the binder resin, and in order to properly maintain physical properties of the sticker layer or the transparent substrate containing the infrared-ray absorbing agent, the total amount of the coloring matter having a color-tone correcting function and the near infrared-ray absorbing agent is preferably suppressed to 10% by weight or less.

### (Ne-Cutting Layer)

The following description will discuss a functional layer having a Ne-cutting function, which is one type of the functional layer. One kind or a plurality of kinds of color-tone correcting agents, used for selectively absorb and attenuate extra light-emission colors (mainly having a wavelength range from 560 to 610 nm) derived from a discharge gas sealed inside the plasma display panel, for example, a two-component gas of neon and xenon, are preferably mixed and contained in the near infrared-ray shielding layer or the color-tone correcting layer. By providing this coloring matter structure, among visible light rays emitted from the display screen of the plasma display panel, those extra light rays derived from the light emission of a discharge gas can be absorbed and attenuated so that the display color of the visible light rays emitted from the plasma display panel can be made closer to a display color of the display target; thus, it becomes possible to display a natural color tone.

### (Ultraviolet-Ray Shielding Layer)

The following description will discuss an ultraviolet-ray shielding layer having an ultraviolet-ray shielding function, which is one type of the functional layer. In the plasma display-use filter of the present invention, the ultraviolet-ray shielding layer has a function for preventing optical degradation of the coloring matter contained in the color-tone correcting layer, the infrared-ray shielding layer and the like located on the side closer to the panel than this layer. A transparent substrate, a sticker layer or the like containing an ultraviolet-ray absorbing agent is used as the ultraviolet-ray shielding layer.

Moreover, Tg of the layer containing the ultraviolet-ray absorbing agent is preferably set to 60° C. or more, more preferably, to 80° C. or more. When the ultraviolet-ray absorbing agent is contained in a thermoplastic resin whose Tg is low, the ultraviolet-ray absorbing agent moves to the adhesive interface or the bonding interface to cause a possibility of impairing the sticking property or the adhesive property. When Tg of the thermoplastic resin containing an ultraviolet-ray absorbing agent is 60° C. or more, the possibility of the ultraviolet-ray absorbing agent moving in the transparent substrate is lowered so that, when another constituent component of the plasma display-use filter, more specifically, for example, a transparent substrate, a color-tone correcting layer or another transparent substrate forming one portion of the antireflection layer, is joined thereto with an interlayer bonding layer interposed therebetween, it is possible to prevent the sticking property from deteriorating.

Preferable examples of the resin having Tg of 60° C. or more that forms the transparent substrate include aromatic polyesters, typically represented by polyethylene terephthalate and polyethylene naphthalate, aliphatic polyamides, typically represented by Nylon 6 and Nylon 66, aromatic polyamides and polycarbonate. Among these, aromatic polyesters are preferably used, and in particular, polyethylene terephthalate, capable of forming a biaxial oriented film that is particularly superior in heat-resistant property and mechanical strength, is desirably used.

As the ultraviolet-ray absorbing agent, preferable examples thereof include salicylic-acid-based compounds, benzophenone-based compounds, benzotriazole-based compounds, cyanoacrylate-based compounds and benzooxazinone-based compounds and cyclic iminoester-based compounds, and from the viewpoints of the ultraviolet-ray shielding property, color tone and the like in a range from 380 nm to 390 nm, benzooxazinone-based compounds are more preferably used. These compounds may be used alone or as a mixture of two kinds or more of these. Moreover, a stabilizer such as HALS (hindered amine-based photostabilizer) and an anti-oxidant is preferably used in combination.

Examples of the benzooxazinone-based compounds serving as desirable materials include: 2-p-nitrophenyl-3,1-benzooxazine-4-one, 2-(p-benzoylphenyl)-3,1-benzooxazine-4-one, 2-(2-naphthyl)-3,1-benzooxazine-4-one, 2-2′-p-phenylenebis(3,1-oxazine-4-one) and 2,2-(2,6-naphthylene)bis(3,1-benzooxazine-4-one). The amount of addition of these compounds is preferably set in a range from 0.5 to 5% by weight to the substrate film.

Moreover, in order to further provide a superior photoresistant property, a cyanoacrylate-based tetramer compound is preferably used in combination. The cyanoacrylate-based tetramer compound is preferably contained in the substrate film at 0.05 to 2% by weight. The cyanoacrylate-based tetramer compound refers to a compound basically composed by a tetramer of cyanoacrylate, and for example, 1,3-bis(2′cyano-3,3-diphenylacryloyloxy)-2,2-bis-(2′cyano-3,3-diphenyl acryloyloxy methylpropane) is proposed. In the case when this is used in combination, the above-mentioned ultraviolet-ray absorbing agent is preferably set in a range from 0.3 to 3% by weight in the substrate film.

The ultraviolet-ray shielding layer is preferably designed to have a transmittance at a wavelength of 380 nm of 5% or less. With this arrangement, it becomes possible to protect the substrate and the dye coloring matter from ultraviolet rays.

The content of the ultraviolet-ray absorbing agent in the ultraviolet-ray shielding layer is preferably set in a range from 0.1 to 5% by weight, more preferably, from 0.2 to 3% by weight. When the content of the ultraviolet-ray absorbing agent is set from 0.1 to 5% by weight, it is possible to obtain superior effects for absorbing ultraviolet rays made incident on the plasma display-use filter from the viewer's side and for preventing photo-degradation in the coloring matter contained in the color-tone correcting layer, without causing degradation in the strength of the transparent substrate or the sticker layer.

Although not particularly limited, examples of the method for adding the ultraviolet-ray absorbing agent to the ultraviolet-ray shielding layer, in particular, to the transparent substrate include a polymerizing process of a thermoplastic resin, a kneading process into the thermoplastic resin in a fusing process prior to the film formation and an impregnating process into the biaxial oriented film. In particular, from the viewpoint of preventing a reduction in the polymerization degree of the thermoplastic resin, the kneading process into the thermoplastic resin in a fusing process prior to the film formation is preferably carried out. In this case, the kneading process of the ultraviolet-ray absorbing agent may be carried out by a directly adding method of the powder of the agent or a master batch method for adding a master polymer containing the agent at a high concentration to the film-forming polymer.

The thickness of the ultraviolet-ray cutting layer is preferably set in a range from 5 to 250 μm, more preferably, from 50 to 200 μm, most preferably, from 80 to 200 μm. When the thickness of the ultraviolet-ray absorbing layer is in the range from 5 to 250 μm, it is possible to obtain superior effects for absorbing ultraviolet rays made incident on the plasma display-use filter from the viewer's side, and also to provide a superior light-transmitting property, more specifically, a visible-light-ray transmitting property.

### (Adhesive Layer)

In the present invention, in order to paste and join the various functional layers or to paste and join the plasma display-use filter to the plasma display, an adhesive layer having an adhesive property may be used. As the sticker agent to be used in this case, not particularly limited, any adhesive, made from a rubber-based, an acryl-based, a silicon-based or polyvinylether-based material, may be used as long as it is an adhesive for bonding two objects to each other through its adhesive function,

Moreover, the sticker agents are mainly classified into two types, that is, a solvent-type sticker agent and a non-solvent-type sticker agent. Although the solvent-type sticker agent, which is superior in drying property, productivity and processability, has been still mainly used, a shift is being made to the non-solvent-type sticker agent in recent years, from the viewpoints of pollution prevention, energy conservation, resource conservation, stability and the like. Among these, an active-ray curable sticker agent, which is a sticker agent that is cured in the order of seconds upon irradiation with an active ray, and has superior characteristics in pliability, adhesive property, chemical resistance and the like, is preferably used.

Specific examples of the active-ray curable acryl-based sticker agent can be found from “Adhesive Data Book” edited by the Adhesion Society of Japan, pages 83 to 88, issued by the Nikkan Kogyo Shinbun, Ltd. in 1990, but is not limited thereto. As commercially available multifunctional acryl-based ultraviolet-ray curable paints, although not particularly limited thereby, the following products are proposed: (trade name: XY (registered trademark) Series and the like) made by Hitachi Kasei Polymer Co., Ltd.; (trade name: Hilock (registered trademark) Series or the like) made by Tohokasei kogyo Co., Ltd.; (trade name: Three Bond (registered trademark) Series and the like) made by ThreeBond Co., Ltd.; (trade name: Alontite (registered trademark) Series and the like) made by Toagosei Co., Ltd.; (trade name: Cemelock Super (registered trademark) Series and the like) made by Cemedine Co., Ltd.

### (Transparent Substrate)

The transparent substrate in the present invention is normally used as a substrate for use in laminating an antireflection layer, a hard coat layer, an infrared-ray cutting layer and a conductive layer thereon. Moreover, by adding an ultraviolet-ray absorbing component thereto, it is allowed to function as an ultraviolet-ray cutting layer.

The transparent substrate in the present invention is prepared as a film capable of being fusion-film-formed or solution-film-formed. Specific examples thereof include: films made from polyester, polyolefin, polyamide, polyphenylene sulfide, cellulose ester, polycarbonate and acrylate. These films are desirably used as the substrate for each of the functional layers of the present invention, and as a material preferably used for a transparent substrate for forming a surface having a waving structure, resins that are superior in transparency, mechanical strength and dimensional stability are required, and specific preferable examples thereof include polyester, cellulose ester and acrylic resins (polyacrylate), and among these, in particular, polyethylene terephthalate, polyethylene-2,6-naphthalate and triacetyl cellulose are exemplified as more preferable materials. Moreover, among polyacrylates, a resin having a cyclic structure in a molecule forms a material that is superior in optical isotropic property. As the resin having the cyclic structure in a molecule, for example, an acrylic resin containing 10 to 50% by weight of a glutaric acid anhydride unit is proposed. However, as a material that has well-balanced performances in all the characteristics, and is applicable to all the functional layers of the present invention, polyester is, in particular, preferably used.

Examples of these polyesters include polyethylene terephthalate, polyethylene naphthalate, polypropylene terephthalate, polybutylene terephthalate and polypropylene naphthalate, and from the viewpoints of performances and costs, polyethylene terephthalate is most preferably used. Moreover, two or more kinds of polyesters may be used as a mixture. Furthermore, polyesters, formed by allowing these to be copolymerized with another dicarboxylic acid component or a diol component, may be used; however, in this case, in the film in which its crystal orientation has been completed, the degree of crystallinity is preferably set to 25% or more, more preferably, to 30% or more, most preferably to 35% or more. The degree of crystallinity of less than 25% tends to cause insufficient dimension stability and mechanical strength. The degree of crystallinity can be measured by using Raman spectrum analyzing method.

In the case when the above-mentioned polyester is used, its ultimate viscosity (measured in o-chlorophenol at 25° C. in accordance with JIS K7367) is preferably set to 0.4 to 1.2 dl/g, more preferably, to 0.5 to 0.8 dl/g.

The transparent substrate to be used in the present invention may be a composite film having a layer structure of two or more layers. As such a composite film, for example, a composite film in which particles are contained in a surface layer portion, without particles being virtually contained in the inner layer portion, and a laminated film in which particles are contained in the inner layer portion, with fine particles being contained in the surface layer portion, may be used. In this case, in the above-mentioned composite films, the inner layer portion and the surface layer portion may be made from the same kind of polymer, or may be made from chemically different kinds of polymers. However, upon application of particles and the like, the degree of addition needs to be set to a level causing no adverse effects to its transparency.

In the case when polyester is used as the transparent substrate of the present invention, from the viewpoints of thermal stability of the film, in particular, of sufficient dimensional stability and mechanical stability, as well as of good flatness, a film that is crystal-oriented by biaxial stretching is preferably used. The state that is crystal-oriented by biaxial stretching refers to a state in which an unstretched thermal plastic film, that is, a thermal plastic film prior to the completion of the crystal-orientation, is preferably stretched by about 2.5 to 5 times in the length direction as well as in the width direction, and the crystal orientation is completed by the succeeding thermal process, and corresponds to a layer having a biaxially oriented pattern found by a wide-angle X-ray diffraction process.

The thickness of the transparent substrate to be used in the present invention, which is selected on demand depending on purposes of use, is preferably set in a range from 10 to 500 μm, more preferably, from 20 to 300 μm from the viewpoints of mechanical strength and handling property.

To the transparent substrate of the present invention, various additives, resin compositions, a cross-linking agent and the like, may be added in a range that does not impair the effects of the present invention, in particular, the optical characteristics thereof, Examples of these include: an antioxidant, a heat-resistant stabilizer, an ultraviolet-ray absorbing agent, organic and inorganic particles (such as silica, colloidal silica, alumina, alumina zol, kaolin, talc, mica, calcium carbonate, barium sulfate, carbon black, zeolite, titanium oxide, metal fine powder and the like), a pigment, a dye, an anti-static agent, a core agent, acrylic resin, polyester resin, urethane resin, polyolefin resin, polycarbonate resin, alkyd resin, epoxy resin, urea resin, phenolic resin, silicon resin, rubber-based resin, wax composition, melamine-based cross-linking agent, oxazoline-based cross-linking agent, methylolated or alkylolated urea-based cross-linking agent, acrylamide, polyamide, epoxy resin, isocyanate compound, aziridine compound, various kinds of silane coupling agents, various kinds titanate-based coupling agents.

The transparent substrate to be used in the present invention is preferably designed to have a transmittance of all light rays of 90% or more and a haze value of 1.5% or less, and by using such a substrate, it becomes possible to improve the visibility and the degree of clearness of an image.

Moreover, the transparent substrate of the present invention is preferably allowed to have a transmission b value of 1.5 or less. When the transmission b value exceeds 1.5, the transparent substrate itself tends to appear yellowish to sometimes impair the clearness of an image.

The b value relates to a method for color specification determined by International Commission on Illumination (CIE), and the b value represents the chromaticness, and the plus sign represents a yellow hue, while the minus sign represents a blue hue. Moreover, as the absolute value becomes greater, the chromaticness of the corresponding color becomes greater to indicate that it has a clearer color, and as the absolute value becomes smaller, the chromaticness thereof becomes smaller. In the case of 0 value, the corresponding color is indicated as an achromatic color. The adjustment of the color specification is carried out, for example, by using coloring matters, and examples of the coloring matters include colored inorganic pigments, organic pigments and dyes; in particular, because of superior weather resistant, the following organic pigments are preferably used: cadmium red, red ion oxide, molybdenum red, chrome vermilion, chromium oxide, Pylidian, titanium cobalt green, cobalt green, cobalt chrome green, Victoria Green, ultramarine blue, Prussian blue, Berlin blue, Miroli blue, cobalt blue, Selulian blue, cobalt silica blue, cobalt zinc blue, Manganese Violet, Mineral Violet and Cobalt Violet.

In the transparent substrate to be used in the present invention, a primer layer (adhesion-improving layer, under coating layer), used for strengthening the adhesion (adhesive strength) to the conductive layer and the aforementioned functional layers, is preferably formed.

### (Transparent Substrate)

A transparent substrate in the present invention is used for applying a mechanical strength to a plasma display panel main body, and an inorganic compound molded product or a transparent organic polymer molded product is used as its material.

As the inorganic compound molded product, preferably, glass, reinforced or semi-reinforced glass, or the like is used, and its thickness is normally set in a range from 0.1 to 10 mm, more preferably, from 1 to 4 mm.

Any polymer molded product may be used as long as it is transparent in the visible wavelength range, and specific examples thereof include: polyethylene terephthalate (PET), polyether sulfone, polystyrene, polyethylene naphthalate, polyallylate, polyetheretherketone, polycarbonate, polypropylene, polyimide and triacetyl cellulose. These transparent polymer products may be formed into a plate (sheet) shape or a film shape, as long as its main face is flat. In the case when a sheet-shaped polymer product is used as the substrate, since the substrate is superior in the dimensional stability and mechanical strength, a transparent laminated body that is superior in the dimensional stability and mechanical strength can be obtained, and, in particular, is applied to such a structure as to require these characteristics.

Moreover, the transparent polymer film has flexibility so that a functional layer can be formed continuously by using a roll-to-roll method; therefore, by using this, it is possible to efficiently produce a laminated body of functional layers with an elongated large area. In this case, the film thickness is normally set in a range from 10 to 250 μm. In the case of the film thickness of less than 10 μm, the mechanical strength as the substrate becomes insufficient, while in the case of the film thickness exceeding 250 μm, since its flexibility becomes insufficient, the resulting film is not suitable to be wound onto a roll and used.

In the present invention, by using glass as the transparent substrate, a sufficient mechanical strength is obtained, and even in the case when glass is not used, advantages, such as elimination of double image reflection and the like, can be obtained because an air gap to the plasma display panel can be eliminated; therefore, the transparent substrate may be used, or may not be used in the present invention.

### (Structure of Filter)

The plasma display-use filter of the present invention is prepared as a laminated body in which a plurality of layers are stacked as described above. The following description will explain its structural examples in detail.
(1) Hard coat layer+conductive layer+transparent substrate+ultraviolet-ray shielding layer+color-tone correcting layer+near infrared-ray shielding layer+adhesive layer+transparent substrate (with the hard coat layer being placed on the viewing side and the transparent substrate being placed on the plasma display panel side), (2) Antireflection layer+hard coat layer+conductive layer+transparent substrate+ultraviolet-ray-shielding layer+color-tone correcting layer+near infrared-ray shielding layer+adhesive layer+transparent substrate (with the antireflection layer being placed on the viewing side and the transparent substrate being placed on the plasma display panel side), (3) Hard coat layer+conductive layer+transparent substrate+ultraviolet-ray shielding layer+near infrared-ray shielding layer+color-tone correcting layer+transparent substrate (with the hard coat layer being placed on the viewing side and the transparent substrate being placed on the plasma display panel side), (4) Antireflection layer+hard coat layer+conductive layer+transparent substrate+ultraviolet-ray-shielding layer+near infrared-ray shielding layer+color-tone correcting layer+transparent substrate (with the antireflection layer being placed on the viewing side and the transparent substrate being placed on the plasma display panel side), (5) Hard coat layer+conductive layer+transparent substrate+ultraviolet-ray shielding layer+color-tone correcting layer+near infrared-ray shielding layer+adhesive layer (with the hard coat layer being placed on the viewing side and the transparent substrate being placed on the plasma display panel side), (6) Antireflection layer+hard coat layer+conductive layer+transparent substrate+ultraviolet-ray-shielding layer+color-tone correcting layer+near infrared-ray shielding layer+adhesive layer (with the antireflection layer being placed on the viewing side and the adhesive layer being placed on the plasma display panel side), (7) Hard coat layer+conductive layer+transparent substrate+ultraviolet-ray shielding layer+near infrared-ray shielding layer+color-tone correcting layer+adhesive layer (with the hard coat layer being placed on the viewing side and the adhesive layer being placed on the plasma display panel side), (8) Antireflection layer+hard coat layer+conductive layer+transparent substrate+ultraviolet-ray-shielding layer+near infrared-ray shielding layer+color-tone correcting layer+adhesive layer (with the antireflection layer being placed on the viewing side and the adhesive layer being placed on the plasma display panel side); however, the plasma display-use filter of the present invention is not intended to be limited thereby.

### (Display-Use Filter Using Light-Shielding Convex Portions of Another Mode)

The plasma display-use filter using a conductive mesh as light-shielding convex portions has been described above, and the following description will discuss a display-use filter using light-shielding convex portions of another mode.

The corresponding light-shielding convex portions can be formed by using a resin component containing a light-shielding substance. As the light-shielding substance, various kinds of dyes and pigments, metal or the like can be used, but are not limited by these. That is, the light-shielding convex portions of the other mode are convex portions containing a light-shielding substance such as a dye, a pigment, metal or the like.

In the present invention, a pigment is preferably used as the light-shielding substance, and a black pigment, or a mixture of a red pigment, a blue pigment and a green pigment may be used.

As the black pigment, Color Index No. Pigment Black 7, carbon black, titanium black, a metal oxide or the like may be used. One kind of these pigments may be used alone, or two or more kinds of these may be used in combination. As the red pigment, Color Index No. Pigment Red (hereinafter, referred to simply as PR), 9, 97, 122, 123, 149, 168, 177, 180, 192, 215, 254 or the like may be used, as the green pigment, Color Index No. Pigment Green (hereinafter, referred to simply as PG), 7 or 36 may be used, and as the blue pigment, Color Index No. Pigment Blue (hereinafter, referred to simply as PB) 15:3, 15:4, 15:6, 21, 22, 60 or 64 may be used.

Among the above-mentioned pigments, the black pigment is preferably used, and titanium black and carbon black are more preferably used.

With respect to the particle size of the pigment serving as a light-shielding substance, from the viewpoint of dispersing property of the pigment, those having an average primary particle size from 5 to 400 nm are preferably used, more preferably, those from 10 to 200 nm are used, and most preferably, those from 10 to 100 nm are used.

The content of the pigment serving as a light-shielding substance is preferably set to 5 to 80% by weight, more preferably, to 10 to 70% by weight, relative to 100% by weight of the total components forming the light-shielding convex portions. When the content of the pigment is too small, it sometimes becomes difficult to provide a sufficient light-shielding property; in contrast, when the content of the pigment is too much, the strength (hardness) of the light-shielding convex portions tends to be lowered and the molding processability tends to deteriorate.

As the resin component forming the light-shielding convex portions, curable resins, such as thermosetting and photosetting resins, are proposed, but are not limited thereto. As the resin for forming the light-shielding convex portions, photo-curable resins that are cured by active light rays, such as ultraviolet rays and an electron beam, are preferably used, and in particular, ultraviolet-ray curable resins are more preferably used.

Examples of the ultraviolet-ray curable resin, examples thereof include acryl-based resins, such as acrylic urethane-based resin, epoxy acrylate-based resin, polyester acrylate-based resin and polyol acrylate-based resin, or epoxy-based resins.

The following description will discuss the acryl-based resins in detail as examples of the photo-curable resin components. The acryl-based resin may have a structure in which, in order to apply a photosensitive property thereto, at least, an acryl-based polymer, an acryl-based polyfunctional monomer or oligomer, and a photopolymerization initiator are contained may be used. Moreover, a so-called acrylepoxy resin with epoxy further added thereto may also be used.

Although not particularly limited, as the usable acryl-based polymer, a copolymer of an unsaturated carboxylic acid and an unsaturated ethylenic compound may be preferably used. Examples of the unsaturated carboxylic acid include: acrylic acid, methacrylic acid, itaconic acid, crotonic acid, maleic acid, fumaric acid and vinyl acetate, or acid anhydride.

Specific examples of the copolymerizable ethylenic unsaturated compounds include, but are not limited to: unsaturated carboxylic acid alkyl esters, such as methyl acrylate, methyl methacrylate, ethyl acrylate, ethyl methacrylate, n-propyl acrylate, isopropyl acrylate, n-propyl methacrylate, isopropyl methacrylate, n-butyl acrylate, n-butyl methacrylate, sec-butyl acrylate, sec-butyl methacrylate, isobutyl acrylate, isobutyl methacrylate, tert-butyl acrylate, tert-butyl methacrylate, n-pentyl acrylate, n-pentyl methacrylate, 2-hydroxyethyl acrylate, 2-hydroxyethyl methacrylate, benzyl acrylate, benzyl methacrylate; aromatic vinyl compounds, such as styrene, p-methyl styrene, o-methyl styrene, m-methyl styrene and α-methyl styrene; unsaturated carboxylic acid aminoalkyl esters, such as aminoethyl acrylate; unsaturated carboxylic acid glycidyl esters, such as glycidyl acrylate and glycidyl methacrylate; carboxylic vinyl esters, such as vinyl acetate and vinyl propionate; cyanated vinyl compounds, such as acrylonitrile, methacrylonitrile and α-chloroacrylonitrile; aliphatic conjugated dienes, such as 1,3-butadiene and isoprene; and macromonomers of polystyrene, polymethyl acrylate, polymethyl methacrylate, polybutyl acrylate, polybutyl methacrylate and polysilicone, with an acryloyl group or a methacryloyl group being attached to each of terminals.

Moreover, the acryl-based polymer having an ethylenic unsaturated group added to its side chain can be preferably used because the sensitivity is improved upon processing. Examples of the ethylenic unsaturated group include: a vinyl group, an allyl group, an acryl group and a methacryl group. With respect to the method for adding such a side chain to an acryl-based (co)polymer, in the case when the acryl-based (co)polymer has a carboxyl group, a hydroxyl group or the like, a method is generally used in which an ethylenic unsaturated compound and an acrylic acid or methacrylic acid chloride, having a glycidyl group, is addition-reacted therewith. In addition, a compound having an ethylenic unsaturated group may be added thereto by utilizing isocyanate. In this case, as the ethylenic unsaturated compound and the acrylic acid or methacrylic acid chloride having a glycidyl group, for example, glycidyl acrylate, glycidyl methacrylate, glycidyl α-ethylacrylate, crotonyl glycidyl ether, glycidyl crotonate ether, glycidyl isocrotonate ether, acrylic acid chloride and methacrylic acid chloride may be used.

As the polyfunctional monomer, examples thereof include: oligomers, such as bisphenol A diglycidyl ether(meth)acrylate, poly(meth)acrylate carbamate, modified bisphenol A epoxy(meth)acrylate, adipic acid 1,6-hexanediol(meth)acrylic acid ester, phthalic anhydride propylene oxide(meth)acrylic acid ester, trimellitic acid diethylene glycol(meth)acrylic acid ester, trimellitic acid diethyleneglycol(meth)acrylic acid ester, rosin-modified epoxy di(meth)acrylate and alkyd-modified(meth)acrylate; or tripropylene glycol di(meth)acrylate, 1,6-hexanediol di(meth)acrylate, bisphenol A diglycidyl ether di(meth)acrylate, trimethylol propane tri(meth)acrylate, pentaerythritol tri(meth)acrylate, triacryl formal, pentaerythritol tetra(meth)acrylate, dipentaerythritol hexa(meth)acrylate and dipentaerythritol penta(meth)acrylate. These may be used alone, or as a mixture of two or more thereof. Moreover, the following mono functional monomers may be used in combination: for example, ethyl(meth)acrylate, 2-ethylhexyl(meth)acrylate, hydroxyethyl(meth)acrylate, n-butyl methacrylate, glycidyl methacrylate, lauryl(meth)acrylate, stearyl(meth)acrylate and isbornyl(meth)acrylate, and a mixture of two or more kinds of these, or a mixture with another compound or the like may be used. By selecting and combining these polyfunctional and monofunctional monomers and oligomers with one another, the sensitivity of resist and the characteristic of processability can be controlled. In particular, in order to increase the hardness, methacrylate compounds are more preferable than acrylate compounds, and in order to increase the sensitivity, those compounds having three or more functional groups are more preferably used. Moreover, melamines and guanamines may be desirably used in place of the acryl-based monomer.

As the photopolymerization initiator, not particularly limited, those conventionally known initiators may be used, and examples thereof include: dimers, such as benzophenone, N,N′-tetraethyl-4,4′-diaminobenzophenone, 4-methoxy-4′-dimethylaminobenzophenone, 2,2-diethoxyacetophenone, benzoin, benzoin methylether, benzoin isobutylether, benzil dimethylketal, α-hydroxy isobutylphenone, thioxanthone, 2-chlorothioxanthone, 1-hydroxycyclohexylphenyl ketone, 2-methyl-1-[4-(methylthio)phenyl]-2-morpholino-1-propane, t-butyl anthraquinone, 1-chloroanthraquinone, 2,3-dichloroanthraquinone, 3-chloro-2-methylanthraquinone, 2-ethyl anthraquinone, 1,4-naphthoquinone, 9,10-phenanthraquinone, 1,2-benzoanthraquinone, 1,4-dimethylanthraquinone, 2-phenyl anthraquinone and 2-(o-chlorophenyl)-4,5-diphenyl imidazole. Moreover, other inorganic photopolymerization initiators, such as acetophenone-based compounds, imidazole-based compounds, hexaaryl biimidazole-based compounds, benzophenone-based compounds, thioxanthone-based compounds, phosphorous-based compounds, triazine-based compounds, halogenated hydrocarbon derivatives, organic boric acid salt compounds or titanate, may also be preferably used. Furthermore, when a sensitizer assistant, such as p-dimethylamino benzoate, is added thereto, the sensitivity is further improved desirably. Two or more of these photopolymerization initiators may be used in combination.

The content of the photopolymerization initiator is properly set in a range from 1 to 25% by weight relative to 100% by weight of the total components of the light-shielding convex portions.

A thermosetting resin may be used as the resin component for forming the light-shielding convex portions of the present invention. Examples of the thermosetting resin include: unsaturated polyester resin, epoxy resin, vinylester resin, phenol resin, thermosetting polyimide resin, and thermosetting polyamideimide resin.

Examples of the unsaturated polyester resin include low-styrene volatile resins which are formed into a low molecular state by introducing an orthophthalic acid-based resin, an isophthalic acid-based resin, a terephthalic acid-based resin, a bisphenol-based resin, a propylene glycol-maleic acid-based resin, dicyclopentadiene or its derivative into an unsaturated polyester composition, or to which a coated-film-forming wax compound is added; low-shrinkage resins to which a thermoplastic resin (polyvinyl acetate resin, a styrene-butadiene copolymer, polystyrene, saturated polyester, and the like) is added; reactive resins, formed by bromating an unsaturated polyester by using Br₂ directly, or by copolymerizing a het acid, dibrome neopentyl glycol or the like; addition-type nonflammable resins in which a combination of a halogenide, such as chlorinated paraffin, tetrabrome bisphenol or the like, and antimony trioxide or a phosphorous compound, or aluminum hydroxide, is used as an additive; and highly toughness resins (with high strength, high elastic modulus and high extension rate) which are hybridized or IPN-formed in combination with polyurethane and silicone.

Examples of the epoxy resin include: glycidyl ether-based resins including a bisphenol-A type, phenol novolac-type, bisphenol-F type or brominated bisphenol-A type resin; and special epoxy resins including a glycidyl amine-based, glycidyl ester-based, cyclic aliphatic-based, or heterocyclic epoxy-based resin, and the like.

Examples of the vinyl ester resin include a compound obtained by dissolving an oligomer, prepared by subjecting a normal epoxy resin to a ring-opening addition reaction with an unsaturated mono-basic acid, such as methacrylic acid, in a monomer such as styrene. Moreover, this also includes a special-type compound that has a vinyl group in its molecule terminal and side chain and contains a vinyl monomer. As the vinyl ester resin of a glycidyl ether-based epoxy resin, for example, bisphenol-based, novolac-based and brominated bisphenol-based resins are proposed, and as the special-type vinyl ester resin, vinylester urethane-based, vinyl isocyanurate-based and side-chain vinylester-based resins are proposed.

The phenol resins are obtained by polycondensing phenols and formaldehydes as materials, and classified as a resole type and a novolac type.

As the thermosetting polyimide resin, examples thereof include maleic acid-based polyimide, such as polymaleimide amine, polyamino bismaleimide, bismaleimide-O,O′-diallylbisphenol-A resin and bismaleimide-triazine resin, or nadic-acid-modified polyimide, and acetylene-terminal polyimide.

The content of the resin component forming the light-shielding convex portions is preferably set in a range from 20 to 90% by weight, more preferably, from 30 to 80% by weight, relative to 100% by weight of all the the components of the light-shielding convex portions. When the content of the resin component is too small, the curing property of the light-shielding convex portions tends to be lowered, and when the content of the resin component is too large, the light-shielding property of the light-shielding convex portions tends to be lowered.

As the forming method of the light-shielding convex portions, a method is proposed in which the above-mentioned composition containing a light-shielding substance and the resin component is dispersed in an appropriate organic solvent, and dissolved or diluted therein so that a liquid-state composition for the light-shielding convex portions is prepared, and this liquid-state composition is printed into a desired pattern of the light-shielding convex portions by using an ink-jet system or a printing system so as to be cured, or another method is proposed in which the processing and forming processes are carried out by using a photolithography system. However, the present invention is not intended to be limited the above-mentioned forming methods.

As the above-mentioned printing system, for example, screen printing, gravure printing, flexographic printing, offset printing and the like are proposed.

The above-mentioned photolithography system is a method in which the liquid-state composition for the light-shielding convex portions is applied onto virtually the entire surface of a transparent substrate, by using an appropriate coating method, such as a reverse coating method, a gravure coating method, a rod coating method, a bar coating method, a die coating method and a spray coating method, and after the coated face have been exposed with active light rays, such as ultraviolet rays, into a dot-shaped or a mesh-shaped pattern, the resulting coated face is developed so that the resin portions corresponding to non-convex areas is dissolved and removed. As the exposing method, a method for exposing with a photomask interposed in between and a method in which scanning and exposing processes are directly carried out by using a laser are proposed.

The plane shape (shape viewed from above) of the light-shielding convex portions, formed by the resin component containing the light-shielding substance, is preferably prepared as a mesh shape or a pattern with a plurality of dots.

The following description will discuss the mesh-shaped concave portions in detail.

With respect to the mesh pattern shape (shape of the non-convex areas, that is, shape of the light transmitting areas) that form the mesh-shaped convex portions, examples thereof include a lattice shaped mesh pattern composed of a quadrilateral shape, such as a square, a rectangular shape and a diamond shape; a polygonal-shaped mesh pattern, such as a triangular shape, a pentagonal shape, a hexagonal shape, an octagonal shape and a dodecagonal shape; a mesh pattern composed of a round shape or an elliptical shape, a composite-shaped pattern of the above-mentioned shapes, and a random mesh pattern.

From the viewpoint of allowing the transparent resin layer to form a surface shape having a center-line average roughness Ra in a range from 50 to 500 nm, the height of the mesh-shaped concave portions is preferably set in a range from 0.5 to 8 μm, more preferably, from 1 to 5 μm. The width of a thin line to form the mesh-shaped concave portions is preferably set in a range from 3 to 30 μm, more preferably, from 5 to 20 μm. In the case of the mesh-shaped convex portions, from the viewpoint of ensuring a superior coating property of the transparent resin layer, the height of the light-shielding convex portions is preferably set to 8 μm or less.

The pitch of the mesh-shaped convex portions made of the mesh pattern is preferably set in a range from 50 to 500 μm, more preferably, from 75 to 450 μm, most preferably, from 100 to 350 μm.

The above-mentioned pitch refers to a distance between center-of-gravities of one light-transmitting area of the mesh pattern and an adjacent light-transmitting area having at least one side shared with this light-transmitting area.

Although the mesh pattern normally represents a state in which all the thin lines are connected to one another, the mesh-shaped convex portions of the present invention may have thin lines of the mesh pattern that are partially cut into pieces.

The following description will discuss the dot-shaped convex portions in detail.

With respect to the convex structure of the dot-shaped convex portions, the major diameter of the dot is preferably set in a range from 2 to 30 μm, more preferably, from 3 to 20 μm, most preferably, from 4 to 15 μm. Moreover, a plurality of dot-shaped convex portions are preferably designed to have virtually a constant major diameter.

From the viewpoint of forming a surface shape having a center-line-average roughness Ra in a range from 50 to 500 nm on the transparent resin layer, the height of the dot-shaped convex portions is preferably set in a range from 0.5 to 8 μm, more preferably, from 1 to 5 μm. Moreover, a plurality of dot-shaped convex portions are preferably designed to have virtually a constant height.

The plane shape of the dot-shaped convex portions is formed into a round shape, an elliptical shape, a polygonal-shape, a triangular shape, a square shape, a polygonal shape, such as a pentagonal shape, or an undefined shape. In the case of a round-shaped dot, the major diameter of the dot-shaped convex portions is indicated by its diameter, and in the case of an elliptical shape, a polygonal shape and an undefined shape, it is indicated by a diameter of a converted round shape having the same area.

The distance between the dot-shaped convex portions is preferably set in a range from 20 to 300 μm, more preferably, from 30 to 200 μm, most preferably, from 40 to 150 μm.

The distance between the dot-shaped convex portions refers to the average distance between the top portions of the dot-shaped convex portions. Each of the distances is preferably set to virtually a constant value.

The number of the dot-shaped convex portions per unit area is preferably set in a range from 4 to 1000 pieces per 1 mm².

The layout of the dot-shaped convex portions may be a regular layout, or a random layout. In the case of the random layout, an FM screening method may be used.

The FM screening method is sometimes referred to also as a random-screening method or a stochastic-screening method, and represents a method for modulating the dot-to-dot intervals, that is, the periodicity thereof. More specifically, the following methods have been known: crystal-luster-screening method (Agfa Gebalt Corp.), diamond-screen method (Linotype-Hell AG), class-screening method and full-tone-screening method (Cytex Industries), velvet-screening method (Ugra-Kohan Co., Ltd.), acutone-screening method (R.R. Donnelly & Sons), Megadot-screening method (American Color Co., Ltd.), clear-screening method (Sea Color Co., Ltd.*), and Monet-screening method (Barco, Inc.). Although any of these methods have different algorithms used for generating dots, they demonstrate variable densities by a change in dot density, and correspond to various modes of the FM screening method.

In the FM screening method, the size of the dot on which the ink is placed is made constant, and the frequency of generation of the dots is changed depending on the density of an image. Since the size of each dot in the FM screening method is smaller in comparison with so-called net-points, it becomes possible to reproduce a required pattern with a high resolution. Different from the so-called net-points, the dots in the FM screening have a non-periodic dot arrangement. Since the dot arrangement is non-periodic in the FM screening, the resulting feature is that no moire interference is caused.

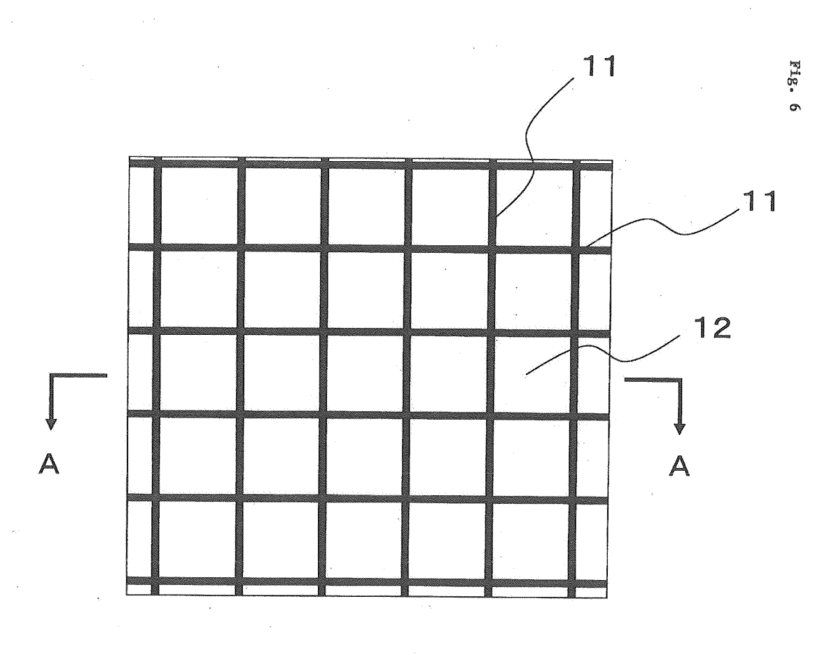

FIGS. 6 to 9 show examples of plane shapes of the light-shielding convex portions relating to the present invention. FIG. 6 is a schematic plan view that shows one example of the mesh-shaped convex portions. Mesh-shaped convex portions 11 having a square-shaped lattice pattern are formed on a transparent substrate 13. The mesh-shaped convex portions 11 are formed by thin lines. Each non-convex area (light-transmitting area) 12 surrounded by the mesh-shaped convex portions 11 made of the thin lines has a square shape. As described earlier, the shape of the non-convex area 12 may have another shape, such as a polygonal shape and a round shape.

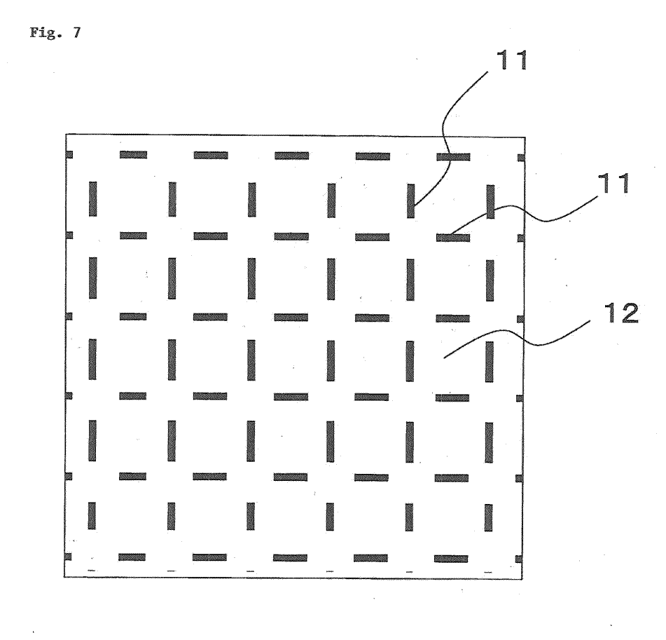

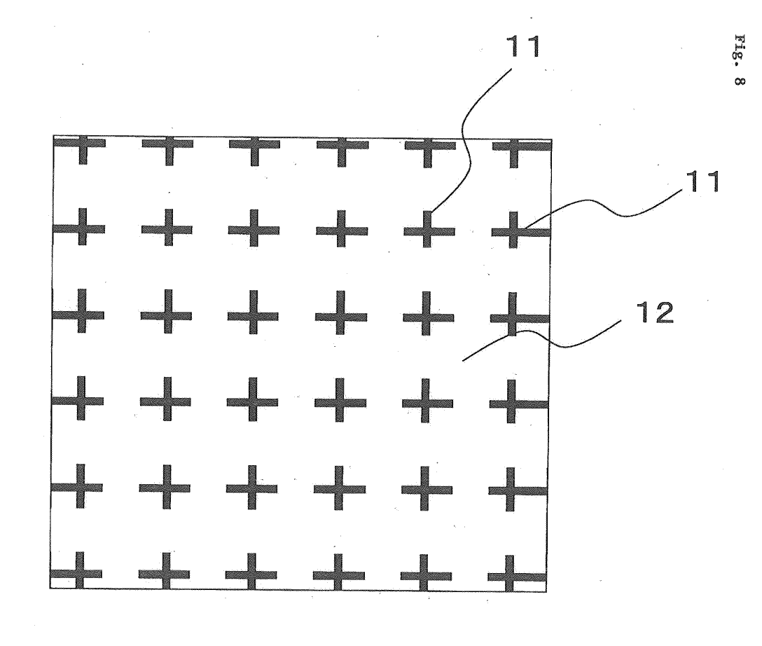

Each of FIGS. 7 and 8 is a schematic plan view showing one example of a shape in which the lattice-state mesh pattern of FIG. 6 is partially cut off. FIG. 7 shows a shape in which the intersection points of the mesh are cut off, and FIG. 8 shows a shape in which thin lines located on other than the intersection points of the mesh are cut off.

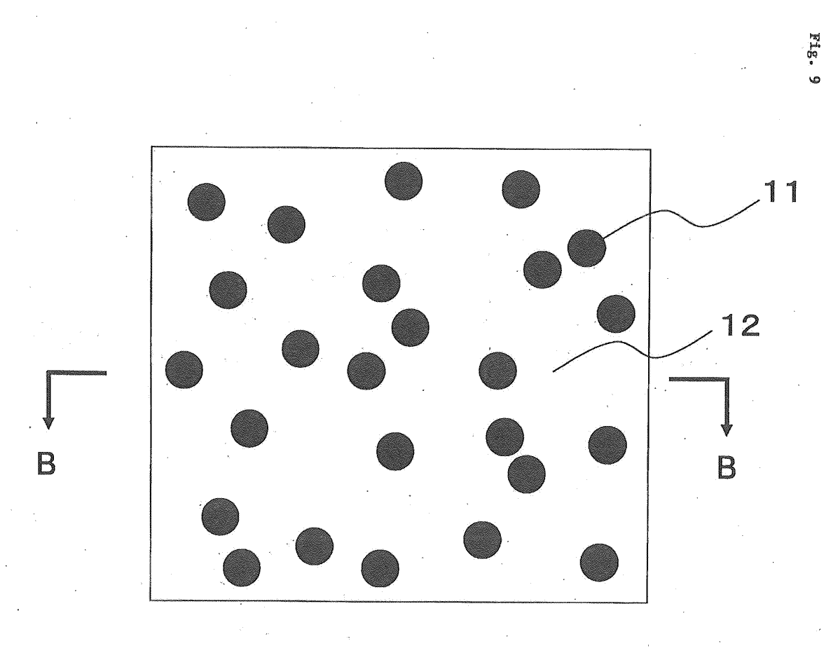

FIG. 9 is a schematic plan view that shows one example of the dot-shaped convex portions. A plurality of dot-shaped convex portions 11 are formed on the transparent substrate 13. Although these dots have a round shape, the plane shape of the dot may have an elliptical shape, a polygonal shape or an undefined shape, as described earlier.

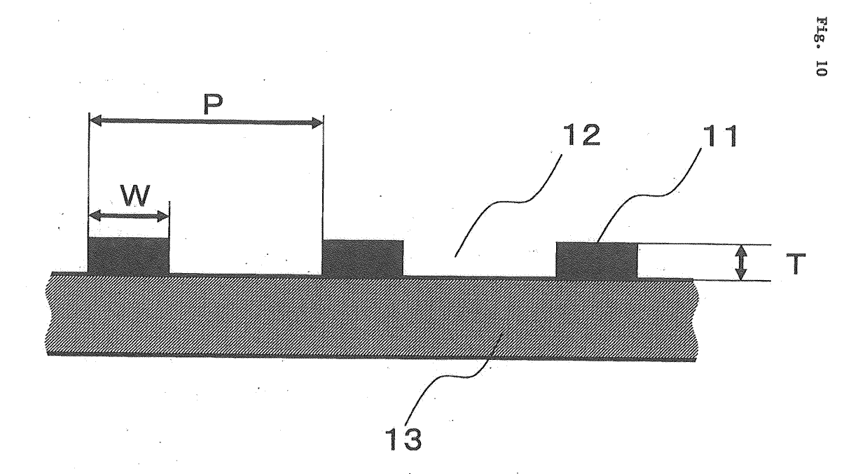

FIG. 10 is a schematic A-A line cross-sectional view of FIG. 6. Sign (W) represents a line width of thin lines that form the mesh-shaped convex portions 11, and sign (P) represents a pitch. In the case when the mesh-shaped convex portions have a square lattice-state mesh pattern, the distance between one mesh-shaped convex portion 11 made of thin lines and another mesh-shaped convex portion adjacent thereto corresponds to the pitch. Sign (T) represents the height of the convex portions.

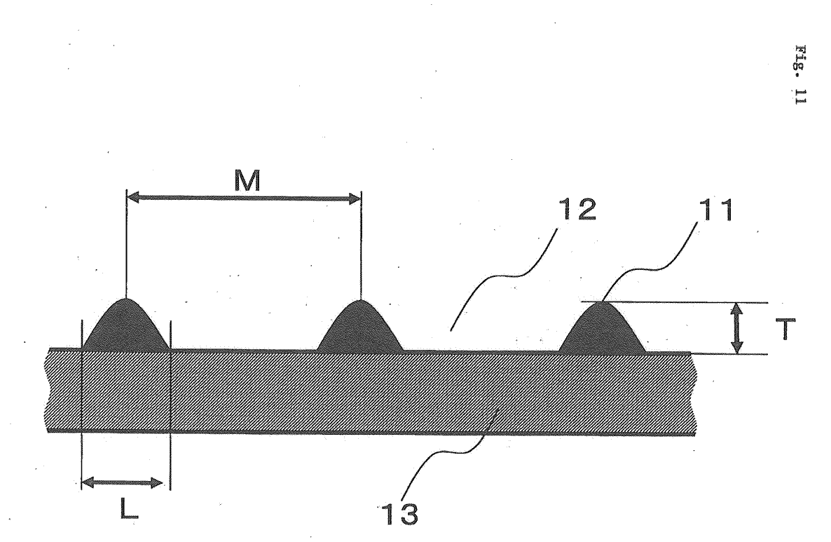

FIG. 11 is a schematic B-B line cross-sectional view of FIG. 9. Sign (L) represents a major diameter of the dot-shaped convex portions 11, sign (M) represents an interval between the dot-shaped concave portions, and sign (T) represents the height of the convex portions. Although FIG. 11 shows dots, each having a peak shape in its cross section, the cross-sectional shape may be a cylindrical shape.

In the present invention, from the viewpoint of maintaining a certain degree of high transmittance, the ratio of the non-convex areas (light-transmitting area) between the light-shielding convex portions relative to the total area is preferably set to 60% or more, more preferably to 70% or more, most preferably, to 80% or more. The upper limit is preferably set to 95% or less, more preferably, to 93% or less.

The ratio of the non-convex areas can be found, for example, by the following processes: A plane image of the surface on which the light-shielding convex portions are formed is photographed through a microscope, and the plane image is divided into two gradations based upon luminance distribution so that by dividing the area of the non-convex areas (light transmitting area) by the total area, the ratio can be obtained.

The light-shielding convex portions have a function for shielding light emission from the display, and the light-shielding process, mentioned here, is most preferably achieved by virtually completely shielding light emission from the display; however, the effects of the light-shielding convex portions can be achieved when 80% or more of light emission can be shielded. More preferably, 90% or more of light emission is shielded, and most preferably, 95% or more of light emission is shielded.

With respect to the wavelength of light to be shielded, it is preferable to shield all the ranges of visible light rays; however, the effects of the light-shielding convex portions can be achieved, when at least light rays in the wavelength range from 500 to 600 nm in which the human visual sensitivity is highly exerted can be shielded with the above-mentioned light-shielding ratio.

### (Another Forming Method for Light-Shielding Mesh-Shaped Convex Portions)

The following description will discuss another method for forming light-shielding convex portions. As the filter for use in a display that generates strong electromagnetic waves, such as a plasma display, a conductive mesh for shielding electromagnetic waves is normally used. As described earlier, the conductive mesh itself serves as the light-shielding convex portions, and the following description will discuss a method for further forming light-shielding mesh-shaped convex portions by utilizing the conductive mesh, in detail.

More specifically, this method relates to a method in which, after forming a conductive mesh serving as the light-shielding convex portions on one of the surfaces of a transparent substrate, mesh-shaped convex portions, which are superposed on the conductive mesh when projected in a direction perpendicular to the surface direction, are further formed on the other face. The plasma display-use filter, obtained by this method, is provided with the conductive mesh serving as the light-shielding convex portions on one of the surfaces of the transparent substrate, with the mesh-shaped convex portions that are superposed on the conductive mesh in its projected manner being formed on the other face of the transparent substrate.

The above-mentioned mesh-shaped convex portions can be formed, for example, by exposing and developing a layer including a photosensitive resin. A photosensitive resin layer is formed on the surface opposing to the conductive mesh of the transparent substrate, and by exposing and developing the photosensitive layer from the conductive mesh side by using the conductive mesh as a mask, the mesh-shaped convex portions can be formed in a projected manner relative to the conductive mesh.

The photosensitive resin for forming the mesh-shaped convex portions in the above-mentioned method is a positive-working type. That is, upon exposing the photosensitive resin layer formed on the opposing face of the transparent substrate by using the conductive mesh preliminarily formed on one of the faces of the transparent substrate as a mask, the thin line portions of the conductive mesh shield light and prevent the light from transmitting therethrough so that the photosensitive resin layer on the corresponding portion is unexposed, while the opening portions of the conductive mesh allow the light to transmit therethrough so that the photosensitive resin layer on the corresponding portion is exposed. In order to obtain a mesh pattern that is superposed on the conductive mesh in the projected manner, it is necessary to form a mesh pattern on the unexposed portions of the photosensitive layer so that the positive-working type photosensitive resin is used. The positive-working photosensitive resin allows its light exposed portions to be dissolved and removed by developing, and also allows its unexposed portions to remain. Ultraviolet rays are preferably used as the exposing process.

The positive-working photosensitive resin has been used in the field of color filters, black matrixes, printed circuit boards and flat printing plates, and conventionally known photosensitive resins can be used also in the present invention. Conventionally known developing liquids and developing methods may also be used.

As the positive-working photosensitive resin, examples thereof include: quinonediazides, such as naphthoquinone diazide and benzoquinone diazide; diazo compounds, such as diazomethyl drum acid, diazodimedone and 3-diazo-2,4-dione; a mixture and condensed product between a photodecomposition agent (dissolution suppressing agent), such as o-nitrobenzyl ester, onium salt and a mixture of onium salt and polyphthalic aldehyde or t-butyl cholinate, and a monomer, such as hydroquinone, fluoroglucine, 2,3,4-trihydroxybenzophenone, that has an OH group and is soluble to alkali, and a polymer, such as a novolac resin like phenol novolac resin and cresol novolac resin, a copolymer between styrene and a maleic acid or maleimide, a copolymer between a phenol-based compound and methacrylic acid, styrene, or acrylonitrile; or polymethyl methacrylate, methyl polymethacrylate, hexafluorobutyl polymetacrylate, dimethyltetrafluoropropyl polymethacrylate, trichloroethyl polymethacrylate, a copolymer of methyl methacrylate-acrylonitrile, polymethyl isopropenyl ketone, polyα-cyanoacrylate and polytrifluoroethyl-α-chloroacrylate. Among these, from the viewpoint of general-purpose properties, a mixed or condensed product of novolac resin is preferably used. More preferably, a mixed or condensed product of novolac resin and quinonediazide is used.

As described earlier, the photosensitive resin layer contains a light-shielding substance. The kind, content and the like of the light-shielding substance have been described earlier.

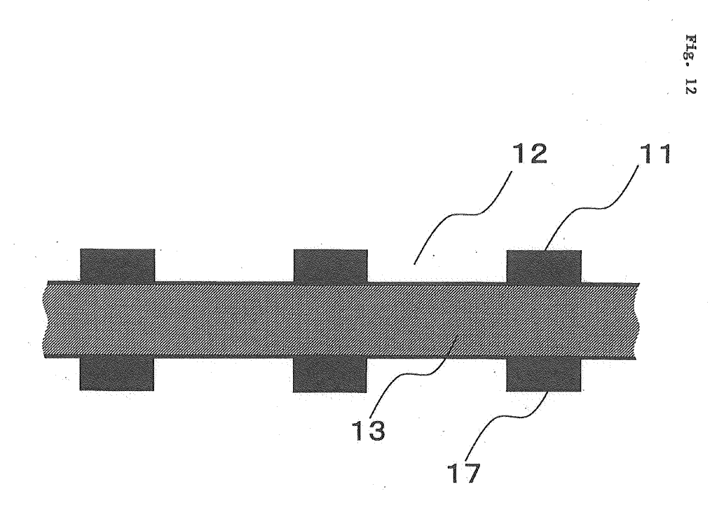

FIG. 12 shows the relationship between the mesh-shaped convex portions and the conductive mesh, formed as described above. In FIG. 12, the mesh-shaped convex portions 11, which are superposed on the conductive mesh 17 in a projected manner, are formed.

The above-mentioned mode is desirably applied to a filter for a display, such as a plasma display, that requires an electromagnetic-wave shielding function. By forming the mesh-shaped convex portions that are superposed on the conductive mesh serving as light-shielding convex portions in a projected manner, the transmittance of the display-use filter having the conductive mesh and the light-shielding mesh-shaped convex portions can be prevented from being lowered. Moreover, by forming the conductive mesh and the light-shielding mesh-shaped convex portions with the transparent substrate being sandwiched therebetween, the shielding effect of external light can be improved so that it becomes possible to suppress the contrast of an image from being lowered due to external light. Furthermore, since the above-mentioned mode makes it possible to provide a display-use filter by using only one sheet of a transparent substrate, it becomes possible to achieve low costs.

As the conductive mesh relating to the above-mentioned mode, the conductive mesh that has been explained earlier can be used.

In the mode in which the mesh-shaped convex portions, which are superposed on the conductive mesh serving as light-shielding convex portions, when projected in a direction perpendicular to the surface direction, are formed, even when the mesh-shaped convex portions have no light-shielding property, it becomes possible to obtain the target effects of the present invention.

That is, upon attaching the display-use filter to a display, by placing the conductive mesh on the display side relative to the mesh-shaped convex portions, the conductive mesh serving as the light-shielding convex portions and the mesh-shaped convex portions are superposed in a vertical direction relative to light emitted from the display so that the light-shielding property of the conductive mesh can be utilized. By utilizing the light-shielding property of the conductive mesh, it becomes possible to obtain the same effects as those of the mesh-shaped convex portions having a light-shielding property, even when the mesh-shaped convex portions have no light-shielding property.

Moreover, the resin layer is stacked in a manner so as to cover the light-shielding convex portions and the non-convex areas formed on the transparent substrate as described earlier. In this case, it is important for the stacked resin layer to have a center-line average roughness Ra set in a range from 50 to 500 nm.

In the present invention, the center-line average roughness Ra of the resin layer of the present invention is preferably set in a range from 75 to 400 nm, more preferably, from 100 to 300 nm, most preferably, from 150 to 250 nm. In the case when the center-line average roughness Ra of the resin layer is less than 50 nm, it is not possible to obtain the effect of preventing reflected images. That is, in the case when the center-line average roughness Ra of the resin layer is less than 50 nm, the outline of a reflected image becomes conspicuous so that the reflected image is easily viewed. In contrast, in the case when the center-line average roughness Ra of the resin layer exceeds 500 nm, the clearness of the transmitted image deteriorates.

Moreover, in the resin layer, concave sections are formed at positions corresponding to the non-convex areas, and the depth (D) of the concave sections is preferably set in a range from 0.5 to 5 μm, more preferably, from 0.5 to 4 μm, most preferably, from 1 to 3 μm. Thus, the effect of preventing reflected images can be exerted.

The depth (D) of the concave section of the resin layer corresponds to a vertical distance from the peak of the resin layer formed on the light-shielding convex portion to the bottom of the resin layer formed in the non-convex area.

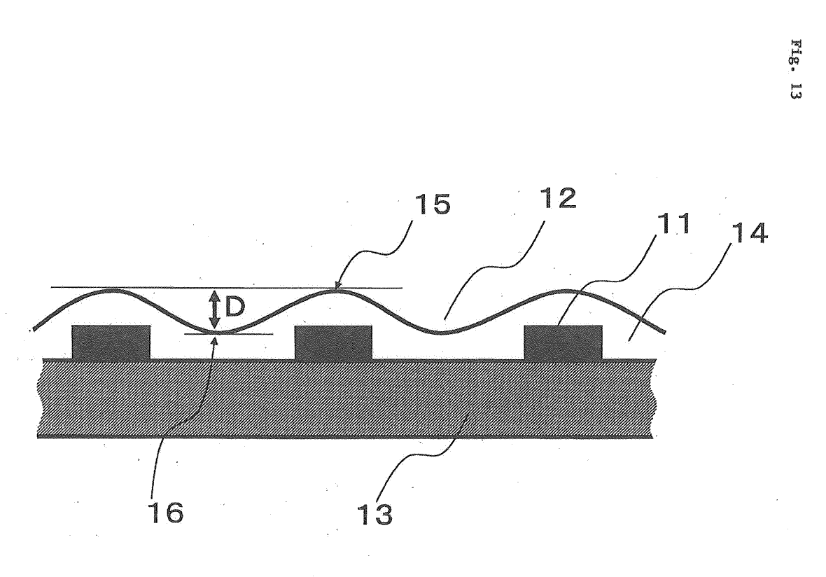

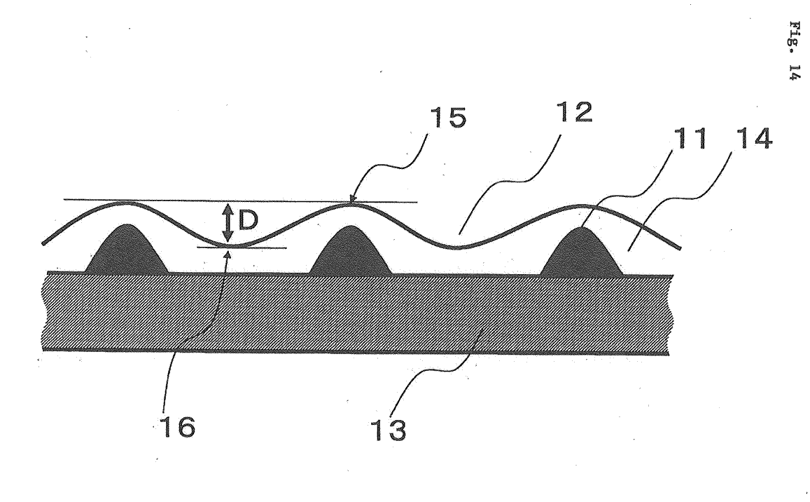

FIG. 13 is a schematic cross-sectional view that shows one example of a mode in which the resin layer is stacked on the mesh-shaped convex portions, and FIG. 14 is a schematic cross-sectional view that shows one example of a mode in which the resin layer is stacked on the dot-shaped convex portions. Reference numeral 14 represents the resin layer. In this case, the depth (D) of the resin layer corresponds to a vertical distance from a peak 15 and a bottom 16.

In the present invention, the controlling process by which the center-line average roughness Ra of the resin layer is set in a range from 50 to 500 nm as described earlier, or the forming process by which the concave sections corresponding the non-convex areas are formed in the resin layer can be achieved by adjusting the height of the light-shielding convex portions, the interval (pitch) of the light-shielding convex portions, the coated amount of the resin layer and the viscosity of the coating solution of the resin layer.

In the plasma display-use filter using the light-shielding convex portions of another mode as described earlier, the lamination method for the resin layer, the structure of the resin layer, the composition of the resin layer, the coated amount of the resin layer, the concave/convex structure of the resin layer, and the like, can be applied in the same modes as those explained in the above-mentioned plasma display-use filter in which the conductive mesh is used as the light-shielding convex portions.

Moreover, with respect to the transparent substrate, and other functional layers (layer having at least one function selected from the group consisting of a near infrared-ray shielding function, a color-tone correcting function, an ultraviolet-ray shielding function and a Ne-cutting function) to be used for the plasma display-use filter using the light-shielding convex portions of another mode as described earlier, the same modes as those explained in the above-mentioned plasma display-use filter in which the conductive mesh is used as the light-shielding convex portions, can also be applied.

### Examples

The following description will discuss examples of the present invention in more detail; however, the present invention is not intended to be limited thereby.

### (Evaluation Method)

### (1) Measurements of Center-Line Average Roughness Ra of Resin Layer

The center-line average roughness Ra on the resin layer side of a display-use filter sample was measured by using a surface roughness measuring device SE-3400 (made by Kosaka Laboratory LTD).

In each of examples and comparative examples, arbitrary five points or more on one sheet of filter having a size of 20 cm×20 cm were measured, and the average value was found and used as the value of Ra on the resin layer of the display-use filter sample.

Upon measurements, a sample member in which a glass plate having a thickness of 2.5 mm was pasted to the sticker layer side of the display-use filter sample was used.

In the case of the conductive mesh and the mesh-shaped light-shielding convex portions, upon carrying out the measurements, the moving direction of the measuring needle was set in parallel with the thin lines of the conductive mesh and the mesh-shaped convex portions, so as to pass through the conductive mesh and virtually the center of the non-convex area (opening portion) of the mesh-shaped light-shielding concave portions, and five measured values in which the pitch of a wave shape, obtained by the measurements, corresponded to virtually the same value as the pitch of the conductive meshes or the mesh-shaped light-shielding convex portions were adopted, and averaged.

In the case when the light-shielding convex portions are the dot-shaped convex portions, five points at arbitrary positions were measured and averaged.
Measuring conditions:
   Feeding speed; 0.5 mm/S
   Cut-off value λc;
      In the case of Ra of 20 nm or less; λc=0.08 mm
      In the case of Ra greater than 20 nm and 100 nm or less;
         λc=0.25 mm
      In the case of Ra greater than 100 nm and 2000 nm or less;
         λc=0.8 mm
   Evaluation length; 8 mm.

In the case when measurements were carried out under the above-mentioned conditions, first, the measurements were conducted based upon the cut-off value λc=0.8 mm, and when the value Ra was greater than 100 nm, the corresponding Ra was adopted. In contrast, as the result of the measurements, when the value Ra was 100 nm or less, re-measuring processes were carried out based upon the cut-off value λc=0.25 mm, and, as a result, when the value Ra was greater than 20 nm, the corresponding Ra value was adopted. In contrast, as the result of the re-measurements, when the value Ra was 20 nm or less, measurements were carried out based upon the cut-off value λc=0.08 mm so that the corresponding Ra value was adopted.
Ra: parameter defined as Ra by the surface roughness measuring device SE-3400 (made by Kosaka Laboratory LTD), which was measured based upon the method of JIS B0601-1982.

### (2) Measurements of Depth (D) of Concave Sections of Resin Layer

The depth (D) of the resin layer was measured by using a laser microscope VK-9700 (made by Keyence Corporation).

In each of examples and comparative examples, arbitrary ten points on one sheet of filter having a size of 20 cm×20 cm were measured, and the average value was found and used as the value of depth D of the concave section of the display-use filter sample. In this case, upon measuring, a sample formed by pasting the sticker layer side of the display-use filter sample to a glass plate having a thickness of 2.5 mm was used.

In the measuring method, first, by using observing/measuring software VK-H1V1, a sample having a size of 5 cm×5 cm was placed so that the upper side and lower side of the opening portion of the conductive mesh were made in parallel with the screen. The magnification was set so that at least one opening portion of the conductive mesh was included within the viewing space. After the focal point had been adjusted and the measuring height range had been properly set, measurements were started.

Next, the measured data were analyzed by the analyzing software VK-H1A1. First, image noise of the measured data was automatically removed, a tilt, caused by such a case when an object was slightly tilted upon measurements, was corrected. Thereafter, the line roughness was measured. At this time, the analyzing process was carried out by using straight lines that were in parallel with a screen including at least one opening portion of the conductive mesh.

Various correcting processes (height smoothing→±12 simple average, tilt correction→straight line (automatic)) were carried out so that a waving curve was calculated based upon the cut-off value λc=0.08 mm, without using λs and λf; thus, the greatest height Wz, calculated based upon the standard of JIS B0633-2001, was used as the depth (D) of the concave section of the resin layer.

### (3) Measurements of Height of Light-Shielding Convex Portions and Thickness of Conductive Mesh

A sample cross section was produced by using a microtome, and the cross section was observed by using an field emission-type scanning electron microscope (S-800, made by Hitachi, Ltd, accelerating voltage: 26 kV, observing magnification: 3000 times) so that the height of the light-shielding convex portions and the thickness of the conductive mesh were measured.

In each of examples and comparative examples, arbitrary five points on one sheet of sample having a size of 20 cm×20 cm were measured, and the average value was found and used as the thickness of the conductive mesh.

### (4) Measurements of Width and Pitch (Distance) of Light-Shielding Convex Portions, and Line Width and Pitch of Conductive Mesh

The surface observation was carried out by using a digital microscope (VHX-200) made by Keyence Corporation under a magnification of 450 times. By using its length-measuring function, the pitch of the lattice-shaped conductive mesh was measured. In each of examples and comparative examples, arbitrary 25 points on one sheet of sample having a size of 20 cm×20 cm were measured, and the average value was found and used as the line width and pitch of the conductive mesh. Additionally, the pitch of the conductive mesh is defined as a distance between center-of-gravities of one opening portion of the mesh pattern and an adjacent opening portion having at least one side shared with this opening portion. In this case, upon measuring, a sample formed by pasting the sticker layer side of the display-use filter sample to a glass plate having a thickness of 2.5 mm was used.

Moreover, the major diameter of the dot-shaped convex portions, the interval between the convex portions and the number of dot-shaped convex portions per 1 mm² were measured by using the same methods as described earlier.

### (5) Measurements of Viscosity

By using a digital rheometer (DV-E) made by Brook Field Co, Ltd., the viscosity at 23° C. was measured by setting a spindle to LV1 with the number of revolutions of 100 rpm. Each of the samples was measured ten times, and the average value was defined as the viscosity of the hard coat layer paint.

### (6) Measurements of Refractive Index

A material coating agent for a layer to be measured was applied by using a spin coater so as to have a dried film thickness of 0.1 μm on a silicon wafer. Next, by using an inert oven INH-21CD (made by Koyo Thermo Systems Co., Ltd.), the resulting film was heated and cured at 130° C. for one minute (curing condition for a low refractive-index layer) so that a coated film was obtained. The refractive index at 633 nm of the coated film thus formed was measured by using a phase-difference measuring device (NPDM-1000, made by Nikon Corporation).

### (7) Measurements of Thickness of Laminated Layer

The cross section of a display-use filter sample was observed by using a transmission-type electron microscope (model H-7100FA made by Hitachi, Ltd.) at an acceleration voltage of 100 kV. In the case of a filter using a glass substrate, the film separated from the glass was evaluated. A thin-film cut-off method was used for adjusting the samples. The observation was carried out under a magnification of 100,000 times so that the thicknesses of the respective layers were measured.

### (8) Measurements of Visual Transmittance

With respect to each display-use filter sample, its transmittance relative to incident light from the observer side (resin layer side) was measured within a wavelength range from 300 to 1300 nm, by using a spectrophotometer (UV3150PC, made by Shimadzu Corp) so that the visual transmittance within a visible-light wavelength range (380 to 780 nm) was found. In this case, the visual transmittance (T) refers to a value obtained by representing a ratio (Φt/Φi, defined by JIS Z8701) between a luminous flux Φt passing through the filter and a luminous flux Φi made incident on an object as a percentage, that is, Y of three stimulating values of object colors (defined by JIS Z8701) caused by light transmission in the XYZ colorimetric system.

Additionally, a sample member formed by pasting the sticker layer side of the display-use filter sample to a glass plate having a thickness of 2.5 mm was used.

### (9) Evaluation of Image Reflection

A display-use filter sample was pasted onto black paper (AC card #300, made by Oji Specialty Paper Co., Ltd.), with the visible surface (resin layer side) facing up (with the sticker layer side being pasted to the black paper). The resulting sample was set in a dark room, with a three-wavelength fluorescent lamp (National Palook, 3-wavelength natural white fluorescent light (F.L 15EX-N 15 W)) being placed at a position 50 cm right above the outermost surface of the resin layer of the filter sample. The visible surface of the filter sample was observed by the naked eye with a distance 30 cm apart from the front side, the clearness of the outline of a reflected image of the fluorescent lamp from the visible surface of the filter sample was evaluated.
Outline of reflected image was unclear: ◯ (Good)
Outline of reflected image was slightly unclear: Δ (Fair)
Outline of reflected image was clear: × (Bad)

One filter was evaluated by five persons on the respective grades, and the evaluation result of the highest frequency was adopted. When there were two evaluation results of the highest frequency, the worse evaluation result was adopted (when the evaluation results of the highest frequency were “◯” and “Δ”, “Δ” was adopted, when they were “Δ” and “×”, “×” was adopted, and when they were “◯” and “×”, “×” was adopted).

### (10) Evaluation of Transmitted Image

The sticker layer side of a display-use filter sample was pasted onto a glass plate having a thickness of 2.5 mm. This sample was placed on a plasma television (TH-42PX500, made by Matsushita Electric Industrial Co., Ltd., with its original filter taken out) with the glass side of the filter sample being made to face the plasma display panel, so that the panel surface and the filter sample visible face (resin layer) were kept in parallel with each other, with a distance from the plasma display panel surface to the outermost face (resin layer outermost face) on the visible side of the filter sample being set to 20 mm, and a black lattice pattern image on the white background was displayed on the display panel. The pattern image was visually evaluated through the filter sample so that the degree of clearness of the transmitted image was determined. The observation was carried out with a distance of 30 cm from the front side of the visible face of the filter.
Transmitted image was clearly viewed: ◯ (Good)
Transmitted image was slightly unclear: Δ (Fair)
Transmitted image became foggy: × (Bad)

One filter was evaluated by five persons on the respective grades, and the evaluation result of the highest frequency was adopted. When there were two evaluation results of the highest frequency, the worse evaluation result was adopted (when the evaluation results of the highest frequency were “◯” and “Δ”, “Δ” was adopted, when they were “Δ” and “×”, “×” was adopted, and when they were “◯” and “×”, “×” was adopted).

### (11) Measurement of Resin Layer Occupancy Rate (R)

In each of examples and comparative examples, arbitrary ten points on one sheet of filter having a size of 20 cm×20 cm were measured by using a laser microscope VK-9700 (made by Keyence Corporation), and the average value was found.

First, the sample was cut into a size of 1 cm×1 cm, and the surface of the filter sample on the resin layer side was subjected to a sputtering process with platinum by using an ion coating method. The sputtering conditions were: 13.3 Pa in vacuum degree, 2 mA in current value and 15 minutes in sputtering time.

Next, three-dimensional image data on the resin layer side of the filter sample was measured and obtained by using software VK-H1V1 (observing and measuring software). In this case, three-dimensional image data of the resin layer between the center of gravity of one opening portion (non-convex area of the light-shielding mesh-shaped convex portions) and the center of gravity of an adjacent opening portion of a conductive mesh was picked up.

Next, the three-dimensional image data thus obtained was two-dimensionally analyzed in a vertical direction by using analyzing software VK-H1A1 so that a two-dimensional profile was found. First, image noise of the three-dimensional image data was automatically removed, and a tilt, caused by such a case when an object was slightly tilted upon measurements, was corrected. Thereafter, the profile was displayed by a straight line passing through point A, point B and point C. Based upon this profile, the height of point C was measured from straight line AB so that an area (α) of a triangle ABC was calculated (the length of straight line AB corresponds to the pitch of the conductive mesh). Moreover, when a length between point A and point B was selected as a section, an area (β) of the resin layer located within the triangle ABC was calculated. Based upon the area (α) of the triangle ABC and the area (β) of the resin layer located within the triangle ABC, the resin layer occupation rate (R) was calculated from the following equation:

R=(β/α)×100

### Example 1

A plasma display-use filter was manufactured by using the following method.

### <Production of Conductive Layer>

An optical polyester film (Lumirror U46 (registered trademark), made by Toray Industries, Inc., thickness: 100 μm) was used as a transparent substrate, and to this easy adhesion face was pasted by using a bonding agent a copper foil with two faces being subjected to a blackening treatment. This film was patterned into a lattice shape by using a photolithography method, with the peripheral portion of the copper foil being left, so as to have a line width of the conductive mesh of 12 μm and a pitch of 100 μm; thus, a conductive layer having the conductive mesh was produced. The thickness of the conductive mesh was 3 μm and the aperture ratio was 75%.

### <Production of Hard Coat Layer>

A solution was prepared by diluting a commercially available hard coating agent (Opstar (registered trademark) Z7534, made by JSR; concentration of solid-state components: 60% by weight) with methylethyl ketone so that the solid-state component concentration was set to 50% by weight, and to this was further added 1% by weight of acryl-based particles having an average particle size of 3 μm (Chemisnow (registered trademark) MX Series, made by Soken Chemical and Engineering Co., Ltd.) so that a paint for a hard coat layer was produced. The viscosity of the paint was 5 mPa·s. The concentration of the acryl-based particles was a concentration relative to 100% by weight of the total components except for the organic solvent of the hard coat layer. The same is true for the following examples as well.

This paint was applied onto the conductive mesh and the opening portions of the conductive layer obtained as described above by using a micro gravure coater, and after having been dried at 80° C. for one minute, the layer was irradiated with ultraviolet rays at 1.0 J/cm² to be cured so that a hard coat layer was formed. The weight coated amount (after dried and cured) of the hard coat layer was 3.5 g/m².

### <Production of Antireflection Layer>

After diluting a commercially available high refractive index and anti-static paint (Opstar (registered trademark) TU4005, made by JSR) by isopropyl alcohol to 8% in solid-component concentration, by a micro gravure coater, the resulting paint was applied to the hard coat layer formation surface, and after having been dried at 120° C. for one minute, the layer was irradiated with ultraviolet rays at 1.0 J/cm² to be cured so that a high refractive-index layer having a refractive index of 1.65 and a thickness of 135 nm was formed on the hard coat layer.

Next, the following paint for a low refractive-index layer was applied to the high refractive-index layer formation surface by a micro gravure coater. The layer was dried and cured at 130° C. for one minute to be dried and cured so that a low refractive-index layer having a refractive index of 1.36 and a thickness of 90 nm was on the high refractive-index layer; thus, an antireflection layer was prepared.

### <Preparation of Paint for Low Refractive-Index Layer>

To 300 parts by weight of propylene glycol monomethyl ether and 100 parts by weight of isopropanol were dissolved 95.2 parts by weight of methyl trimethoxysilane and 65.4 parts by weight of trifluoropropyl trimethoxysilane.

To this solution were dropped 297.9 parts by weight of a dispersion solution of silica fine particles having a number-average particle size of 50 nm, with voids being included inside core shells thereof (isopropanol dispersion type, solid-component concentration: 20.5%, made by JGC Catalyst and Chemicals Ltd.), 54 parts by weight of water and 1.8 parts by weight of oxalic acid, while being stirred so as not to allow the reaction temperature to exceed 30° C.

After the dropping process, the resulting solution was heated at a bath temperature of 40° C. for 2 hours, and the solution was then heated at a bath temperature of 85° C. for 2 hours, and after having been heated at an increased inner temperature of 80° C. for 1.5 hours, this was cooled to room temperature so that a polymer solution was obtained.

To the resulting polymer solution was added a mixture prepared by dissolving 4.8 parts by weight of aluminum tris(acetylacetate) (trade name: Almichelate A (W), made by Kawaken Fine Chemical Co., Ltd.) in 125 parts by weight of methanol, as an aluminum-based curing agent, and to this were further added 1500 parts by weight of isopropanol and 250 parts by weight of propylene glycol monomethylether, and this was stirred at room temperature for 2 hours so that a low refractive-index paint was prepared.

<Production of Near Infrared-Ray Shielding Layer with Ne-Cutting Function>

To 2000 parts by weight of methylethyl ketone were added 14.5 parts by weight of IRG-050 KAYASORB (registered trademark) made by Nippon Kayaku Co., Ltd. and 8 parts by weight of IR-10A EX-Color (registered trademark) made by Nippon Shokubai Co., Ltd. serving as near infrared-ray absorbing coloring matters, and to this was further added 2.9 parts by weight of TAP-2 made by Yamada Chemical Co., Ltd. as an organic coloring matter having a main absorbing peak at 593 nm, and the mixture was stirred so as to be dissolved. This solution serving as a transparent polymer resin binder solution was mixed and stirred with 2000 parts by weight of IR-G205 (solid-component concentration: 29% solution) HALSHYBRID (registered trademark) made by Nippon Shokubai Co., Ltd. so that a paint was prepared.

The above-mentioned paint was applied onto an optical polyester film surface on the side opposite to the hard coat layer formation side by using a dye coater, and this was dried at 120° C. so that a near infrared-ray shielding layer was prepared.

### <Production of Color Correcting Layer>

An organic color-correcting coloring matter was added to an acryl-based transparent sticker. The amount of addition of the coloring matter for each of standards was adjusted so that the visual transmittance of a final filter was set to 40%. This sticker was stacked on the near infrared-ray shielding layer with a thickness of 25 μm.

### Example 2

A plasma display-use filter was produced by using the same processes as those of example 1, except that the following conductive layer and hard coat layer were used and that no antireflection layer was stacked on the hard coat layer.

### <Production of Conductive Layer>

An optical polyester film (Lumirror U46 (registered trademark), made by Toray Industries, Inc., thickness: 100 μm) was used as a transparent substrate, and to this easy adhesion face was pasted by using a bonding agent a copper foil with two faces being subjected to a blackening treatment. This film was patterned into a lattice shape by using a photolithography method, with the peripheral portion of the copper foil being left, so as to have a line width of the conductive mesh of 12 μm and a pitch of 300 μm; thus, a conductive layer having the conductive mesh was produced. The thickness of the conductive mesh was 5 μm and the aperture ratio was 88%.

### <Production of Hard Coat Layer>

A solution was prepared by diluting a commercially available hard coating agent (Opstar (registered trademark) Z7534, made by JSR; concentration of solid-state components: 60% by weight) with methylethyl ketone so that the solid-state component concentration was set to 50% by weight, and to this was further added 1% by weight of acryl-based particles having an average particle size of 3 μm (Chemisnow (registered trademark) MX Series, made by Soken Chemical and Engineering Co., Ltd.) so that a paint for a hard coat layer was produced. The viscosity of the paint was 6 mPa·s. This paint was applied onto the conductive mesh and the opening portions of the conductive layer obtained as described above by using a micro gravure coater, and after having been dried at 80° C. for one minute, the layer was irradiated with ultraviolet rays at 1.0 J/cm² to be cured so that a hard coat layer was formed. The weight coated amount (after dried and cured) of the hard coat layer was 8 g/m².

### Example 3

A conductive layer was formed on an optical polyester film by using the same processes as those of example 2, and a hard coat layer was stacked thereon. Next, a low refractive-index layer was formed on the hard coat layer by using the same processes as those of example 1 so that a plasma display-use filter was produced.

### Comparative Example 1

A conductive layer was formed by using the same processes as those of example 2. A plasma display-use filter was produced in the same manner as in example 2 except that the following hard coat layer was applied and formed on the conductive mesh of the conductive layer.

### <Production of Hard Coat Layer>

A solution was prepared by diluting a commercially available hard coating agent (Opstar (registered trademark) Z7534, made by JSR; concentration of solid-state components: 60% by weight) with methylethyl ketone so that the solid-state component concentration was set to 50% by weight, and to this was further added 20% by weight of acryl-based particles having an average particle size of 5 μm (Chemisnow (registered trademark) MX Series, made by Soken Chemical and Engineering Co., Ltd.) so that a paint for a hard coat layer was produced. The viscosity of the paint was 6 mPa·s. This paint was applied onto the conductive mesh and the opening portions of the conductive layer obtained as described above by using a micro gravure coater, and after having been dried at 80° C. for one minute, the layer was irradiated with ultraviolet rays at 1.0 J/cm² to be cured so that a hard coat layer was formed. The weight coated amount (after dried and cured) of the hard coat layer was 8 g/m².

### Comparative Example 2

A conductive layer having a conductive mesh with a thickness of 9 μm, a line width of 12 μm and a pitch of 300 μm was produced in the same manner as in example 2. The aperture ratio of the conductive mesh was 87%. When a coating solution for a hard coat layer, prepared in the same manner as in example 2, was applied and formed on the conductive mesh so that the weight coated amount was set to 7 g/m², stripes and irregularities occurred on the coated surface, failing to provide samples to be evaluated.

### (Evaluation)

Each of the samples prepared as described above was evaluated with respect to the depth (D) of concave sections of the resin layer, the center-line average roughness Ra of the resin layer, the image reflection, and the transmitted image clearness. Table 1 shows the results.

Table 1 shows that examples of the present invention are superior in the reflection image prevention and transmitted image clearness.

In contrast, comparative example 1 has the center-line average roughness Ra of the resin layer exceeding 500 nm because its hard coat layer contains many particles, with the result that the transmitted image clearness is lowered.

In comparative example 2, its conductive mesh has a large thickness of 9nm, with the result that the coating property of the hard coat layer deteriorates to cause coating irregularities and stripes.

### Example 4

### <Production of Conductive Layer>

On one face of an optical polyester film (Lumirror U36 (registered trademark), made by Toray Industries, Inc., thickness: 100 μm), a lattice-shaped mesh pattern was gravure printed by using a catalyst ink made of a palladium colloid containing paste, and this was immersed in an electroless copper plating solution so that an electroless copper plating process was carried out thereon, and after an electrolytic copper plating process had been successively carried out thereon, an electrolytic Ni—Sn alloy plating process was further carried out thereon so that a conductive mesh was formed.

This conductive mesh had a line width of 20 μm, a pitch of 300 μm a thickness of 5 μm and an aperture ratio of 87%.

### <Production of Hard Coat Layer>

A paint for a hard coat layer was prepared by diluting a commercially available hard coating agent (Opstar (registered trademark) Z7534, made by JSR; concentration of solid-state components: 60% by weight) with methylethyl ketone so that the solid-state component concentration was set to 40% by weight. The viscosity of the paint was 2.5 mPa·s. This paint was applied onto the conductive mesh and the opening portions of the conductive layer obtained as described above by using a micro gravure coater, and after having been dried at 80° C. for one minute, the layer was irradiated with ultraviolet rays at 1.0 J/cm² to be cured so that a hard coat layer was formed. The weight coated amount (after dried and cured) of the hard coat layer was 6.5 g/m².

### <Production of Antireflection Preventive Layer>

A low refractive-index layer was applied and formed onto the hard coat layer in the same manner as in example 1.

By carrying out the other processes in the same manner as in example 1, a plasma display-use filter was produced.

### Example 5

A conductive mesh was produced in the same manner as in example 4. The same paint for a hard coat layer as that of example 4 was applied and formed on the conductive mesh so that the weight coated amount of the hard coat layer was set to 8.5 g/m². No antireflection layer was stacked thereon. By carrying out the other processes in the same manner as in example 4, a plasma display-use filter was produced.

### Example 6

A conductive mesh was produced in the same manner as in example 4. The same paint for a hard coat layer as that of example 4 was applied and formed on the conductive mesh so that the weight coated amount of the hard coat layer was set to 10.5 g/m². No antireflection layer was stacked thereon. By carrying out the other processes in the same manner as in example 4, a plasma display-use filter was produced.

### Example 7

A conductive mesh was produced in the same manner as in example 4. The following paint for a hard coat layer was applied and formed on the conductive mesh so that the weight coated amount of the hard coat layer was set to 4.5 g/m². No antireflection layer was stacked thereon. By carrying out the other processes in the same manner as in example 4, a plasma display-use filter was produced.

### <Production of Hard Coat Layer>

A solution was prepared by diluting a commercially available hard coating agent (Opstar (registered trademark) Z7534, made by JSR; concentration of solid-state components: 60% by weight) with methylethyl ketone so that the solid-state component concentration was set to 40% by weight, and to this was further added 2% by weight of acryl-based particles having an average particle size of 1.5 μm (Chemisnow (registered trademark) MX Series, made by Soken Chemical and Engineering Co., Ltd.) so that a paint for a hard coat layer was produced. The viscosity of the paint was 2.5 mPa·s. This paint was applied thereon by using a micro gravure coater, and after having been dried at 80° C. for one minute, the layer was irradiated with ultraviolet rays at 1.0 J/cm² to be cured so that a hard coat layer was formed.

### Example 8

A conductive mesh was produced in the same manner as in example 4. The following paint for a hard coat layer was applied and formed on the conductive mesh so that the weight coated amount of the hard coat layer was set to 7 g/m². No antireflection layer was stacked thereon. By carrying out the other processes in the same manner as in example 4, a plasma display-use filter was produced.

### <Production of Hard Coat Layer>

A coating solution containing 30 parts by weight of dipentaerythritol, 8 parts by weight of N-vinyl pyrrolidone, 2 parts by weight of methyl methacrylate, 1 part by weight of a silicone-based leveling agent (SH190, made by Toray Dow Corning Inc.) and 60 parts by weight of methylethyl ketone was prepared. The viscosity of this coating solution was 4 mPa·s.

### (Evaluation)

Each of the samples prepared as described above was evaluated with respect to the depth (D) of concave sections of the resin layer, the center-line average roughness Ra of the resin layer, the image reflection, and the transmitted image clearness. In this case, however, with respect to the transmitted image clearness, a filter was directly pasted onto the plasma display-panel surface, and this was evaluated in accordance with the evaluation criteria of example 1. Table 2 shows the results.

Table 2 shows that examples of the present invention are superior in the reflection image prevention and transmitted image clearness.

### Example 9

### <Production of Conductive Layer>

On one face of an optical polyester film (Lumirror U426 (registered trademark), made by Toray Industries, Inc., thickness: 100 μm), a nickel layer (thickness: 0.02 μm) was formed by using a vacuum vapor deposition method at normal temperature under a vacuum of 3×10⁻³ Pa. On this was further formed a copper layer (thickness: 3 μm) in the same manner by using the vacuum vapor deposition method at normal temperature under a vacuum of 3×10⁻³ Pa. Thereafter, a photoresist layer was applied and formed onto the surface on the copper layer side, and the photoresist layer was exposed through a lattice-shaped mesh pattern and developed, and then subjected to an etching process so that a conductive mesh was formed. The conductive mesh was subjected to a blackening process (oxidizing process). This conductive mesh had a line width of 13 μm, a pitch of 300 μm, a thickness of 3 μm and an aperture ratio of 89%.

### <Production of Hard Coat Layer>

A paint for a hard coat layer was prepared by diluting a commercially available hard coating agent (Opstar (registered trademark) Z7534, made by JSR; concentration of solid-state components: 60% by weight) with methylethyl ketone so that the solid-state component concentration was set to 40% by weight. The viscosity of the paint was 2.5 mPa·s. This paint was applied onto the conductive mesh and the opening portions of the conductive layer obtained as described above by using a micro gravure coater, and after having been dried at 80° C. for one minute, the layer was irradiated with ultraviolet rays at 1.0 J/cm² to be cured so that a hard coat layer was formed. The weight coated amount (after dried and cured) of the hard coat layer was 2.5 g/m².

### <Production of Antireflection Preventive Layer>

A low refractive-index layer was applied and formed onto the hard coat layer in the same manner as in example 1.

By carrying out the other processes in the same manner as in example 1, a plasma display-use filter was produced.

### Example 10

A conductive mesh was produced in the same manner as in example 9. The same paint for a hard coat layer as that of example 9 was applied and formed on the conductive mesh so that the weight coated amount of the hard coat layer was set to 3.6 g/m². No antireflection layer was stacked thereon. By carrying out the other processes in the same manner as in example 9, a plasma display-use filter was produced.

### Example 11

A conductive mesh was produced in the same manner as in example 9. The same paint for a hard coat layer mentioned was applied and formed on the conductive mesh so that the weight coated amount of the hard coat layer was set to 4.2 g/m². No antireflection layer was stacked thereon. By carrying out the other processes in the same manner as in example 9, a plasma display-use filter was produced.

### <Production of Hard Coat Layer>

A solution was prepared by diluting a commercially available hard coating agent (Opstar (registered trademark) Z7534, made by JSR; concentration of solid-state components: 60% by weight) with methylethyl ketone so that the solid-state component concentration was set to 40% by weight, and to this was further added 2% by weight of acryl-based particles having an average particle size of 1.5 μm (Chemisnow (registered trademark) MX Series, made by Soken Chemical and Engineering Co., Ltd.) so that a paint for a hard coat layer was produced. The viscosity of the paint was 2.5 mPa·s. This paint was applied thereon by using a micro gravure coater, and after having been dried at 80° C. for one minute, the layer was irradiated with ultraviolet rays at 1.0 J/cm² to be cured so that a hard coat layer was formed.

### Example 12

A conductive mesh was produced in the same manner as in example 9. The following paint for a hard coat layer was applied and formed on the conductive mesh so that the weight coated amount of the hard coat layer was set to 3.6 g/m². No antireflection layer was stacked thereon. By carrying out the other processes in the same manner as in example 9, a plasma display-use filter was produced.

### <Production of Hard Coat Layer>

A coating solution containing 30 parts by weight of dipentaerythritol hexaacrylate, 8 parts by weight of N-vinyl pyrrolidone, 2 parts by weight of methyl methacrylate, 1 part by weight of a silicone-based leveling agent (SH190, made by Toray Dow Corning Inc.) and 60 parts by weight of methylethyl ketone was prepared. The viscosity of this coating solution was 4 mPa·s.

### Comparative Example 3

A conductive mesh was formed by using the same processes as those of example 9. The same paint for a hard coat layer as that of example 9 was applied and formed on the conductive mesh so that the weight coated amount of the hard coat layer was set to 17 g/m². No antireflection layer was stacked thereon. By carrying out the other processes in the same manner as in example 9, a plasma display-use filter was produced.

### Example 13

A conductive mesh was produced in the same manner as in example 9. However, the conductive mesh was designed to have a line width of 7 μm and a pitch of 150 μm. The thickness of the conductive mesh was 3 μm and the aperture ratio thereof was 88%. The same paint for a hard coat layer as that of example 9 was applied to the conductive mesh so as to have a weight coated amount of 3.6 g/m². No antireflection layer was stacked thereon. The other processes were carried out in the same manner as in example 9 so that a plasma display-use filter was produced.

### Example 14

The same paint for a hard coat layer as that of example 9 was applied to the same conductive mesh as that of example 13 so as to have a weight coated amount of 2.8 g/m². No antireflection layer was stacked thereon. The other processes were carried out in the same manner as in example 9 so that a plasma display-use filter was produced.

### Example 15

A conductive mesh was produced in the same manner as in example 9. However, the conductive mesh was designed to have a line width of 4 μm and a pitch of 100 μm. The thickness of the conductive mesh was 3 μm and the aperture ratio thereof was 90%. The same paint for a hard coat layer as that of example 9 was applied to the conductive mesh so as to have a weight coated amount of 4.2 g/m². No antireflection layer was stacked thereon. The other processes were carried out in the same manner as in example 9 so that a plasma display-use filter was produced.

### Example 16

A conductive mesh was produced in the same manner as in example 13. Onto this conductive mesh, the following high refractive-index hard coat layer was applied and formed so as to have a weight coated amount of 3.6 g/m². Moreover, the low refractive-index layer of example 1 was applied and formed onto the high refractive-index hard coat layer.

### <Production of High-Refractive-Index Hard Coat Layer>

A coating solution for a high refractive-index hard coat layer “TYS63-004”, made by Toyo Ink MFG. Co., Ltd., (antimony oxide fine particles having an average primary particle size of 40 nm; viscosity 6.5 mPa·s) was applied by using a micro gravure coater, and after having been dried at 80° C. for one minute, the layer was irradiated with ultraviolet rays at 1.0 J/cm² to be cured so that a hard coat layer was formed. The hard coat layer had a refractive index of 1.63.

### Example 17

Onto the same conductive mesh as that of example 13, a commercially available hard coating agent (Opstar (registered trademark) Z7534, made by JSR; concentration of solid-state components: 60% by weight, viscosity: 9 mPa·s) was applied as a paint for a hard coat layer so that the weight coated amount of the hard coat layer was set to 10 g/m². No antireflection layer was stacked thereon. By carrying out the other processes in the same manner as in example 9, a plasma display-use filter was produced.

### Comparative Example 4

Onto the same conductive mesh as that of example 13, the following paint for a hard coat layer was applied and formed so as to have a weight coated amount of 2.8 g/m². No antireflection layer was stacked thereon. By carrying out the other processes in the same manner as in example 9, a plasma display-use filter was produced.

### <Production of Hard Coat Layer>

A solution was prepared by diluting a commercially available hard coating agent (Opstar (registered trademark) Z7534, made by JSR; concentration of solid-state components: 60% by weight) with methylethyl ketone so that the solid-state component concentration was set to 40% by weight, and to this was further added 9% by weight of cross-linking polystyrene-based particles having an average particle size of 3.5 μm (Chemisnow (registered trademark) SX Series, made by Soken Chemical and Engineering Co., Ltd.) so that a paint for a hard coat layer was produced. The viscosity of the paint was 2.5 mPa·s. This paint was applied by using a micro gravure coater, and after having been dried at 80° C. for one minute, the layer was irradiated with ultraviolet rays at 1.0 J/cm² to be cured so that a hard coat layer was formed.

### (Evaluation)

Each of the samples prepared as described above was evaluated with respect to the depth (D) of concave sections of the resin layer, the center-line average roughness Ra of the resin layer, the image reflection, and the transmitted image clearness. In this case, with respect to the transmitted image clearness, a filter was directly pasted onto the panel face of a plasma display panel, and evaluations were made in accordance with the evaluation criteria of example 1. Table 3 shows the results.

Table 3 shows that examples of the present invention are superior in the reflection image prevention and transmitted image clearness.

In comparative example 3, the coated amount of the hard coat layer was as much as 17 g/m², with the result that it was not possible to form concave sections at portions without the conductive mesh of the resin layer (hard coat layer), and the center-line average roughness Ra was also less than 50 nm, with the result that no reflection image preventive function was obtained. Furthermore, since comparative example 3 had much coated amount of the hard coat layer as described above, layer curling occurred in the plasma display-use filter.

Comparative example 4 contains a comparatively large amount of particles (average particle size: 3.5 μm) that are larger than the thickness 3 μm of the conductive mesh, with the result that the center-line average roughness Ra of the resin layer exceeds 500 nm to cause degradation of the transmitted image clearness.

### Example 101

Onto one face of an optical polyester film (Lumirror U46 (registered trademark), made by Toray Industries, Inc., thickness: 100 μm), serving as a transparent substrate, the following paint for forming light-shielding convex portions was applied and dried so as to have a dried film thickness of 5 μm so that a coat film for forming the light-shielding convex portions was laminated.

### <Paint for Forming Light-Shielding Convex Portions>

8.4 parts by weight of titanium black 13M-T (titanium nitride) made by Mitsubishi Materials Corporation, 12.5 parts by weight of acidity-treated carbon black 9930CF made by Daido Chemical Industries Co., Ltd., 12.5 parts by weight of carbon black PRINTEX25 made by Degussa Corporation, 1.68 parts by weight of “Solsperse (registered trademark)” 12000 made by Abisha* Co., Ltd., 56.14 parts by weight of a 45 weight % solution of 3-methyl-3-methoxybutanol of acrylic polymer (see below), 24.29 parts by weight of “Disperbyk (registered trademark)” 167 (dispersant) made by BYK Japan K.K., and 884.5 parts by weight of propylene glycol monomethylether acetate were precisely weighed, and mixed and dispersed at 2500 rpm for 3 hours by using a mill-type dispersing device with zirconia beads filled therein, so that a pigment dispersion solution having a pigment concentration of 3.34% by weight was obtained.

To 57.74 parts by weight of this pigment dispersion solution was added and mixed therewith 0.63 parts by weight of a 45 weight % solution of 3-methyl-3-methoxybutanol of acrylic monomer (see below), 7.56 parts by weight of a 30 weight % solution of 3-methyl-3-methoxy-butylacetate of a bisphenoxy ethanol fluorene-based tetrafunctional ancylate compound (see below), 3.24 parts by weight of a 30 weight % solution of 3-methyl-3-methoxy-butyl acetate of dipentaerythritol hexaacrylate (DPHA, made by Nippon Kayaku Co., Ltd.) serving as a polyfunctional monomer, 0.24 parts by weight of “Irgacur (registered trademark)” 379 serving as a photopolymerization initiator, 1.47 parts by weight of “Adeka (registered trademark) Optomer” N-1919 made by Asahi Denka Kogyo Co., Ltd., and a solution prepared by dissolving 0.19 parts by weight of N,N′-tetraethyl-4,4′-diaminobenzophenone, 0.14 parts by weigh of vinyl trimethoxysilanet serving as an adhesive-property improving agent, 0.28 parts by weight of a propylene glycol monomethyl ether acetate 10 weight % solution serving as a silicone-based surfactant, in 28.51 parts by weight of 3-methyl-3-methoxy-butylacetate so that a paint for forming light-shielding convex portions was prepared. The content ratio of the black pigments in the above-mentioned paint was 11% by weight relative to all the components except for the organic solvent.

### <Acrylic Polymer>

After synthesizing a methyl methacrylate/methacrylic acid/styrene copolymer (weight composition ratio: 33/34/33) by using a method disclosed in example 1 of Japanese Patent No. 3120476, to this was added 33 parts by weight of glycidyl methacrylate, and re-precipitated in refined water, and filtered and dried so that acrylic polymer (P1) powder having characteristics of an average molecular weight (Mw) of 9,000 and an acid value of 70 (mg KOH/g: obtained in accordance with JIS K-5407) was obtained.

### <Bisphenoxy Ethanol Fluorene-Based Tetrafunctional Acrylate Compound>

First, 296 parts by weight of bisphenoxy ethanol fluorene diglycidyl ether(epoxy equivalent: 296 g/eq), 3.4 parts by weight of dimethylbenzyl amine, 0.34 parts by weight of p-methoxyphenol and 72.06 parts by weight of acrylic acid (1 mole) were loaded into a container, and this was heated, with an air flow being blown thereto at a flow rate of 20 ml/min, so as to be reacted at a temperature from 110 to 120° C. During this time, the acid value was measured, and the heating and stirring processes were continued until the value had become less than 2.0 mgKOH/g. It took 10 hours until the acid value had reached the target value. Thus, bisphenoxy ethanol fluorene-type acrylate was obtained.

Next, 184.0 parts by weight of the bisphenoxy ethanol fluorene-type acrylate (hydroxyl group equivalent: 368 g/eq, calculated value) synthesized as described above, 100 parts by weight of 3-methoxy-3-methyl-butylacetate and 26.6 parts by weight of triethyl amine (0.263 moles) were loaded into a container, and dissolved therein, and after having been cooled by a water bath, into this was dropped and added a solution prepared by dissolving 25.38 parts by weight of isophthal chloride (0.125 moles: an amount required for allowing a half of the hydroxyl groups to react with the acid chloride) into 100 parts by weight of 3-methoxy-3-methyl-butyl acetate. This was further subjected to the reaction at room temperature for two hours, and after having been diluted with 267.3 parts by weight of 3-methoxy-3-methyl-butyl acetate, the resulting white precipitation was pressure-filtered so that a 30 weight % solution of a bisphenoxyethanol fluorene-based tetra-functional acrylate compound was obtained.

### <Formation of Light-Shielding Convex Portions>

The coat film for forming light-shielding convex portions, stacked on the transparent substrate as described above, was subjected to an exposing process with ultraviolet rays through a photomask having a square lattice-shaped pattern. Successively, this was subjected to a developing process by using an alkali developing solution so that light-shielding mesh-shaped convex portions having a width of the convex portion of 20 μm, a pitch of 300 μm and a height of 5 μm were formed. The aperture ratio of the mesh-shaped convex portions was 87%.

### <Coating Process of Transparent Resin Layer>

The following hard coat layer was applied and formed so as to cover the light-shielding convex portions and the non-convex areas formed as described above.

### <Production of Hard Coat Layer>

A paint for a hard coat layer was prepared by diluting a commercially available hard coating agent (Opstar (registered trademark) Z7534, made by JSR; concentration of solid-state components: 60% by weight) with methylethyl ketone so that the solid-state component concentration was set to 40% by weight. The viscosity of the paint was 2.5 mPa·s. This paint was applied thereto by using a micro gravure coater, and after having been dried at 80° C. for one minute, the layer was irradiated with ultraviolet rays at 1.0 J/cm² to be cured so that a hard coat layer was formed. The weight coated amount (after dried and cured) of the hard coat layer was 6.5 g/m².

### <Production of Filter>

On a surface opposed to the hard coat layer of the film on which the hard coat layer obtained as described above was stacked, an acrylic resin-based sticker that contained a diimmonium-based coloring matter and a phthalocyanine-based coloring matter as near infrared-ray absorbing coloring matters and also contained an organic color-correcting coloring matter so as to adjust the transmittance was stacked with a thickness of 25 μm. The added amount of the organic color correcting coloring matter was adjusted so that the visual transmittance of the manufactured filter was set to 40%.

### Example 102

A display-use filter was produced in the same manner as in example 101, except that the weight coated amount (after dried and cured) of the hard coat layer was changed to 8.5 g/m².

### Example 103

A display-use filter was produced in the same manner as in example 101, except that the weight coated amount (after dried and cured) of the hard coat layer was changed to 10.5 g/m².

### Example 104

A display-use filter was produced in the same manner as in example 101 except that the preparation of the hard coat layer was changed as described below.

### <Production of Hard Coat Layer>

A solution was prepared by diluting a commercially available hard coating agent (Opstar (registered trademark) Z7534, made by JSR; concentration of solid-state components: 60% by weight) with methylethyl ketone so that the solid-state component concentration was set to 40% by weight, and to this was further added 2% by weight of acryl-based particles having an average particle size of 1.5 μm (Chemisnow (registered trademark) MX Series, made by Soken Chemical and Engineering Co., Ltd.) so that a paint for a hard coat layer was produced. The viscosity of the paint was 2.5 mPa·s. This paint was applied by using a micro gravure coater, and after having been dried at 80° C. for one minute, the layer was irradiated with ultraviolet rays at 1.0 J/cm² to be cured so that a hard coat layer was formed. The weight coated amount (after dried and cured) of the hard coat layer was 4.5 g/m².

### Example 105

A display-use filter was produced in the same manner as in example 101 except that the preparation of the hard coat layer was changed as described below.

### <Production of Hard Coat Layer>

A paint containing 30 parts by weight of dipentaerythritol hexaacrylate, 8 parts by weight of N-vinyl pyrrolidone, 2 parts by weight of methyl methacrylate, 1 part by weight of a silicone-based leveling agent (SH190, made by Toray Dow Corning Inc.) and 60 parts by weight of methylethyl ketone was prepared. The viscosity of this coating solution was 4 mPa·s. This paint was applied by using a micro gravure coater, and after having been dried at 80° C. for one minute, the layer was irradiated with ultraviolet rays at 1.0 J/cm² to be cured so that a hard coat layer was formed. The weight coated amount (after dried and cured) of the hard coat layer was 7 g/m².

### Example 106

On the hard coat layer applied and formed on the light-shielding convex portions in example 102, the following antireflection layer (high refractive-index layer/low refractive-index layer) was further formed.

The other processes were carried out in the same manner as in example 101 so that a display-use filter was produced.

### <Production of Antireflection Preventive Layer>

After diluting a commercially available high refractive index and anti-static paint (Opstar (registered trademark) TU4005, made by JSR) by isopropyl alcohol to 8% in solid-component concentration, the resulting paint was applied to the hard coat layer formation surface by a micro gravure coater, and after having been dried at 120° C. for one minute, the layer was irradiated with ultraviolet rays at 1.0 J/cm² to be cured so that a high refractive-index layer having a refractive index of 1.65 and a thickness of 135 nm was formed on the hard coat layer.

Next, the following paint for a low refractive-index layer was applied to the high refractive-index layer formation surface by a micro gravure coater. The layer was dried and cured at 130° C. for one minute to be dried and cured so that a low refractive-index layer having a refractive index of 1.36 and a thickness of 90 nm was on the high refractive-index layer; thus, an antireflection layer was prepared.

### <Preparation of Paint for Low Refractive-Index Layer>

To 300 parts by weight of propylene glycol monomethyl ether and 100 parts by weight of isopropanol were dissolved 95.2 parts by weight of methyl trimethoxysilane and 65.4 parts by weight of trifluoropropyl trimethoxysilane.

To this solution were dropped 297.9 parts by weight of a dispersion solution of silica fine particles having a number-average particle size of 50 nm, with voids being included inside outer core shells thereof (isopropanol dispersion type, solid-component concentration: 20.5%, made by JGC Catalyst and Chemicals Ltd.), 54 parts by weight of water and 1.8 parts by weight of formate, while being stirred so as not to allow the reaction temperature to exceed 30° C.

After the dropping process, the resulting solution was heated at a bath temperature of 40° C. for 2 hours, and the solution was then heated at a bath temperature of 85° C. for 2 hours, and after having been heated at an increased inner temperature of 80° C. for 1.5 hours, this was cooled to room temperature so that a polymer solution was obtained.

To the resulting polymer solution was added a mixture prepared by dissolving 4.8 parts by weight of aluminum tris(acetylacetate) (trade name: Almichelate A (W), made by Kawaken Fine Chemicals Co., Ltd.) in 125 parts by weight of methanol, as an aluminum-based curing agent, and to this were further added 1500 parts by weight of isopropanol and 250 parts by weight of propylene glycol monomethylether, and this was stirred at room temperature for 2 hours so that a low refractive-index paint was prepared.

### Example 107

On the hard coat layer applied and formed onto the light-shielding convex portions in example 102, only the paint for a low refractive-index layer of example 106 was further applied and formed in the same manner as in example 106.

The other processes were carried out in the same manner as in example 1 so that a display-use filter was produced.

### Comparative Example 101

A display-use filter was produced in the same manner as in example 101 except that the preparation of the hard coat layer was changed as described below.

### <Production of Hard Coat Layer>

A solution was prepared by diluting a commercially available hard coating agent (Opstar (registered trademark) Z7534, made by JSR; concentration of solid-state components: 60% by weight) with methylethyl ketone so that the solid-state component concentration was set to 40% by weight, and to this was further added 20% by weight of acryl-based particles having an average particle size of 5 μm (Chemisnow (registered trademark) MX Series, made by Soken Chemical and Engineering Co., Ltd.) so that a paint for a hard coat layer was produced. The viscosity of the paint was 2.5 mPa·s. This paint was applied onto the light-shielding convex portions and non-convex areas obtained as described above by using a micro gravure coater, and after having been dried at 80° C. for one minute, the layer was irradiated with ultraviolet rays at 1.0 J/cm² to be cured so that a hard coat layer was formed. The weight coated amount (after dried and cured) of the hard coat layer was 8.5 g/m².

### Comparative Example 102

The same processes as those of example 101 were carried out except that the weight coated amount (after dried and cured) of the hard coat layer was changed to 23 g/m² so that a display-use filter was produced.

### Comparative Example 103

The same processes as those of example 101 were carried out except that no black pigment was added thereto so that mesh-shaped convex portions were formed. Onto the mesh-shaped convex portions, the same hard coat layer as that of example 104 was applied and formed in the same manner as in example 104.

The other processes were carried out in the same manner as in example 101 so that a display-use filter was produced.

### (Evaluation)

Each of the display-use filters produced as described above was evaluated with respect to the depth (D) of concave sections of the resin layer, the center-line average roughness Ra of the resin layer, the image reflection and the transmitted image clearness, and Table 4 shows the results thereof. In this case, with respect to the transmitted image clearness, a filter was directly pasted onto the panel face of a plasma display panel, and evaluations were made in accordance with the evaluation criteria of example 1.

Table 4 shows that examples of the present invention are superior in the reflection image prevention and transmitted image clearness.

In contrast, in comparative example 101, since the hard coat layer contained many particles, the center-line average roughness Ra of the transparent resin layer exceeded 500 nm, with the result that the transmitted clearness was lowered.

In comparative example 102, since the coated amount of the hard coat layer was as much as 23 g/m², the center-line average roughness Ra of the transparent resin layer became smaller than 50 nm, and the depth (D) of concave sections of the resin layer was as small as 0.1 μm, with the result that it was not possible to prevent the reflection image. Moreover, in comparative example 102, since the coated amount of the hard coat layer as as much as 23 g/m², layer curling occurred greatly in the plasma display-use filter.

In comparative example 103, since the mesh-shaped convex portions contained no black pigment and had no light-shielding property, the transmitted image clearness was lowered.

### Example 108

An optical polyester film (Lumirror U46 (registered trademark), made by Toray Industries, Inc., thickness: 100 μm) was used as a transparent substrate, and on one surface of this film, the same paint for forming light-shielding convex portions as that of example 1 was applied and dried so as to have a dried film thickness of 3 μm so that a coat film for forming light-shielding convex portions was stacked thereon.

### <Formation of Light-Shielding Convex Portions>

The coat film for forming light-shielding convex portions, stacked on the transparent substrate as described above, was exposed with ultraviolet rays through a photomask having a round pattern. This was then subjected to a developing process by using an alkali developing solution so that light-shielding dot-shaped convex portions having a major diameter of the convex portion of 20 μm, an interval of 40 μm and a height of 3 μm. The number of the dot-shaped convex portions per 1 mm² was 625, and the aperture ratio was 80%.

### <Production of Hard Coat Layer>

The same hard coat layer as that of example 101 was applied and formed so that the weight coated amount (after dried and cured) was set to 3 g/m².

The other processes were carried out in the same manner as in example 101 so that a display-use filter was produced.

### Example 109

### <Formation of Light-Shielding Convex Portions>

The same processes as those of example 108 were carried out so that dot-shaped convex portions were formed. In this case, however, the height of the dot-shaped convex portions was changed to 5 μm.

### <Production of Hard Coat Layer>

The same hard coat layer as that of example 101 was applied and formed so that the weight coated amount (after dried and cured) was set to 7 g/m².

The other processes were carried out in the same manner as in example 101 so that a display-use filter was produced.

### Comparative Example 104

Dot-shaped convex portions, which were the same as those of example 109 except that no black pigment was contained and that no light-shielding property was prepared, were formed, and the same hard coat layer as that of example 101 was applied and formed thereon so as to have a weight coated amount of 7 g/m².

The other processes were carried out in the same manner as those of example 101 so that a display-use filter was produced.

### (Evaluation)

Each of the display-use filters produced as described above was evaluated with respect to the depth (D) of concave sections of the resin layer, the center-line average roughness Ra, the image reflection and the transmitted image clearness, and Table 5 shows the results thereof. In this case, with respect to the transmitted image clearness, a filter was directly pasted onto the panel face of a plasma display panel, and evaluations were made in accordance with the evaluation criteria of example 1.

Table 5 shows that examples of the present invention are superior in the reflection image prevention and transmitted image clearness.

In contrast, in comparative example 104, since the dot-shaped convex portions contained no black pigment, and had no light-shielding property, the transmitted image clearness was lowered.

### Example 110

### <Production of Conductive Mesh>

On one face of an optical polyester film (Lumirror U426 (registered trademark), made by Toray Industries, Inc., thickness: 100 μm), a nickel layer (thickness: 0.02 μm) was formed at normal temperature under a vacuum of 3×10⁻³ Pa by using a vacuum vapor deposition method. On this was further formed a copper layer (thickness: 3 μm) in the same manner by using the vacuum vapor deposition method at normal temperature under a vacuum of 3×10⁻³ Pa. Thereafter, a photoresist layer was applied and formed onto the surface on the copper layer side, and the photoresist layer was exposed through a mask having a lattice-shaped mesh pattern and developed, and then subjected to an etching process so that a conductive mesh was formed. The conductive mesh was subjected to a blackening process (oxidizing process).

This conductive mesh had a line width of 13 μm, a pitch of 300 μm, a thickness of 3 μm and an aperture ratio of 89%.

### <Formation of Mesh-Shaped Convex Portions>

Positive-working photosensitive resin (novolac resin/quinone diazide-based resin solution; made by Shipley Fareast Co., Ltd.) was mixed with the pigment dispersion solution for forming light-shielding convex portions of example 1 so that the black pigment was set to 8% by weight relative to the resin component; thus, a paint for forming light-shielding convex portions was prepared. This paint was applied onto a face opposed to the conductive mesh of the optical polyester film so as to have a dried film thickness of 3 μm so that a coat film for forming light-shielding convex portions was stacked thereon.

Next, after the coat film for forming light-shielding convex portions had been exposed to ultraviolet rays applied from the conductive mesh side, with the conductive mesh serving as a mask, the resulting film was developed by an alkali aqueous solution so that light-shielding mesh-shaped convex portions, made of a mesh pattern superposed with the conductive mesh in its projected manner, was formed.

### <Production of Hard Coat Layer>

The same hard coat layer as that of example 101 was applied and formed on the mesh-shaped convex portions so that the weight coated amount (after dried and cured) was set to 3.6 g/m².

### <Production of Filter>

Next, on the formation face of the conductive mesh, an acrylic resin-based sticker that contained a diimmonium-based coloring matter and a phthalocyanine-based coloring matter as near infrared-ray absorbing coloring matters and also contained an organic color-correcting coloring matter so as to adjust the transmittance was stacked with a thickness of 25 μm. The added amount of the organic color correcting coloring matter was adjusted so that the visual transmittance of the manufactured filter was set to 40%.

### Example 111

### <Production of Conductive Mesh>

The same processes as those of example 110 were carried out so that a conductive mesh was produced.

### <Production of Mesh-Shaped Convex Portions>

Positive-working photosensitive resin (novolac resin/quinone diazide-based resin solution; made by Shipley Fareast Co., Ltd.) was applied onto a face opposed to the conductive mesh so as to have a dried thickness of 3 μm so that a coat film for forming light-shielding convex portions was stacked thereon. In this case, the coat film for forming light-shielding convex portions had no light-shielding property.

Next, after the coat film for forming light-shielding convex portions had been exposed to ultraviolet rays applied from the conductive mesh side, with the conductive mesh serving as a mask, the resulting film was developed by an alkali aqueous solution so that light-shielding mesh-shaped convex portions with no light-shielding property, made of a mesh pattern superposed with the conductive mesh in its projected manner, was formed.

### <Production of Hard Coat Layer>

The same hard coat layer as that of example 101 was applied and formed on the mesh-shaped convex portions so that the weight coated amount (after dried and cured) was set to 3.6 g/m².

### <Production of Filter>

Next, on the formation face of the conductive mesh, an acrylic resin-based sticker that contained a diimmonium-based coloring matter and a phthalocyanine-based coloring matter as near infrared-ray absorbing coloring matters and also contained an organic color-correcting coloring matter so as to adjust the transmittance was stacked with a thickness of 25 μm. The added amount of the organic color correcting coloring matter was adjusted so that the visual transmittance of the manufactured filter was set to 40%.

### (Evaluation)

Each of the display-use filters produced as described above was evaluated with respect to the depth (D) of concave sections of the transparent resin layer, the center-line average roughness Ra, the image reflection and the transmitted image clearness, and Table 6 shows the results thereof. In this case, with respect to the transmitted image clearness, a filter was directly pasted onto the panel face of a plasma display panel, and evaluations were made in accordance with the evaluation criteria of example 1.

Table 6 shows that example 110, which had a mode in which the light-shielding mesh-shaped convex portions having a mesh pattern that was superposed with the conductive mesh in its projected manner, were formed, was superior in the reflection image prevention and transmitted image clearness.

Moreover, example 111 had a mode in which the light-shielding mesh-shaped convex portions having no light-shielding property that had a mesh pattern that was superposed with the conductive mesh in a projected manner, were formed; however, since a light-shielding conductive mesh was placed perpendicularly below the mesh-shaped convex portions, the mesh-shaped convex portions were consequently allowed to shield light emission from the display, so that it is possible to provide a superior transmitted image clearness and also to prevent image reflection.

TABLE 1

| | | | Structure of resin layer | | Weight | | | | | |
|---|---|---|---|---|---|---|---|---|---|---|
| | | | HC: Hard coat layer | Paint | coated | Depth of | Center-line | | | |
| | Structure of | | HR: High refractive- | viscosity | amount | concave | average | Occupancy | | |
| | conductive mesh | | index layer | of hard | of hard | portion | roughness | rate of resin | Image | Transmitted |
| | Height | Pitch | LR: Low refractive- | coat layer | coat layer | (D) | (Ra) | layer (R) | reflection | image |
| | (μm) | (μm) | index layer | (mPa · s) | (g/m²) | (μm) | (nm) | (%) | evaluation | evaluation |
| Example 1 | 3 | 100 | HC/HR/LR | 5 | 3.5 | 1.2 | 220 | 55 | ∘ | ∘ |
| Example 2 | 5 | 300 | HC | 6 | 8 | 1.5 | 240 | 50 | ∘ | ∘ |
| Example 3 | 5 | 300 | HC/LR | 6 | 8 | 1.5 | 240 | 50 | ∘ | ∘ |
| Comparatieve | 5 | 300 | HC | 6 | 8 | 2.0 | 700 | 120 | ∘ | x |
| Example 1 | | | | | | | | | | |
| Comparatieve | 9 | 300 | HC | 6 | 7 | — | — | — | — | — |
| Example 2 | | | | | | | | | | |

In Table, “—” represtents “unevaluation” because no samples to be evaluated were obtained due to occurrence of coating irregularities and coating stripes.
In Table, in “Structure of resin layer”, left side represents “light-shielding convex portion side” and right side represents “uppermost surface side”. That is, “HC/HR/LR” indicates that HC, HR and LR are placed in this order from the light-shielding convex portion side.

TABLE 2

| | | | Structure of resin layer | | Weight | | | | | |
|---|---|---|---|---|---|---|---|---|---|---|
| | | | HC: Hard coat layer | Paint | coated | Depth of | Center-line | | | |
| | Structure of | | HR: High refractive- | viscosity | amount | concave | average | Occupancy | | |
| | conductive mesh | | index layer | of hard | of hard | portion | roughness | rate of resin | Image | Transmitted |
| | Height | Pitch | LR: Low refractive- | coat layer | coat layer | (D) | (Ra) | layer (R) | reflection | image |
| | (μm) | (μm) | index layer | (mPa · s) | (g/m2) | (μm) | (nm) | (%) | evaluation | evaluation |
| Example 4 | 5 | 300 | HC/LR | 2.5 | 6.5 | 1.9 | 320 | 50 | ∘ | ∘ |
| Example 5 | 5 | 300 | HC | 2.5 | 8.5 | 1.3 | 240 | 45 | ∘ | ∘ |
| Example 6 | 5 | 300 | HC | 2.5 | 10.5 | 0.8 | 140 | 45 | ∘ | ∘ |
| Example 7 | 5 | 300 | HC | 2.5 | 4.5 | 2.4 | 300 | 55 | ∘ | ∘ |
| Example 8 | 5 | 300 | HC | 4 | 7 | 1.7 | 290 | 45 | ∘ | ∘ |

In Table, in “Structure of resin layer”, left side represents “light-shielding convex portion side” and right side represents “uppermost surface side”. That is, “HC/HR/LR” indicates that HC, HR and LR are placed in this order from the light-shielding convex portion side.

TABLE 3

| | | | Structure of resin layer | | Weight | | | | | |
|---|---|---|---|---|---|---|---|---|---|---|
| | | | HC: Hard coat layer | Paint | coated | Depth of | Center-line | | | |
| | Structure of | | HR: High refractive- | viscosity | amount | concave | average | Occupancy | | |
| | conductive mesh | | index layer | of hard | of hard | portion | roughness | rate of resin | Image | Transmitted |
| | Height | Pitch | LR: Low refractive- | coat layer | coat layer | (D) | (Ra) | layer (R) | reflection | Image |
| | (μm) | (μm) | index layer | (mPa · s) | (g/m2) | (μm) | (nm) | (%) | evaluation | evaluation |
| Example 9 | 3 | 300 | HC/LR | 2.5 | 2.5 | 2.0 | 360 | 50 | ∘ | ∘ |
| Example 10 | 3 | 300 | HC | 2.5 | 3.6 | 1.3 | 200 | 50 | ∘ | ∘ |
| Example 11 | 3 | 300 | HC | 2.5 | 4.2 | 0.7 | 150 | 60 | ∘ | ∘ |
| Example 12 | 3 | 300 | HC | 4 | 3.6 | 1.7 | 250 | 45 | ∘ | ∘ |
| Comprative | 3 | 300 | HC | 2.5 | 17 | 0.1 | 30 | 15 | x | ∘ |
| Example 3 | | | | | | | | | | |
| Example 13 | 3 | 150 | HC | 2.5 | 3.6 | 1.0 | 240 | 50 | ∘ | ∘ |
| Example 14 | 3 | 150 | HC | 2.5 | 2.8 | 0.8 | 190 | 50 | ∘ | ∘ |
| Example 15 | 3 | 100 | HC | 2.5 | 4.2 | 0.6 | 170 | 55 | ∘ | ∘ |
| Example 16 | 3 | 150 | HC/LR | 6.5 | 3.6 | 1.0 | 240 | 50 | ∘ | ∘ |
| Example 17 | 3 | 150 | HC | 9 | 10 | 0.3 | 80 | 40 | Δ | ∘ |
| Comprative | 3 | 150 | HC | 2.5 | 2.8 | 1.5 | 700 | 110 | ∘ | x |
| Example 4 | | | | | | | | | | |

In Table, in “Structure of resin layer”, left side represents “light-shielding convex portion side” and right side represents “uppermost surface side”. That is, “HC/HR/LR” indicates that HC, HR and LR are placed in this order from the light-shielding convex portion side.

TABLE 4

| | Light-shielding | | Structure of resin layer | | Weight | | | | | |
|---|---|---|---|---|---|---|---|---|---|---|
| | convex portion | | HC: Hard coat layer | Paint | coated | Depth of | Center-line | | | |
| | (Mesh-shaped | | HR: High refractive- | viscosity | amount | concave | average | Occupancy | | |
| | convex portion) | | index layer | of hard | of hard | portion | roughness | rate of resin | Image | Transmitted |
| | Height | Pitch | LR: Low refractive- | coat layer | coat layer | (D) | (Ra) | layer (R) | Reflection | image |
| | (μm) | (μm) | index layer | (mPa · s) | (g/m2) | (μm) | (nm) | (%) | evaluation | evaluation |
| Example 101 | 5 | 300 | HC | 2.5 | 6.5 | 1.9 | 320 | 50 | ∘ | ∘ |
| Example 102 | 5 | 300 | HC | 2.5 | 8.5 | 1.3 | 240 | 45 | ∘ | ∘ |
| Example 103 | 5 | 300 | HC | 2.5 | 10.5 | 0.8 | 140 | 45 | ∘ | ∘ |
| Example 104 | 5 | 300 | HC | 2.5 | 4.5 | 2.4 | 300 | 55 | ∘ | ∘ |
| Example 105 | 5 | 300 | HC | 4 | 7 | 1.7 | 290 | 45 | ∘ | ∘ |
| Example 106 | 5 | 300 | HC/HR/LR | 2.5 | 8.5 | 1.3 | 240 | 45 | ∘ | ∘ |
| Example 107 | 5 | 300 | HC/LR | 2.5 | 8.5 | 1.3 | 240 | 45 | ∘ | ∘ |
| Comparative | 5 | 300 | HC | 2.5 | 8.5 | 2.0 | 700 | 120 | ∘ | x |
| Example 101 | | | | | | | | | | |
| Comparative | 5 | 300 | HC | 2.5 | 23 | 0.1 | 30 | 15 | x | ∘ |
| Example 102 | | | | | | | | | | |
| Comparative | 5 | 300 | HC | 2.5 | 4.5 | 2.4 | 300 | 50 | ∘ | x |
| Example 103 | | | | | | | | | | |

In Comparative Example 103, “mesh-shaped convex portion” has no light-shielding property.
In Table, in “Structure of resin layer”, left side represents “light-shielding convex portion side” and right side represents “uppermost surface side”. That is, “HC/HR/LR” indicates that HC, HR and LR are placed in this order from the light-shielding convex portion side.

TABLE 5

| | | | | | | Weight | | | | |
|---|---|---|---|---|---|---|---|---|---|---|
| | | | | | Paint | coated | Depth of | Center-line | | |
| | Light-shielding convex portion | | | Structure of | viscosity | amount | concave | average | | |
| | (dot-shaped convex portions) | | | resin layer | of hard | of hard | portion | roughness | Image | Transmitted |
| | Height | Interval | Number | HC: Hard | coat layer | coat layer | (D) | (Ra) | reflection | image |
| | (μm) | (μm) | (Number/mm2) | coat layer | (mPa · s) | (g/m2) | (μm) | (nm) | evaluation | evaluation |
| Example 108 | 3 | 40 | 625 | HC | 2.5 | 3 | 0.8 | 260 | ∘ | ∘ |
| Example 109 | 3 | 40 | 625 | HC | 2.5 | 7 | 1.2 | 450 | ∘ | ∘ |
| Comparative | 3 | 40 | 625 | HC | 2.5 | 7 | 1.2 | 450 | ∘ | x |
| Example 104 | | | | | | | | | | |

In Comparative Example 104, “mesh-shaped convex portion” has no light-shielding property.

TABLE 6

| | | | | | Weight | | | | |
|---|---|---|---|---|---|---|---|---|---|
| | Light-shielding convex | | | Paint | coated | Depth of | Center-line | | |
| | portion (Mesh-shaped | | Structure of | viscosity | amount | concave | average | | |
| | convex portion) | | resin layer | of hard | of hard | portion | roughness | Image | Transmitted |
| | Height | Pitch | HC: Hard | coat layer | coat layer | (D) | (Ra) | reflection | image |
| | (μm) | (μm) | coat layer | (mPa · s) | (g/m2) | (μm) | (nm) | evaluation | evaluation |
| Example 110 | 3 | 300 | HC | 2.5 | 3.6 | 1.3 | 200 | ∘ | ∘ |
| Example 111 | 3 | 300 | HC | 2.5 | 3.6 | 1.3 | 200 | ∘ | ∘ |

In Comparative Example 111, “mesh-shaped convex portion” has no light-shielding property.

1. A display-use filter, which comprises a laminated body comprising:
a transparent substrate;
light-shielding convex portions formed on the transparent substrate;
a resin layer stacked on the light-shielding convex portions and a non-convex area existing between the light-shielding convex portions,
wherein a concave section of the resin layer is formed in the non-convex area, and the resin layer has a center-line average roughness Ra in a range from 50 to 500 nm.

2. The display-use filter according to claim 1, wherein the concave section in the resin layer has a depth (D) in a range from 0.5 to 5 μm.

3. The display-use filter according to claim 1, wherein the light-shielding convex portions have a height of 0.5 to 8 μm, and are mesh-shaped convex portions or a plurality of dot-shaped convex portions.

4. The display-use filter according to claim 3, wherein a resin layer occupancy ratio (R), defined in the following manner, is set to 20 to 100%:
(Definition of the resin layer occupancy ratio (R))
R=(β/α)×100)
α: area of triangle ABC
β: area of resin layer located within triangle ABC
where, in the case when the cross section of a resin layer is viewed, the cross section being in a direction orthogonal to a transparent substrate and passing through two adjacent centers of gravity (G1, G2) of adjacent non-convex areas, each surrounded by the mesh-shaped convex portions in the surface direction of the transparent substrate, it is supposed that an apex of the resin layer on the mesh-shaped convex portions is C, that an intersection point of a perpendicular line (perpendicular relative to the transparent substrate) passing through one of the centers of gravity G1 of the two centers of gravity and the surface of the resin layer is A, and that an intersection point of a perpendicular line (perpendicular relative to the transparent substrate) passing through the other center of gravity G2 of the two centers of gravity and the surface of the resin layer is B.

5. The display-use filter according to claim 1, wherein the light-shielding convex portions is a conductive mesh.

6. The display-use filter according to claim 5, wherein the conductive mesh has a pitch in a range from 50 to 500 μm.

7. The display-use filter according to claim 5, wherein a resin layer occupancy ratio (R), defined in the following manner, is set to 20 to 100%:
(Definition of the resin layer occupancy ratio (R))
R=(β/α)×100)
α: area of triangle ABC
β: area of resin layer located within triangle ABC
where, in the case when the cross section of a resin layer is viewed, the cross section being in a direction orthogonal to a transparent substrate and passing through two adjacent centers of gravity (G1, G2) of adjacent non-convex areas (openings of the conductive mesh), each surrounded by the conductive mesh, in the surface direction of the transparent substrate, it is supposed that an apex of the resin layer on the conductive mesh is C, that an intersection point of a perpendicular line (perpendicular relative to the transparent substrate) passing through one of the centers of gravity G1 of the two centers of gravity and the surface of the resin layer is A, and that an intersection point of a perpendicular line (perpendicular relative to the transparent substrate) passing through the other center of gravity G2 of the two centers of gravity and the surface of the resin layer is B.

8. The display-use filter according to claim 1, wherein the light-shielding convex portions contain a resin component and a light-shielding substance.

9. The display-use filter according to claim 1, wherein the resin layer (one layer on the light-shielding convex portion side in the case when the resin layer has a laminated structure) has a weight coated amount in a range from 1 to 16 g/m².

10. The display-use filter according to claim 1, wherein the resin layer is a transparent resin layer.

11. The display-use filter according to claim 1, wherein the resin layer is a hard coat layer.

12. The display-use filter according to claim 1, wherein the resin layer has a laminated structure in which an antireflection layer is stacked on a hard coat layer.

13. The display-use filter according to claim 1, further comprising:
a functional layer having at least one function selected from the group consisting of a near infrared-ray shielding function, a color-tone correcting function, an ultraviolet-ray shielding function and a Ne-cutting function.

14. The display-use filter according to claim 1 for use in a plasma display.
